(19) United States
(12) Patent Application Publication
(10) Pub. No.: US 2026/0157568 A1
(43) Pub. Date: Jun. 11, 2026

(54) PROPANE GRILL WITH CONVECTION SYSTEM

(71) Applicant: SharkNinja Operating LLC, Needham, MA (US)

(72) Inventors: Thomas Morrell, Somerville, MA (US); Nathaniel R. Lavins, Cambridge, MA (US); David Conor Dykeman, Hopkinton, MA (US); Peter Hutchinson, Medfield, MA (US); Igor Kofman, Moultonborough, NH (US); Fouad Enniri, Nassau, NY (US); Guowei Sun, Shenzhen (CN); Xiaohu Liu, Newton, MA (US); Weston Lickfeld, Brookline, MA (US); Lintao Dai, Huizhou (CN)

(21) Appl. No.: 19/079,059

(22) Filed: Mar. 13, 2025

Related U.S. Application Data
(63) Continuation of application No. PCT/CN2024/126801, filed on Oct. 23, 2024.
(60) Provisional application No. 63/618,216, filed on Jan. 5, 2024.

(51) Int. Cl. A47J 37/07; A23B 4/052; F23D 14/04; F24C 3/12; F24C 15/00; F24C 15/14; F24C 15/32

(52) U.S. Cl. CPC A47J 37/0754; A23B 4/052; A47J 37/0713; F23D 14/045; F24C 3/12; F24C 15/006; F24C 15/14; F24C 15/322; A47J 2202/00; F23D 2900/11403; F23D 2900/14003

(57) ABSTRACT

In an embodiment, a cooking device is provided. The cooking device includes a housing defining an internal cooking chamber with at least one cooking surface disposed therein, and at least one gas-powered heat source disposed in the internal cooking. The at least one gas-powered heat source is configured to heat air and a food product disposed in the internal cooking chamber during a cooking operation. The cooking device also includes a convection fan in fluid communication with the internal cooking chamber and configured to circulate the heated air within the internal cooking chamber during a cooking operation.

### CROSS-REFERENCE TO RELATED APPLICATIONS

The present application is a continuation of PCT International Application No. PCT/CN2024/126801, titled “PROPANE GRILL WITH CONVECTION SYSTEM,” and filed on Oct. 23, 2024, which claims priority under 35 U.S.C. § 119 (e) to U.S. Provisional Patent Application No. 63/618,216, titled “PROPANE GRILL WITH CONVECTION SYSTEM” and filed on Jan. 5, 2024, the entire contents of each are hereby expressly incorporated by reference herein.

### FIELD

A propane grill with a convection system is provided.

### BACKGROUND

Propane grills and other gas-powered cooking systems rely on flames to heat and cook food. Excess air is a common challenge when designing propane grills and similar systems. While oxygen is a necessary component of the combustion of the gaseous fuel relied on by these systems, excess airflow, such as from wind, will extinguish the flames leading to ineffective cooking or even safety risks due to the unmitigated flow of the gaseous fuel. Still, traditional systems have put in place components such as specially-designed ducts, wind guards, and other mechanisms to reduce the adverse impact of excess airflow so that cooking can take place even in windy environments.

### SUMMARY

A propane grill with a convection system is provided. Related apparatuses and techniques are also provided.

In an embodiment, a cooking device is provided. The cooking device can include a housing, at least one gas-powered heat source, and a convection fan. The housing can include a base and a lid defining an internal cooking chamber. The internal cooking chamber can include at least one cooking surface disposed therein. The at least one gas-powered heat source can be disposed in the internal cooking chamber beneath the at least one cooking surface. The at least one gas-powered heat source can be configured to heat a food product disposed on the at least one cooking surface during a cooking operation. The convection fan can be disposed in fluid communication with internal cooking chamber and configured to circulate heated air within the internal cooking chamber.

The cooking device can vary in a number of ways. For example, the cooking device can include a smoke unit coupled to the housing. The smoke unit can be configured to generate and supply smoke to the internal cooking volume. In some variations, the smoke unit can include an aspirator configured to divert circulated convective air through an aspirator pathway to create a low-pressure zone in the smoke pathway to increase a flow rate of smoke entering the internal cooking chamber. In some aspects, the aspirator can include a tongue configured to divert a fraction of the circulated convective air to the aspirator pathway. For example, the cooking device can include at least one burner duct disposed at least partially around the at least one burner. The at least one burner duct can be configured to prevent circulated heated air from extinguishing the at least one gas-powered heat source. In some variations, the cooking device can also include a flame tamer disposed above the at least one burner duct and the at least one burner. The flame tamer can be wider than the at least one burner duct and can be configured to prevent falling debris and/or waste from interfering with the at least one gas-powered heat source. In some aspects, the cooking device can include a grease catch disposed beneath the at least one burner and the at least one burner duct, the grease catch defining at least one fluid drain, the grease catch being sloped toward the at least one fluid drain such that fluid impacting the grease catch is directed to the at least one fluid drain. For example, the cooking device can include a convection motor configured to drive the fan, and a cooling fan configured to reduce an operating temperature of the convection motor. In some variations, the convection motor can be configured to drive the cooling fan. For example, the at least one gas-powered heating device can include at least one burner tube and a pilot light. In some variations, the pilot light can have a first plurality of outlets having each having a first distribution density and a second plurality of outlets each having a second distribution density greater than the first size. The first plurality of outlets can be configured to support a first plurality of flames and the second plurality of outlets are configured to support at least one secondary flame, and the first plurality of flames can be configured to burn the air-fuel mixture more efficiently than the at least one secondary flame. In some variations, the cooking device can include a flame tamer disposed over the pilot light. The flame tamer can define at least one window therethrough. The at least one window can be positioned such that the at least one secondary flame is visible from a vantage point disposed above the flame tamer. In some variations, can include a thermopile configured to detect the presence of flame generated by the pilot light. In some aspects, the thermopile can be electrically isolated from all other electronic components in the cooking device. For example, the cooking device can include a duct configured to receive airflow from the fan at a first end of the internal cooking chamber and expel the received airflow at a second end of the internal cooking chamber. For example, the cooking device can include an exhaust configured to vent air from the internal cooking volume. The exhaust vent can be disposed proximate a pressure-neutral region. For example, the cooking device can include a split volute defining a first airflow path and a second airflow path. The fan can be disposed within the split volute. In some variations, the heated air circulated by the fan can be configured to be substantially equally divided between the first airflow path and the second airflow path. In some aspects, the first airflow path can be configured to create a first toroidal airflow pattern in the internal cooking chamber and the second airflow can be configured to create a second toroidal airflow pattern in the internal cooking chamber. In further aspects, the first and second toroidal patterns can flow in opposite circular directions.

In an embodiment, a cooking device is provided. The cooking device can include a housing including a base and a lid defining an internal cooking chamber. The internal cooking chamber can include at least one cooking surface disposed therein. The cooking device can also include at least one gas-powered heat source disposed in the internal cooking chamber beneath the at least one cooking surface. The at least one gas-powered heat source can be configured to heat a food product disposed on the at least one cooking surface during a cooking operation. The cooking device can further include a convection fan operable to circulate heated air within the internal cooking chamber.

The cooking device can vary in a number of ways. For example, the at least one gas-powered heat source can be disposed within the internal cooking chamber. For example, the cooking device can include a smoke unit disposed on an external surface of the housing. The smoke unit can be in fluid communication with the internal cooking chamber and can be configured to generate smoke to flavor a food product disposed the at least one cooking surface. In some variations, the smoke unit can include an outer housing disposed on the external surface of the housing and a fuel container removably receivable within the outer housing of the smoke unit. The fuel container can be configured to hold combusting fuel during a smoke generation process. For example, the cooking device can include a pilot light in fluid communication with the at least one gas-powered heat source. In some variations, the at least one gas-powered heat source can include a plurality of substantially parallel gas-powered burner tubes. For example, the at least one gas-powered heat source can include three substantially parallel gas-powered burner tubes. For example, the fan can be configured to blow air directly onto the cooking surface. For example, the fan can be coupled to the base of the housing, and the lid can be hinged to the base such that the lid can be moved between an open and a closed position without moving the fan. For example, the fan can be configured to rotate around an axis that is substantially parallel to the at least one cooking surface. For example, the cooking device can include at least one flame tamer disposed between the at least one gas-powered heat source and the cooking surface. For example, the cooking device can include a burner duct disposed at least partially around the at least one gas-powered heating source. The burner duct can be configured to prevent the fan from extinguishing one or more flames generated by the at least one gas-powered heat source. In some variations, the burner duct can include a pair of sidewalls disposed laterally adjacent to the at least one gas-powered heating source, and a flame tamer separate from the pair of sidewalls and disposed directly above the at least one gas-powered heating source.

In an embodiment, a cooking device is provided. The cooking device can include a housing defining an internal cooking volume. The internal cooking volume can have at least one cooking surface disposed therein. The cooking device can also include at least one gas-powered heating source disposed within the internal cooking volume and beneath the at least one cooking surface, and a fan disposed in fluid communication with internal cooking volume and configured to circulate air within the internal cooking volume. The at least one gas-powered heating source and the fan can be operable during a convective cooking mode to cook a food product disposed on the at least one cooking surface.

The cooking device can vary in a number of ways. For example, the cooking device can include a smoke unit coupled to the housing, the smoke unit being configured to generate smoke for flavoring a food product disposed within the internal cooking volume. In some variations, the smoke unit can be coupled to an external surface of the housing. For example, the cooking device can include a pilot light in fluid communication with the at least one gas-powered heat source. In some variations, the at least one gas-powered heat source can include a plurality of substantially parallel gas-powered burner tubes. For example, the at least one gas-powered heat source can include three substantially parallel gas-powered burner tubes. For example, the cooking device can include a burner duct disposed around the at least one gas-powered heating source. The burner duct can be configured to prevent the fan from extinguishing one or more flames generated by the at least one gas-powered heat source. In some variations, the burner duct can include a pair of sidewalls disposed laterally adjacent to the at least one gas-powered heating source and a flame tamer separate from the pair of sidewalls and disposed directly above the at least one gas-powered heating source.

In an embodiment, a cooking device is provided. The cooking device can include a housing defining an internal cooking chamber. The internal cooking chamber can include a cooking surface. The cooking device can also include at least one duct disposed within the internal cooking chamber beneath the cooking surface. The at least one duct can define an inlet at a lower end thereof and an outlet at an upper end thereof. The cooking device can further include at least one gas-powered heat source disposed within the at least one duct. The at least one gas-powered heat source can be configured to heat the cooking surface with one or more flames. The at least one gas-powered heat source can be configured to receive secondary air via the inlet of the at least one duct and configured to emit convective products out of the outlet of the at least one duct.

The cooking device can vary in a number of ways. For example, the cooking device can include at least one flame tamer disposed over the at least one duct. The at least one flame tamer can be configured to prevent food waste falling from the cooking surface onto the at least one gas-powered heat source. In some variations, the at least one flame tamer can have a substantially triangular shape. For example, the at least one gas-powered heat source can include three substantially parallel burner tubes. In some variations, the at least one duct can include three substantially parallel ducts. The at least three substantially parallel burner tubes can be disposed in the three substantially parallel ducts. For example, the at least one gas-powered heat source can include three substantially parallel burner tubes and a pilot light running substantially perpendicular to the three substantially parallel burner tubes.

In an embodiment, a cooking device is provided. The cooking device can include a housing defining an internal cooking chamber. The internal cooking chamber can include a cooking surface and at least one gas-powered heat source disposed beneath the cooking surface. The cooking device can also include a triangular top panel disposed directly above the at least one gas-powered heat source, and at least one duct flanking the at least one gas-powered heat source. The at least one of duct can be spaced from the triangular top panel to define at least one gap. The at least one duct can be configured to direct heat emitted by the at least one gas-powered heat source toward the triangular top and out the at least one gap.

The cooking device can vary in a number of ways. For example, the cooking device can include a smoke unit coupled to an external surface of the housing. The smoke unit can be in fluid communication with the internal cooking chamber and being configured to generate smoke to flavor a food product during a cooking operation. For example, the at least one gas-powered heat source can include at least one burner tube and a pilot light. The pilot light can be in fluid communication with the at least one burner tube. In some variations, the at least one burner tube can include at least three burner tubes disposed parallel to each other. For example, the at least one gas-powered heat source can include a plurality of gas-powered heat sources and the at least one duct can include a plurality of duct. In some variations, wherein adjacent ducts within the plurality of ducts can a grease pathway therebetween. For example, the cooking device can include a grease catch disposed beneath the at least one gas-powered heat source and the at least one duct. The grease catch can slope to at least one drain through which grease can pass. In some variations, the cooking device can include a grease tray disposed beneath the grease catch. The grease tray can be configured to collect and retain grease pass through the at least one drain of the grease catch. For example, the at least one duct can include at least one left side panel and at least one right side panel, and the at least one left side panel can be substantially parallel to a left half of the triangular top panel and the at least one right side panel can be substantially parallel to a right half of the triangular top panel. For example, the cooking device can include at least one sloped grease catch disposed beneath the at least one baffle. The at least one sloped grease catch can be configured to direct caught fluid toward at least one drain disposed in the at least one sloped grease catch.

In an embodiment, a cooking device is provided. The cooking device can include a housing defining an internal cooking chamber. The internal cooking chamber can include at least one cooking surface upon which a food product can be placed during a cooking operation. The cooking device can also include at least one gas-powered heat source disposed in the internal cooking chamber and beneath the at least one cooking surface, and at least one baffle located in the internal cooking chamber. The at least one baffle can include a sloped top panel disposed directly above the at least one gas-powered heat source, and a plurality of connected side panels disposed laterally adjacent to the at least one gas-powered heat source. The sloped top panel can be configured to receive and divert grease dripping from the at least one cooking surface. The plurality of connected side panels can be separate from the sloped top panel and can be configured to protect the at least one gas-powered heat source.

The cooking device can vary in a number of ways. For example, the cooking device can include a convection assembly disposed within the internal cooking chamber. The convection assembly can include at least one fan configured to circulate air within the internal cooking chamber during the cooking operation. For example, the cooking device can include a smoke unit coupled to an external surface of the housing. The smoke unit can be in fluid communication with the internal cooking chamber and can be configured to generate smoke to flavor the food product during the cooking operation. For example, the cooking device can include a grease catch disposed beneath the at least one gas-powered heat source and the at least one baffle. The grease catch can slope to at least one drain through which grease can pass. In some variations, the cooking device can include a grease tray disposed beneath the grease catch. The grease tray can be configured to collect and retain grease pass through the at least one drain of the grease catch.

In an embodiment, a cooking device is provided. The cooking device can include a housing defining an internal cooking chamber. The internal cooking chamber can include a cooking surface configured to support a food product during a cooking operation, at least one gas-powered burner, a plurality of sloped burner baffles each having a sloped top panel separate from at least one side panel, a grease catch defining at least one fluid drain, and a grease tray. The internal cooking chamber can be structured such that grease dripping off the food product during the cooking operation is configured to flow, in order, through the cooking surface, down the sloped top panel, through the at least one fluid drain, and into the grease tray.

The cooking device can vary in a number of ways. For example, the sloped top panel can have an A-frame-shaped cross section. In some variations, the at least one side panel can include a left side panel and a right side panel, and the left side panel can be substantially parallel to a left half of the sloped top panel and the right side panel can be substantially parallel to a right half of the sloped top panel. For example, the cooking device can include a convection assembly disposed within the internal cooking chamber, and the convection assembly can include at least one fan configured to circulate air within the internal cooking chamber during the cooking operation. For example, the cooking device can include a smoke unit coupled to an external surface of the housing. The smoke unit can be in fluid communication with the internal cooking chamber and can be configured to generate smoke to flavor the food product during the cooking operation.

In an embodiment, a cooking system is provided. The cooking system can include a gas-powered grill defining a cooking chamber. The gas-powered grill can include at least one gas-powered burner located within the cooking chamber and configured to heat a food product disposed therein during a cooking operation. The cooking system can also include a convection fan operable to circulate heated air within the cooking chamber during the cooking operation. The convection fan can be powered by a convection fan motor. The cooking system can further include a cooling fan configured to reduce a temperature of the convection fan motor during operation of the convection fan.

The cooking device can vary in a number of ways. For example, the gas-powered grill can be configured to reach cook temperatures of at least 500 degrees Fahrenheit. In some variations, the gas-powered grill can be configured to reach cook temperatures of at least 600 degrees Fahrenheit. For example, at a max power setting, the gas-powered grill can be configured to output at least 36,000 BTUs. For example, the convection fan motor can be configured to power the convection fan and the cooling fan. For example, the convection fan can be in direct communication with the cooking surface. For example, the convection fan can be configured to rotate about an axis that is substantially horizontal. For example, the at least one gas-powered burner can be at least two parallel burner tubes extending substantially across the cooking chamber. For example, the at least one gas-powered burner can include at least one burner tube at a pilot light in fluid communication with the at least one burner tube. In some variations, the cooking system can include at least one flame detection sensor disposed proximate to the pilot light and configured to determine whether the pilot light is lit or unlit. For example, the convection fan and the at least one heating element can be operable during the cooking operation to heat food through convection. For example, the cooking system can include a smoke unit coupled to an exterior of the gas-powered grill. The smoke unit can be in fluid communication with the cooking chamber and can be configured to generate smoke to flavor the food product during the cooking operation.

In an embodiment, a cooking system is provided. The cooking system can include a housing defining an internal cooking chamber. The internal cooking chamber can include at least one cooking surface disposed therein and configured to support a food product during a cooking operation. The cooking system can also include at least one gas-powered heating element disposed beneath the at least one cooking surface, and a convection system coupled to the housing. The convection system can include a convection fan operable by a fan motor during the cooking operation to circulate heated air within the internal cooking chamber, and a cooling fan disposed external to the internal cooking chamber and configured to reduce an operating temperature of the fan motor.

The cooking system can vary in a number of ways. For example, the fan motor can be configured to power the convection fan and the cooling fan. For example, the cooking system can include a smoke unit coupled to an exterior of the housing. The smoke unit can be configured to generate smoke to flavor the food product during the cooking operation. For example, the at least one gas-powered heating element can be at least two parallel burner tubes extending substantially across the cooking chamber. For example, the at least one gas-powered heating element can include at least one burner tube at a pilot light in fluid communication with the at least one burner tube. For example, the internal cooking chamber can include at least one cooking surface upon which the food product can be placed during the cooking operation, and the convection fan can be in direct communication with the cooking surface.

In an embodiment, a cooking system is provided. The cooking system can include a cooking device defining an internal cooking chamber. The internal cooking chamber can have at least one gas-powered heat source and therein, and a convection assembly in fluid communication with the internal cooking assembly. The convection assembly can include a convection fan, and a duct configured to receive airflow from the convection fan at a first end of the internal cooking chamber and expel the received airflow toward a second end of the internal cooking chamber.

The cooking system can vary in a number of ways. For example, the cooking system can include a smoke unit coupled to the cooking device. The smoke unit can be configured to generate smoke to flavor a food product disposed within the internal cooking chamber. For example, the at least one gas-powered heat source can include at least one burner tube and a pilot light. The pilot light can be in fluid communication with the at least one burner tube. In some variations, the at least one burner tube can include at least three burner tubes disposed parallel to each other. For example, the at least one gas-powered heat source can include a plurality of gas-powered heat sources and the at least one baffle can include a plurality of baffles. In some variations, adjacent baffles within the plurality of baffles can define a grease pathway therebetween through which grease can drain. For example, the convection assembly can include a split volute within which the convection fan is disposed. The split volute can be configured to guide from the convection fan along a plurality of flow paths. In some variations, the split volute can include at least one drain hole such that grease within the split volute can drain through the at least one drain hole.

In an embodiment, a cooking system is provided. The cooking system can include a cooking device comprising an internal cooking chamber extending from a first end of the cooking device to a second end of the cooking device opposite the first end. The internal cooking chamber can have at least one gas-powered heat source disposed therein. The cooking system can also include a convection assembly in fluid communication with the internal cooking chamber. The convection assembly can include a convection fan configured to circulate air within the internal cooking chamber from the first end to the second end thereof during a convective cooking operation.

The cooking system can vary in a number of ways. For example, the convection assembly can include a volute configured to direct air circulated by the convection fan through the internal cooking chamber. In some variations, the volute can be a split volute defining a plurality of flow paths, and the convection fan can be configured to direct air along each flow path in the plurality of flow paths. For example, the cooking system can include at least one duct configured to receive air from the convection assembly at the first end of the internal cooking chamber and emit the received air toward the second end of the internal cooking chamber. For example, the convection assembly can include a motor configured to drive the convection fan and a cooling fan configured to cool the motor. In some variations, the motor can be configured to drive the cooling fan. For example, the cooking device can include a cooking surface disposed in the internal cooking chamber. The cooking surface can be disposed between the at least one gas-powered heat source and the convection assembly. For example, the cooking device can include at least one exhaust disposed in a pressure-neutral region of the internal cooking chamber.

In an embodiment, a cooking system is provided. The cooking system can include a cooking device defining an internal cooking chamber. The internal cooking chamber can have at least one gas-powered heat source and therein. The cooking system can also include a convection assembly disposed within the internal cooking chamber. The convection assembly, can include a volute defining at least one airflow path, and a fan disposed within the volute and configured to circulate heated air within the internal cooking chamber.

The cooking system can vary in a number of ways. For example, the at least one airflow path can include a first airflow path and a second airflow path. In some variations, the cooking system can include an air duct defined within the internal cooking chamber and configured to receive air from the first airflow path at a first side of the internal cooking chamber and configured to emit air from the first airflow path at a second side of the internal cooking chamber. For example, the at least one gas-powered heat source can include at least one burner tube and a pilot light, the pilot light being in fluid communication with the at least one burner tube. For example, the at least one gas powered heat source can include at least three burner tubes disposed parallel to each other. For example, the at least one gas-powered heat source can include a plurality of gas-powered heat sources and the at least one baffle comprises a plurality of baffles.

In an embodiment, a cooking system is provided. The cooking system can include a gas-powered grill defining an internal cooking chamber, The internal cooking chamber can have at least one gas-powered heating element disposed therein, The cooking system can also include convection assembly coupled to the gas-powered grill. The convection assembly can include a volute disposed within the internal cooking chamber, a convection fan disposed within the volute and configured to circulate air within the internal cooking chamber during a cooking operation, and at least one duct configured to receive airflow from the convection fan at a first end of the internal cooking chamber and configured to emit the received airflow at a second end of the internal cooking chamber.

The cooking system can vary in a number of ways. For example, the volute can be a split volute defining a first flow path leading to the at least one duct and a second flow path, and the convection fan can be configured to generate airflow to flow along the first flow path and the second flow path. In some variations, air flowing along the first flow path can be substantially equal to air flowing along the second flow path. In other variations, the convection assembly, in operation, can be configured to create at least two spiral airflow zones within the internal cooking chamber.

In an embodiment, a method is provided. The method can include receiving data characterizing at least one user-specified operating input at a user interface in electronic communication with a gas-powered cooking device. The at least one user-specified operating input can include an operating temperature range of the gas-powered cooking device and a temperature value within the operating temperature range. The method can also include receiving temperature sensor information characterizing a first temperature of the gas-powered cooking device, receiving a valve position of a valve disposed in a fuel line of the gas-powered cooking device, and causing the valve to move to the received valve position to alter a flow rate of fuel in the fuel line of the gas-powered cooking device to reach a set temperature.

The method can vary in a number of ways. For example, the method can include receiving a target power output of the gas-powered cooking device, and the valve position can be determined based at least in part of the target power output. For example, the method can include confirming, after causing the valve to move to the valve position, an actual valve position using at least one of an RPM sensor, a rotary encoder, or at least one limit switch, adjusting the actual valve position when a difference between the valve position and the actual valve position exceeds a predetermined threshold. For example, the method can include adjusting the valve position based on a temperature differential between the temperature value within the operating temperature range and the first temperature of the gas-powered cooking device. For example, the method can include adjusting the valve position based on an accumulated temperature differential between the temperature value within the operating temperature range and the first temperature of the gas-powered cooking device over a predetermined time interval. For example, the method can include receiving temperature sensor information characterizing a second temperature of the gas-powered cooking device, adjusting the valve position based on a rate of change of temperature from the first temperature of the gas-powered cooking device and the second temperature of the gas-powered cooking device. For example, the method can include receiving temperature sensor information characterizing a second temperature of the gas-powered cooking device, a differential between the first temperature and the second temperature exceeding a predetermined threshold indicative of an emergency situation, and causing the valve to move to an emergency valve position corresponding to a minimum flow rate of fuel in the fuel line of the gas-powered cooking device while avoiding a flashback scenario. For example, the method can include receiving lid state information characterizing an open and closed position of a lid of the gas-powered cooking device, and adjusting, based on the received lid state, the valve position.

In an embodiment, a system is provided. The system can include at least one data processor, and memory storing instructions, which when executed by the at least one data processor, cause the at least one data processor to perform operations. The operations can include receiving data characterizing at least one user-specified operating input at a user interface in electronic communication with a gas-powered cooking device. The at least one user-specified operating input can include an operating temperature range of the gas-powered cooking device and a temperature value within the operating temperature range. The operations can also include receiving temperature sensor information characterizing a first temperature of the gas-powered cooking device, determining, based on the received at least one user-specified operating input and the received temperature sensor information, a valve position of a valve disposed in a fuel line of the gas-powered cooking device, causing the valve to move to the determined valve position to alter a flow rate of fuel in the fuel line of the gas-powered cooking device.

The system can vary in a number of ways. For example, the operations can include confirming, after causing the valve to move to the valve position, an actual valve position using at least one of an RPM sensor, a rotary encoder, a pressure sensor, or at least one limit switch, and adjusting the actual valve position when a difference between the valve position and the actual valve position exceeds a predetermined threshold. For example, the operations can include adjusting the valve position based on a temperature differential between the temperature value within the operating temperature range and the first temperature of the gas-powered cooking device. For example, the operations can include adjusting the valve position based on an accumulated temperature differential between the temperature value within the operating temperature range and the first temperature of the gas-powered cooking device over a predetermined time interval. For example, the operations can include receiving temperature sensor information characterizing a second temperature of the gas-powered cooking device, and adjusting the valve position based on a rate of change of temperature from the first temperature of the gas-powered cooking device and the second temperature of the gas-powered cooking device. For example, the operations can include receiving temperature sensor information characterizing a second temperature of the gas-powered cooking device, a differential between the first temperature and the second temperature exceeding a predetermined threshold indicative of an emergency situation, and causing the valve to move to an emergency valve position corresponding to a minimum flow rate of fuel in the fuel line of the gas-powered cooking device. For example, the operations can include receiving lid state information characterizing an open and closed position of a lid of the gas-powered cooking device, and adjusting, based on the received lid state, the valve position.

In an embodiment, a non-transitory computer program product storing executable instructions is provided. The instructions, when executed by at least one data processor forming part of at least one computing system, implement operations. The operations can include receiving data characterizing at least one user-specified operating input at a user interface in electronic communication with a gas-powered cooking device. The at least one user-specified operating input can include an operating temperature range of the gas-powered cooking device and a temperature value within the operating temperature range. The operations can also include receiving temperature sensor information characterizing a first temperature of the gas-powered cooking device, determining, based on the received at least one user-specified operating input and the received temperature sensor information, a valve position of a valve disposed in a fuel line of the gas-powered cooking device, and causing the valve to move to the determined valve position to alter a flow rate of fuel in the fuel line of the gas-powered cooking device.

In an embodiment, a cooking device is provided. The cooking device can include a housing defining an internal cooking chamber, a fan operably coupled to the housing and configured to circulate convective air within the internal cooking chamber, and a smoke unit operably coupled to the housing. The smoke unit can be configured to generate smoke and supply generated smoke to the internal cooking chamber via a smoke pathway. The smoke unit can include an aspirator configured to divert circulated convective air through an aspirator pathway to create a low-pressure zone in the smoke pathway to increase a flow rate of smoke entering the internal cooking chamber.

The cooking device can vary in a number of ways. For example, the aspirator includes a tongue configured to divert a fraction of the circulated convective air to the aspirator pathway. In some variations, the fraction of diverted convective air can be about one-half of a total. In other variations, the fraction of diverted convective air can be about one-third of a total. In further variations, the fraction of diverted convective air can be about one-sixth of a total. For example, the aspirator can be configured to increase the flow rate of smoke entering the internal cooking chamber by about 75%. For example, the smoke unit can be coupled to an exterior of the housing. In some variations, the fan is disposed within the internal cooking chamber.

In an embodiment, a cooking device is provided. The cooking device can include a housing defining an internal cooking chamber, and a tubular body defining a lumen therethrough, the lumen being configured to receive an air-fuel mixture. The tubular body can define a first plurality of outlets having a first distribution density and a second plurality of outlets having a second distribution density greater than the first distribution density. Each of the first and second plurality of outlets can lead to the lumen. The first plurality of outlets can be configured to support a first plurality of flames and the second plurality of outlets are configured to support at least one secondary flame, and the first plurality of flames can be configured to burn the air-fuel mixture more efficiently than the at least one second flame.

The cooking device can vary in a number of ways. For example, the cooking device can include a flame tamer disposed above the tubular body. The flame tamer can be configured to deflect food debris away from the tubular body. In some variations the flame tamer can have a substantially A-frame shape. In other variations, the flame tamer can define at least one window, and the second plurality of outlets can be visible through the at least one window from a vantage point located above the flame tamer and the tubular body. For example, the first plurality of outlets can be spaced substantially linearly along a length of the tubular body. In some variations, the first plurality of outlets can be evenly spaced along the length of the tubular body. For example, the second plurality of outlets can be spaced substantially non-linearly. For example, the second plurality of outlets can be positioned to receive a greater proportion of secondary air as compared to primary air than the first plurality of outlets.

In an embodiment, a cooking device is provided. The cooking device can include a housing defining an internal cooking chamber, and a tubular body defining a lumen therethrough, the lumen being configured to receive an air-fuel mixture. The tubular body can define a first plurality of outlets having each having a first size and a second plurality of outlets each having a second size greater than the first size. Each of the first and second plurality of outlets can lead to the lumen. The first plurality of outlets can be configured to support a first plurality of flames and the second plurality of outlets can be configured to support at least one secondary flame, and the first plurality of flames can be configured to burn the air-fuel mixture more efficiently than the at least one secondary flame.

The cooking device can vary in a number of ways. For example, the cooking device can include a flame tamer disposed above the tubular body. The flame tamer can be configured to deflect food debris away from the tubular body. In some variations, the flame tamer can have a substantially A-frame shape. In other variations, the flame tamer can define at least one window. The second plurality of outlets can be visible through the at least one window from a vantage point located above the flame tamer and the tubular body. For example, the first plurality of outlets can be spaced substantially linearly along a length of the tubular body. In some variations, the first plurality of outlets can be evenly spaced along the length of the tubular body. For example, the first plurality of outlets can be spaced substantially linearly along a length of the tubular body.

In an embodiment, a method is provided. The method can include receiving temperature data characterizing a current temperature of a cooking chamber. The current temperature exceeding a first predetermined temperature threshold can be indicative of a flare-up in the cooking chamber. The method can also include receiving first time data characterizing a first length of time the current temperature of the cooking chamber has exceeded the first predetermined temperature threshold. The first length of time exceeding a first predetermined time threshold can be indicative of the flare-up. The method can further include setting a rotational speed of a fan disposed in the cooking chamber to a predetermined fan speed, and setting a target pressure drop corresponding to a minimum flow rate of gaseous fuel.

The method can vary in a number of ways. For example, the method can include receiving second time data characterizing a second length of time the current temperature of the cooking chamber has exceeded the first predetermined temperature threshold. The second length of time being greater than the first length of time can be indicative of an overheat scenario in the cooking chamber. In some variations, the method can include setting the rotational speed of the fan to a maximum allowable fan speed, and adjusting a current valve angle to match a target valve angle. For example, the method can include displaying, in response to reception of the temperature data and the first time data, a first error message on a display in electronic communication with the cooking chamber, the first error message communicating the flare-up. In some variations, the method can include displaying, in response to reception of the second time data, a second error message on the display, the second error message communicating the overheat scenario. For example, the first predetermined temperature threshold can be about 350 degrees Celsius. For example, the first predetermined time threshold can be about 30 seconds. In some variations, the second predetermined temperature threshold can be about 10 minutes.

In an embodiment, a method is provided. The method can include receiving valve angle data characterizing a current valve angle position of a motorized valve, determining if the current valve angle position corresponds to a minimum permissible gas flow value for a current burner configuration of a cooking device, determining a rate of temperature change in a cooking cavity of the cooking device, and setting, upon confirmation the current valve angle position does correspond to the minimum permissible gas flow value and the rate of temperature change is below a predetermined threshold, a fan speed of a fan disposed in the cooking cavity to a maximum value and a fuel flow rate to a minimum value.

The method can vary in a number of ways. For example, the predetermined threshold can be about negative one one-hundredth of a degree Celsius per second. For example, the method can include displaying, on a display in electronic communication with the cooking device, an error message communicating a detected flame-out scenario.

In an embodiment, an integrated valve is provided. The integrated valve can include a burner selection valve configured to selectively link, based on one or more user burner selections, a fuel supply to a combination or sub-combination of a plurality of burners, and a motorized valve configured to adjust, based on one or more user temperature selections, a flow rate of fuel from the fuel supply to the linked combination or sub-combination of the plurality of burners.

The integrated valve can vary in a number of ways. For example, the burner selection valve can be a purely mechanical valve isolated from an electronic controller. For example, the plurality of burners can include a pilot burner and three cooking burners. For example, the motorized valve can be configured to receive electronic input from a controller in electrical communication with the motorized valve. For example, the motorized valve can be configured to adjust the flow rate based on a current temperature of a cooking chamber in which the plurality of burners are disposed. For example, the integrated valve can include a plurality of microswitches configured to provide to a user interface an indication of a currently-active combination or sub-combination of the plurality of burners.

In an embodiment, a cooking device is provided. The cooking device can include a housing defining an internal cooking chamber, and a plurality of gas-powered heat sources configured to cook a food product. The plurality of gas-powered heat sources can be disposed in the internal cooking chamber. The cooking device can also include an integrated valve, which can include a burner selection valve configured to selectively fluidly link a combination or sub-combination of the plurality of gas-powered heat sources to a fuel supply, and a motorized valve configured to control a flow rate of fuel supplied to the selected combination or sub-combination of gas-powered heat sources.

The cooking device can vary in a number of ways. For example, the cooking device can include a user interface configured to receive user inputs to control operations of the plurality of gas-powered heat sources and the integrated valve. In some variations, the motorized valve can be configured to control the flow rate based on or more set-point temperatures receives at the user interface. In some aspects, the motorized valve can be configured to control the flow rate based on a measured temperature of the internal cooking chamber. For example, the burner selection valve can be a purely mechanical valve isolated from an electronic controller. For example, the plurality of gas-powered heat sources can include a pilot burner and three cooking burners.

In an embodiment, a cooking device is provided. The cooking device can include a housing defining an internal cooking chamber, and one or more gas-powered heat sources disposed in the internal cooking chamber. The one or more gas-powered heat sources can be configured to cook a food product. The cooking device can also include a controller configured to control one or more cooking operations of the cooking device. The controller can include a ground-monitoring circuit configured to cut power to the controller when a loss-of-ground event is detected.

The cooking device can vary in a number of ways. For example, the cooking device can include a convection assembly including a convection fan configured to circulate heated air in the internal cooking chamber. The controller can be configured to operate the convection assembly. For example, the cooking device can include an integrated valve. The integrated valve can include a burner selection valve configured to activate and deactivate a combination or sub-combination of the one or more gas-powered heat sources, and a motorized valve configured to adjust a flow rate of fuel supplied to the selected combination or sub-combination of one or more gas-powered heat sources. In some aspects, the burner selection valve can be electronically isolated from the controller. In other aspects, the motorized valve can be electronically connected to the controller. In some variations, the motorized valve can be configured to adjust the flow rate based on a current temperature of the internal cooking chamber and a desired temperature received via a user input.

In an embodiment, a cooking device is provided. The cooking device can include a housing defining an internal cooking chamber, and one or more gas-powered heat sources disposed in the internal cooking chamber. The one or more gas-powered heat sources can be configured to cook a food product. The cooking device can also include a valve configured to adjust a flow rate of fuel supplied to the one or more gas-powered heat sources. The valve can be in electronic communication with a controller. The cooking device can further include a controller configured to control one or more cooking operations of the cooking device. The controller can include a capacitor storing a charge quantity great enough to move the valve from a current position to a minimal flow rate position in a power loss scenario.

For example, the cooking device can include an integrated valve. The integrated valve can include a burner selection valve configured to activate and deactivate a combination or sub-combination of the one or more gas-powered heat sources, and a motorized valve configured to adjust a fuel rate of fuel supplied to the selected combination or sub-combination of one or more gas-powered heat sources. In some variations, the burner selection valve can be electronically isolated from the controller. In other variations, the motorized valve can be electronically connected to the controller. In some aspects, the motorized valve can be configured to adjust the flow rate based on a current temperature of the internal cooking chamber and a desired temperature received via a user input.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

These and other features will be more readily understood from the following detailed description taken in conjunction with the accompanying drawings, in which:

FIG. 1 depicts a perspective view of a propane grill with a convection system according to an embodiment;

FIG. 2 depicts a rear perspective view of the propane grill of FIG. 1;

FIG. 3 depicts a perspective view of the propane grill of FIG. 1 without a lid;

FIG. 4 depicts a partial perspective view of the propane grill of FIG. 1 without grill stand doors;

FIG. 5 depicts the propane grill of FIG. 4 without a fuel source;

FIG. 6 depicts a top view of the propane grill of FIG. 1 without a lid or grill grates;

FIG. 7 depicts a perspective view of burners usable with the propane grill of FIG. 1;

FIG. 8 depicts a partial top view of a burner of FIG. 7;

FIG. 9 depicts a partial top view of the burners of FIG. 7 with an indicator;

FIG. 10 depicts a front view of a simplified burner duct according to an embodiment;

FIG. 11 depicts a front view of a simplified burner duct in relation to flame dimensions;

FIG. 12 depicts a perspective view of the burner duct of FIG. 10 with a flame tamer;

FIG. 13 depicts a perspective view of a grease director according to an embodiment;

FIG. 14 depicts a front view of a pair of the burner ducts of FIG. 10 with the grease director of FIG. 13;

FIG. 15 depicts a perspective view of the burners of FIG. 7 with flame tamers usable with the propane grill of FIG. 1;

FIG. 16 depicts a top perspective view of the burners and flame tamers of FIG. 7 with the indicator of FIG. 9 visible through a flame tamer;

FIG. 17 depicts a cross-sectional view of the burners and flame tamers of FIG. 15 and burner ducts usable with the propane grill of FIG. 1;

FIG. 18 depicts a partial cross-sectional view of the propane grill of FIG. 1;

FIG. 19 depicts a perspective view of two grease directors according to an embodiment;

FIG. 20 depicts a partial cross-sectional view of a burner duct and a flame tamer usable with the propane grill of FIG. 1 according to an embodiment;

FIG. 21 depicts a cross-sectional view of a burner and a burner duct usable with the propane grill of FIG. 1 according to an embodiment;

FIG. 22 depicts a perspective view of a convection system of the propane grill of FIG. 1;

FIG. 23 depicts a perspective view of the propane grill of FIG. 1 with a lid and a side removed;

FIG. 24 depicts a simplified diagram of a recirculation duct with a bump-out;

FIG. 25 depicts a simplified top view of convection zones in the propane grill of FIG. 1 generated by the convection system of FIG. 22;

FIG. 26 depicts a partial rear perspective view of the propane grill of FIG. 1 including an exhaust vent;

FIG. 27 depicts a partial cross-sectional view of the convection system of FIG. 22;

FIG. 28 depicts a rear perspective view of the convection system of FIG. 22 and smoke unit of the propane grill of FIG. 1;

FIG. 29 depicts a cross-sectional view of the convection system and smoke unit of FIG. 28;

FIG. 30 depicts a partial perspective view of the convection system of FIG. 22;

FIG. 31 depicts a cross-sectional view of an aspirator of the convection system of FIG. 22 according to an embodiment;

FIG. 32 depicts a partial perspective view of overlayed variations of the aspirator of FIG. 31;

FIG. 33 depicts a cross-sectional view of the overlayed variations of the aspirator of FIG. 31;

FIG. 34 depicts a chart depicting a relationship between variables of the convection system and smoke unit of FIG. 28;

FIG. 35 depicts a simplified diagram of a gas train according to some embodiments;

FIG. 36 depicts a simplified diagram of the components of the propane grill of FIG. 1;

FIG. 37 depicts a front view of the UI of the propane grill of FIG. 1 according to an embodiment;

FIG. 38 depicts a perspective view of an integrated valve usable with the propane grill of FIG. 1 according to an embodiment;

FIG. 39 depicts another perspective view of the integrated valve of FIG. 38;

FIG. 40 depicts a chart explaining the relationship between valve switch states of an integrated valve of the propane grill of FIG. 1;

FIG. 41 depicts a variation of the UI of FIG. 37 with an ignition indicator;

FIG. 42 depicts a thermocouple and a thermopile used to detect an ignition state of the pilot burner of the propane grill of FIG. 1 and to output the detection to the indicator of FIG. 41;

FIG. 43 depicts a diagram of a car-like ignition, according to some embodiments, usable with the propane grill of FIG. 1;

FIG. 44 depicts a simplified diagram of pressure values over a gas train of the propane grill of FIG. 1;

FIG. 45 depicts a diagram of achievable temperature bands at different fuel levels for the propane grill of FIG. 1;

FIG. 46 depicts a diagram of exhaust vent area performance for the propane grill of FIG. 1;

FIG. 47 depicts a diagram of the relationship between power output (BTU) and valve angle of the integrated valve for the propane grill of FIG. 1;

FIG. 48 depicts a diagram of the relationship between valve angle of the integrated valve as a function of temperature rise in the cavity of the propane grill of FIG. 1;

FIG. 49 depicts a diagram of the relationship between lid state of the propane grill of FIG. 1 and generated power;

FIG. 50 depicts a diagram of the relationship between fuel tank pressure and power output for several regulator variations;

FIG. 51 depicts a diagram of achievable temperature ranges for several fuel tank pressures across one, two, and three operating burners for the propane grill of FIG. 1;

FIG. 52 depicts a diagram of a PID control loop according to an embodiment;

FIG. 53 depicts a diagram of a gas-out detection control loop according to an embodiment;

FIG. 54 depicts a diagram of a flare-up detection control loop according to an embodiment;

FIG. 55 depicts a diagram of a flare-up response and overheat check control loop according to an embodiment;

FIG. 56 depicts a diagram of a flame-out detection control loop according to an embodiment;

FIG. 57 depicts a diagram of an overheat or flame-out response control loop according to an embodiment;

FIG. 58 depicts a diagram of a power-loss response circuit according to an embodiment;

FIG. 59 depicts a diagram of a power-loss response loop using the circuit of FIG. 68 according to an embodiment;

FIG. 60 depicts a ground-monitoring response loop according to an embodiment;

FIG. 61 depicts a ground monitoring circuit configured to perform the response loop of FIG. 60;

FIG. 62 a low-power circuit used to supply power to the ground-monitoring circuit of FIG. 60;

FIG. 63 depicts a diagram of grill components usable with the propane grill of FIG. 1 according to a variation;

FIG. 64 depicts a diagram of grill components usable with the propane grill of FIG. 1 according to another variation;

FIG. 65 depicts a simplified diagram of a gas train with a solenoid instead of an integrated valve;

FIG. 66 depicts a simplified diagram of the gas train of FIG. X with two solenoids in series;

FIG. 67 depicts a simplified diagram of the gas train of FIG. X with four solenoids in parallel, each solenoid corresponding to one of three burners and a pilot burner;

FIG. 68 depicts an underside perspective view of the propane grill of FIG. 1 with a solenoid to selectively supply fuel to one or more burners;

FIG. 69 depicts a solenoid scheme for a single-burner grill according to an embodiment;

FIG. 70 depicts a variation of the solenoid scheme of FIG. 69 for a multi-burner grill according to an embodiment;

FIG. 71 depicts a variation of the solenoid scheme of FIG. 70 for an adjustable multi-burner grill; and

FIG. 72 depicts a variation the solenoid scheme of FIG. 71 for an adjustable multi-burner grill with wireless communication capabilities.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Certain illustrative embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting illustrative embodiments and that the scope of the present invention is defined solely by the claims. The features illustrated or described in connection with one illustrative embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape.

Grills differ in numerous ways from gas-powered ovens, including gas-powered ovens with convection. Some of these differences can include flame placement, manner of cooking, food waste management, achievable temperature, etc. It is well-known that certain foods are better suited to oven cooking, while other foods are better suited to grills, and a consumer, faced with the option to choose an oven or a grill for a given food dish may consider the operative capabilities and benefits of each device to make their decision.

One difference between the devices is flame location, which affects the kind of cooking each device can perform. In gas-powered convection ovens, the flames providing heat for cooking are typically located outside a cooking chamber. The flames can be located, for example, behind an oven plate in the rear of the oven or beneath a floor of the cooking chamber out of the flow path for convection. Heat created by the flames can pass into the cooking chamber via radiation, and the heated air in the cooking chamber can be circulated by a convection fan during a cooking operation. The flames themselves are protected from direct interaction with air currents during convective cooking operations. These ovens may also feature additional heat sources or heating elements in other regions of the cooking chamber, such as a broiler heat element located on a ceiling of the cooking chamber in order to brown food in a controlled manner. In contrast, grill flames are located directly within a cooking cavity beneath a main cooking surface. The flames output high heat to a cooking surface through a flame tamer or some kind of protection layer, and the heat is directly impacting any food placed on the main cooking surface.

Flame location then affects the kind of cooking or manner of cooking that is feasible for both ovens and grills. While ovens contain one or more racks or surfaces upon which cooking takes place, cooking rarely if ever occurs directly on these one or more racks. Instead, any number of trays, baking dishes, or other vessels are placed atop the one or more racks as a sort of buffer between the support of the racks and the food itself. In contrast, grilling primarily occurs through direct contact with the main cooking surface. Food receives direct exposure to heat emitted by the grill flames, and the close proximity to high-output flames contributes heavily to the unique and desirable traits of grilled food. Additionally, conduction via the grill grate can be an additional mechanism of heat transfer to grill food, and conduction can be used to produce desirable grill marks to show that a piece of food, such as a steak, was cooked via a grill.

This close proximity typically necessitates proper airflow management within the grill's cooking chamber. The flames must be fed by oxygen-rich air to output high heat, but they must also be protected from wind and too much air or else they risk being extinguished. Gas-powered convection cooking fans do not require the high temperatures of grilling, so the flames can be placed outside the cooking chamber for more indirect heat. This placement can also serve to protect the flames from being extinguished by the oven's own convection fan during convective cooking operations. Typically, ovens can output up to 16,000 to 17,000 BTUs of heat to operate at temperatures up to between about 450 and 500 degrees Fahrenheit. Localized temperatures from operations like broiling may reach slightly higher than this range, but the average temperature of the cooking chamber almost never reaches higher. Components in the oven could suffer damage and wear if exposed to heightened temperatures for extended periods of time, and the cooking operations for which ovens are utilized do not necessitate heightened temperatures. Grills, on the other hand, can output much higher heat-twice or more that of ovens—to reach temperatures of 600, 650, 700+ degrees Fahrenheit. Again, the cooking operations for which grills are utilized often necessitate this heightened temperature output. A steak cooked in an oven may turn out with a texture like cured leather, but a well-grilled steak, at temperatures high enough to break down the steak's tough proteins, can be made tender and delicious.

One reason that ovens more or less necessitate the use of another vessel, such as a baking dish, while grills do not involves food waste management. Food placed directly on an oven rack may drop food waste in the form of juices, crumbs, etc. through gaps in the oven rack onto a floor of the oven's cooking chamber. This deposited food can burn and release undesirable smells or smoke into the cooking chamber, which can detrimentally affect food cooking in the oven. Over time, grease may become baked onto the surfaces of the cooking chamber and off-gas into the cooking chamber whenever the oven is operated. Many ovens must be regularly and thoroughly cleaned for proper performance because the accumulated food waste will otherwise present a risk to operation and potentially to a user's health. But for user intervention to clean the oven, there is often no automatic or natural mechanism with which an oven can maintain itself. In contrast, grills harness food waste to impart desirable flavors and aromas onto food. For example, steaks grilled on a grill grate will drop fat and juice through the grill grate and onto flame tamers or some other protective flame surface during a cooking process. Upon impact, this fat and juice can be instantly vaporized by the intense heat produced by the flames, and the vapors and smoke can ultimately flavor the grilling steak. In some instances, dripping fat may cause localized flare-ups of flame to brown or char the grilled food. This, too, can be desirable. Of course, grills must have some form of food waste management, such as a grease tray or other features, in order to prevent the accumulation of large deposits of ignitable grease. But the controlled production of smoke and vapors from the food waste is often critical to well-grilled food.

Propane grills with convection systems are described herein. The combination of traditional propane grilling with convection airflow to create a more even cooking environment, provides a unique combination of benefits in one cooking system. This combination of features differs from those features of either convection ovens or traditional grills. The introduction of convection into a gas-powered grill is incompatible with traditional systems, which consistently design ways to fight excess air and wind in the cooking cavity introduced above. Propane or gas flames can be blown out easily, and many gas grills feature safety protocols to identify a flame-out scenario to avoid leaking unburned gas. Consequently, the inclusion of convection in a gas-powered grill introduces a host of challenges to operation, most notably the maintenance of flame life while air is sufficiently circulated within a cooking cavity of the grill, and it runs directly counter to traditional grill designs. These challenges simply do not exist for traditional grills, which seek to prevent the unwanted ingress of excess air (or air circulation generally) in their cooking cavities. In the grills described herein, the desirable and deliberate air circulation by an on-board convection system risks flame life, so these propane grills can include specific flame protection mechanisms, including burner ducts and grease management systems to enable grilling with convection, as well as onboard control logic to handle error situations.

The grills described herein can include a variety of features and variations on components, sub-systems, etc. Where similar such features or variations are described, they can be interchangeable and usable with any given grill set-up. The specific grills shown and described are exemplary only.

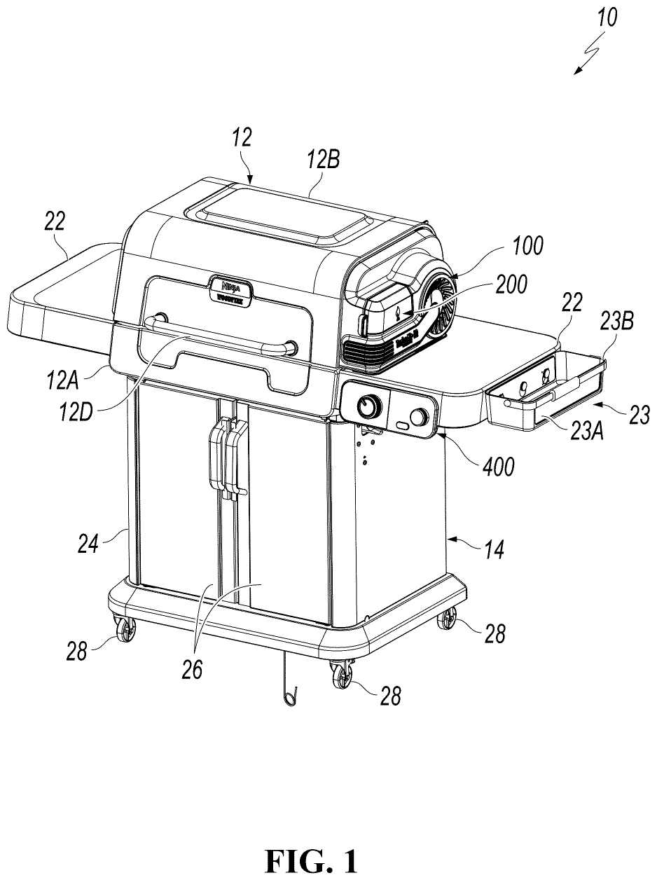

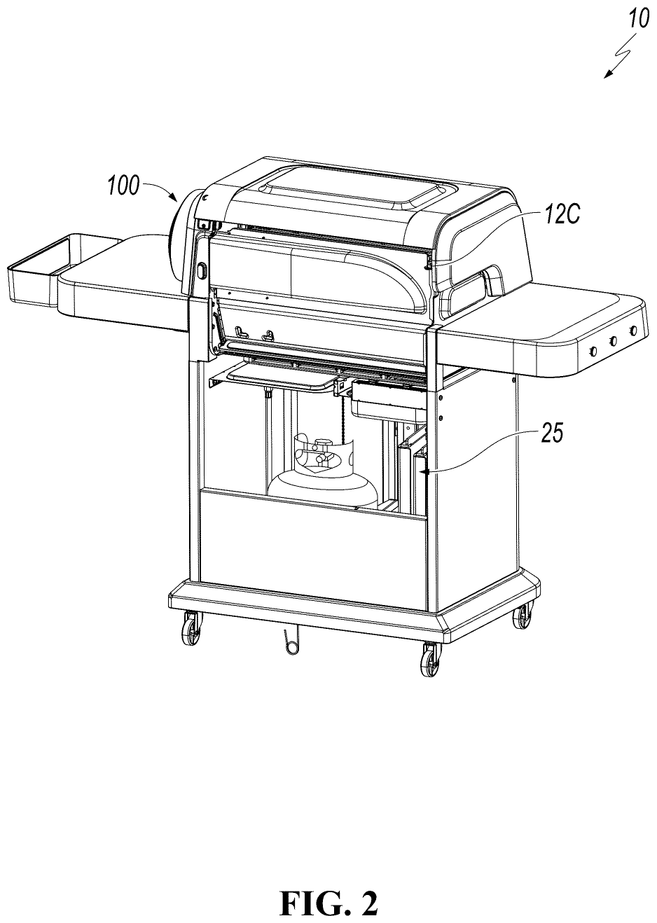

An example of a propane grill with a convection system like the kind described above is depicted in FIG. 1 onward. The propane grill 10 comprises a housing unit 12 set atop a grill stand 14. The housing unit 12 can include the components of the propane grill 10 responsible for cooking food, and the grill stand 14 can provide the propane grill 10 with support and stability during use and maneuvering. The housing unit 12 defines an interior cooking chamber 16 within which food can be cooked using heat produced by gas-fueled flames. The housing unit 12 includes a substantially rectangular housing base 12A and a lid 12B pivotally coupled to the housing base via a hinge 12C located at a rear of the propane grill 10 and seen especially in FIG. 2. A handle 12D is located on a front of the lid 12B such that a user can pivot the lid 12B through manipulation of the handle 12D and relative to the housing base 12A via the hinge 12C to gain access to the interior cooking chamber 16 therein. Generally, the housing unit 12 and the propane grill 10 in turn can take on a variety of forms, but as depicted, the housing base 12A has a generally rectangular shape, and, with the lid 12C, tapers upward so that the housing unit 12 as a whole has a substantially trapezoidal appearance. The housing unit 12 can further include a convection system 100, a smoke unit 200, and at least a portion of a control system 300, each of which is described in greater detail below.

The grill stand 14 is located beneath the housing unit 12 and can be substantially fixed thereto, for example, via a plurality of fasteners such as a bolts or the like. The grill stand 14, although depicted having a generally rectangular form complementary to the shape of the housing base 12A, can vary in form either in conjunction with or separately from the housing unit 12. The grill stand 14 can comprise a solid frame 24 defining an interior space 25, which can be accessed via one or more doors 26 located on a front of the grill stand 14. To assist with maneuverability of the propane grill 10, the grill stand 14 can be placed atop a plurality of casters 28, which can be individually locked or unlocked as needed.

The propane grill 10 can feature one or more additional surfaces, including shelving, burners, etc. For example, as shown, the housing unit 12 can include a pair of shelves 22 extending laterally on either side of the housing unit 12. The shelves 22 provide platforms upon which tools, plates, food, etc. can be placed for convenience. The shelves 22 are substantially rectangular in form, although the shelves can take on any form desired. Although depicted as having smooth flat tops, the shelves 22 can feature additional modules, such as side burners, infrared burners, warming plates, cooking and/or heating components, etc. These additional modules can be operated independently of cooking operations taking place in the rest of the propane grill 10 in order to provide a user with greater flexibility for cooking. The shelves 22 can also feature hooks or the like from which tools and grilling implements can be hung for convenience.

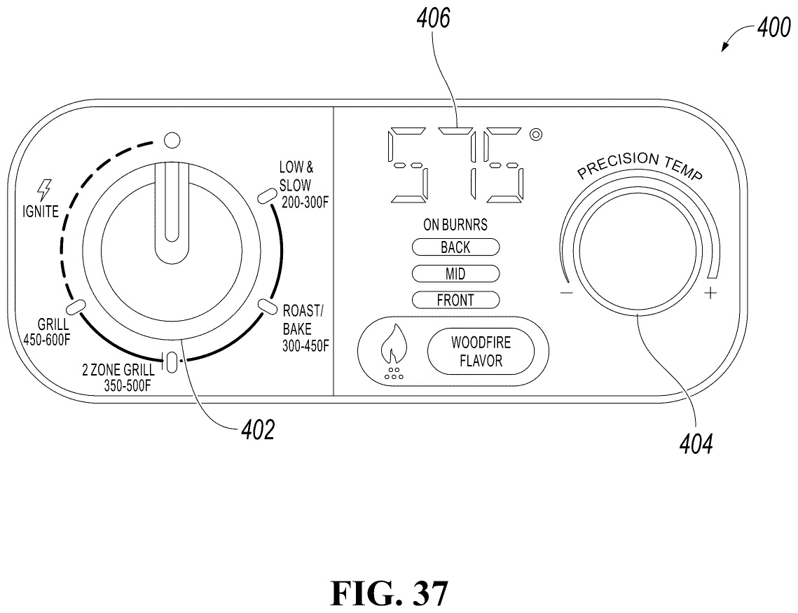

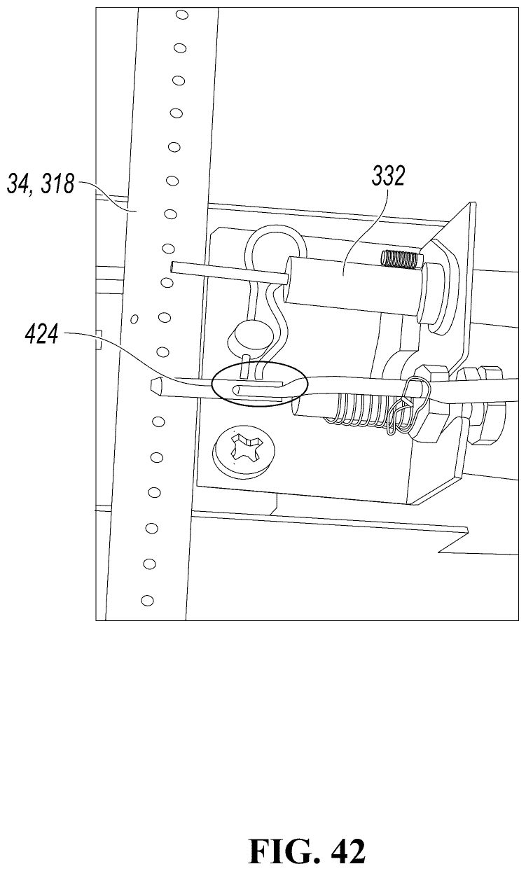

Further, a UI 400 is shown depicted on the shelves 22. The UI 400 includes a number of inputs which can be used to control operations of the propane grill 10 involving each of the convection system 100, the smoke unit 200, and the control system 300, in addition to cooking operations occurring elsewhere, such as on one or more additional modules of the propane grill 10. The UI 400 and such operations will be described in greater detail below. Although the UI 400 is shown depicted on a right side of the front of the propane grill 10, the UI 400 can be located anywhere it is accessible by a user. In some implementations, the UI 400 can be removable from and/or remote from the propane grill 10, and can operate the propane grill 10 via a wired and/or wireless connection. Additionally, inputs at the UI 400 may not be the only way in which a user is able to control operations of the propane grill 10. For example, a user can monitor and/or control operations of the propane grill 10 via an external device, such as a smartphone, smart device, computer, etc. Additional details of the UI 400 and other variations will be described with regard to FIGS. 37-43.

Extending from a side of the shelves is a caddy 23, which can conveniently house grilling accessories, such as tools, implements, spices, etc. The caddy 23 can be removably attached to the shelves 22, or other anywhere else on the propane grill 10 via a clip, magnets, or the like. The caddy 23 generally features a recessed body 23A and a handle 23B coupled to the body 23A to carry the caddy 23 to and from the propane grill 10.

As introduced above, the propane grill 10 further includes a convection system 100 and a smoke unit 200. Both the convection system 100 and the smoke unit 200 make up part of the housing unit 12 and will be described in greater detail below.

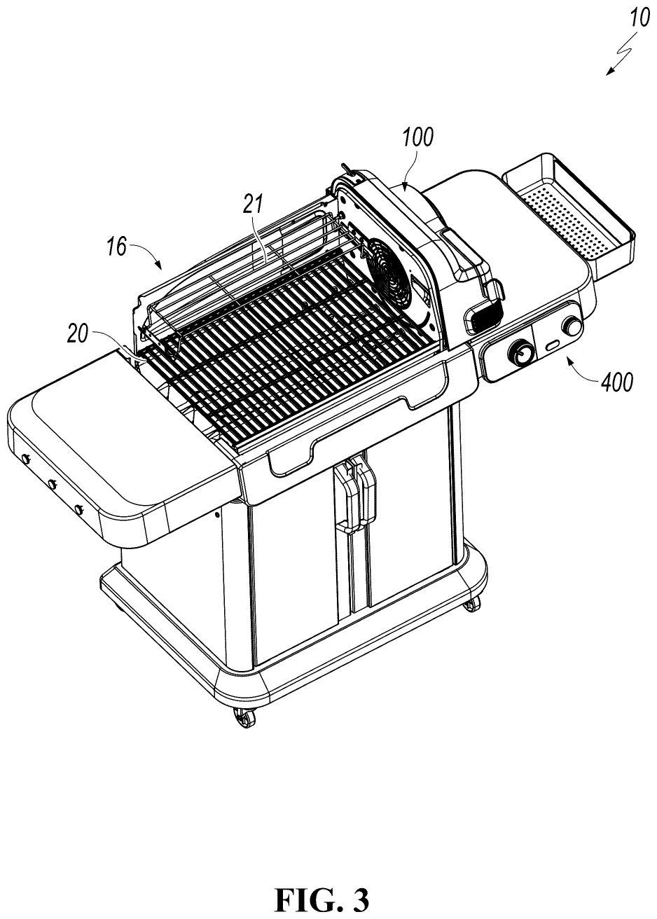

FIG. 3 depicts the propane grill 10 with the lid 12B removed. From this view, the interior cooking chamber 16 is viewable, as well as an internal portion of the convection system 100. Within the interior cooking chamber 16 is a main cooking surface 20 upon which food can be cooked. The main cooking surface 20 can vary in form. As depicted in FIG. 3, the main cooking surface can take the form of one or more removable cooking grates. As described herein, the one or more cooking grates can be swapped for another kind of cooking surface, such as a griddle or the like, depending upon a user's preference. The main cooking surface 20 can also take the form of a structure to support food while cooking, such as a spit, a rotisserie, a basket, a vessel, a utensil, a skewer, etc. Also included within the interior cooking chamber 16 is a secondary cooking surface 21. The secondary cooking surface 21 is depicted in the form of a shelf comprising a separate grill grate, although the exact structure of the secondary cooking surface 21 can vary just as the structure of the main cooking surface 20 can vary. The secondary cooking surface 21 as shown is elevated above the main cooking surface 20, and it does not extend all the way to a front of the propane grill 10 to ensure that the main cooking surface 20 is not blocked by the secondary cooking surface 21. Food can be placed atop the secondary cooking surface 21 when alternative cooking is desired. Convection and certain cooking modes of the propane grill 10 can provide a substantially even heat gradient both across the interior chamber 16 left to right as well as from top to bottom such that there can be minimal to no difference in cooking effects for food placed upon the main cooking surface 20 versus the secondary cooking surface 21 in those modes. Effectively, the secondary cooking surface 21 provides increased cooking space so that when the main cooking surface 20 is full, food can be placed atop the secondary cooking surface 21 to achieve the same desired outcome compared to food placed atop the main cooking surface 20. The flexibility provided by the convection system 100 will be described in greater detail below.

The grill stand 14 is located beneath the housing unit 12 and can be substantially fixed thereto via a plurality of fasteners such as a bolts or the like. The grill stand 14, although depicted having a generally rectangular form complementary to the shape of the housing base 12A, can vary in form either in conjunction with or separately from the housing unit 12. The grill stand 14 can comprise a solid frame 24 defining an interior space 25 to house accessories and/or components of the propane grill 10 The interior space 25 can be open and readily accessible, or the interior space 25 can be accessed via one or more doors 26 located on a front of the grill stand 14. To assist with maneuverability of the propane grill 10, the grill stand 14 can be placed atop a plurality of casters 28, which can be individually locked or unlocked as needed. As depicted, the grill stand 14 can flare outward at a bottom thereof to increase the overall footprint of the propane grill 10. The casters 28 can be located on an outer region of this flared base, which can assist with supporting and stabilizing the propane grill 10.

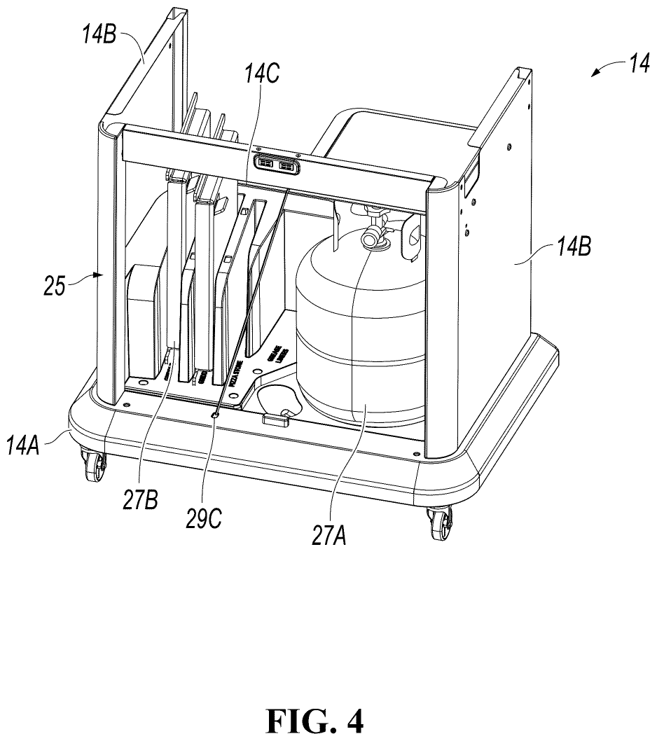

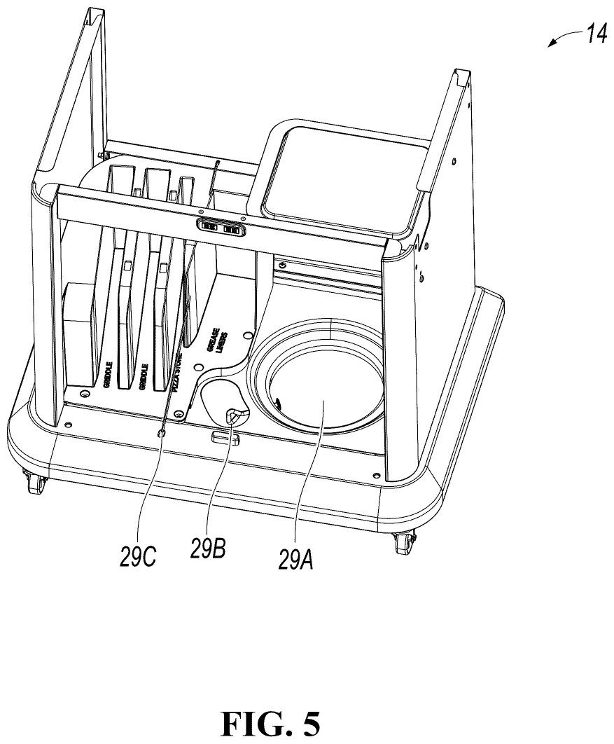

FIG. 4 depicts the interior space 25 of the grill stand 14. As depicted, the grill stand 14 includes a base 14A, one or more side panels 14B, and a rear panel 14C, which together with the doors 26 delineate the interior space 25 of the grill stand 14. The base 14A includes a tank seat 29A defined therein to receive and secure a fuel tank 27A, such as a propane tank. The base 14A can also include a screw clamp 29B that can be actuated in order to secure a received fuel tank 27A. The screw clamp 29B can be especially seen in FIG. 5. For regulatory compliance, a divider 29C can bisect the interior space 25 of the grill stand 14 so that only one fuel tank 27A can be placed within the propane grill 10 at a time. However, where the divider 29C is not required, it can be removed. Other items can be placed and stored within the grill stand 14 interior space 25 as needed, including grilling accessories, tools, and more. For example, as shown in FIGS. 4 and 5, two griddle plates 27B can be stored within the interior space 25. The griddle plates 27B can replace the grill grates as part of the main cooking surface 20 as desired in order to expand the scope of cooking operations available to a user of the propane grill 10. While the propane grill 10 is capable of using a fuel tank 27A for fuel, the propane grill 10 can also be configured to connect to a fixed gas source, such as one attached to a house or other structure.

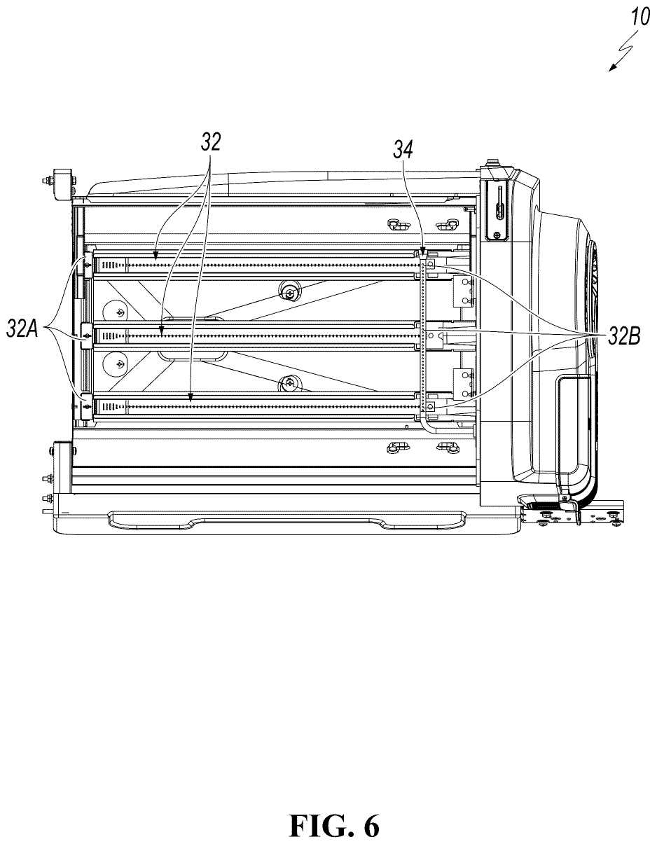

As introduced, cooking operations with the propane grill 10 involve the combustion of gaseous fuel, such as propane, in order to heat and cook food in a desired manner. The combustion of gaseous fuel is performed using a one or more heat sources, which can take various forms. For example, as depicted and described herein, the one or more heat sources can take the form of a plurality of burners 32. FIG. 6 depicts a top-down view of the propane grill 10 with the lid 12B, the main cooking surface 20, and components of the flame protection system removed. From this view, the burners 32 of the propane grill 10 are clearly depicted, and they take the form of three burner tubes running laterally across the interior of the housing unit 12. Each of the burners 32 can be secured to the housing unit 12 at a first end 32A and at a second end 32B thereof. In addition to the three burners 32, a pilot burner 34 can be disposed in the housing substantially perpendicular to each of the burners 32. Although three substantially parallel burner tubes are depicted, one or more burners of various forms and in various arrangements can be used in the propane grill 10.

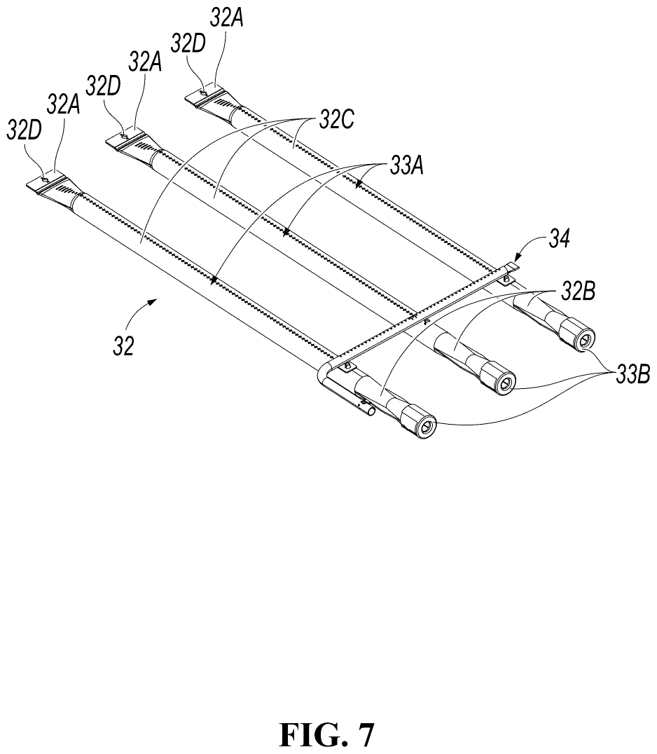

FIG. 7 depicts the burners 32 and pilot burner 34 in isolation. As depicted, each of the burners 32 is substantially identical, so description for a given burner 32 can be applied more broadly to the burners 32 as a whole. The burner 32 generally includes a nozzle 33A coupled to a tube body 33B. The nozzle 33A can be in fluid communication with the gaseous fuel via one or more fuel lines such that a mixture of gaseous fuel (e.g., propane) and primary air, are injected into the tube body 33B. The tube body 33B is substantially elongate with a generally constant diameter along a length thereof. At the first end 32A of the burner 32, the tube body 33B can be crimped so that it is sealed while also providing a hole 32D via which the burner 32 can be mounted within the propane grill 10. The tube body 33B can be connected to the pilot burner 34 at the second end 32B. A plurality of outlets 32C are defined along the length of the tube body 33B at substantially equal intervals. Each of the outlets 32C is substantially similar in both shape and size to provide for even heating along the burner 32. However, at some points along the burner 32, the number, size, shape, and/or spacing of the outlets 32C can vary. This variance can result in the selective output of flames as desired to concentrate heat in a certain area of the propane grill 10, for example.

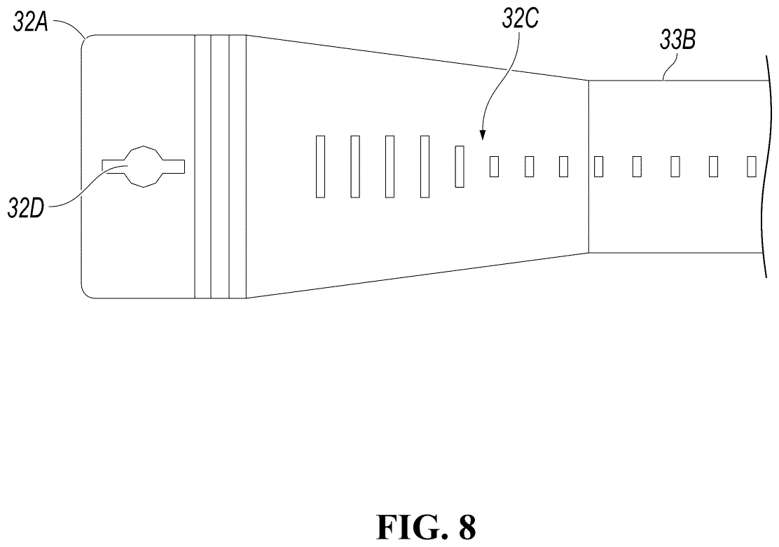

As shown in FIG. 8, the outlets 32C can vary at the first end 32A of the burner 32. The outlets 32C on the crimped portion of the tube body 33B more densely populate the available area of the tube body 33B as compared to rest of the burner 32. This increased outlet density can ensure that more flame is created at this region, which, as explained previously, can be useful for controlling overall heat distribution in the propane grill 10. Further, the relative discrepancy between these larger outlets 32C as compared to those on the rest of the burner 32 can assist with fluid flow within the burner. In general, some amount of fluid pressure is required to force fuel and primary air through a burner, and some amount of fluid pressure is required to properly expel this mixture through a burner outlet when ignited to result in a healthy flame. If a flame is too weak, it can be extinguished more easily, or, it can fail to supply proper heat to that region of the grill. By altering the outlets 32C as described herein, flame health can be more easily maintained at a distance far from the nozzle 33A. In other words, the concentration of outlets 32C of a larger size at the first end 32A can assist in ensuring proper flame health is achieved at that first end 32A.

While the details for a given burner 32 can be applied to all burners 32 in the propane grill 10, variances between the burners are also contemplated herein. For example, the described burner 32 can vary in a number of ways. These variances can be applied evenly across all present burners 32, or they can be applied unevenly such that one burner among the present burners 32 may have, for example, a first type of outlet distribution while a second burner among the present burners 32 may have a second, different type of outlet distribution. These variations can depend upon the operations and features of the propane grill 10.

The pilot burner 34 is also shown in FIG. 7 running approximately perpendicular to the burners 32. As a pilot light, the pilot burner 34 can be ignited and kept ignited while the propane grill 10 is in operation. As described in detail below, each burner 32 can include its own internal valve to selectively enable the flow of fuel therein. While the pilot burner 34 is ignited, flame to a given burner 32 can depend upon the state of that burner tube's 32 internal valve state.

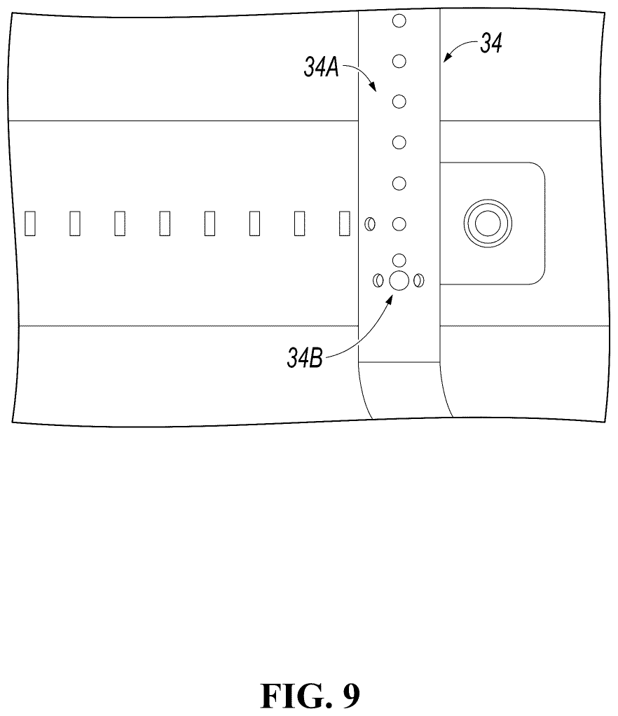

The pilot burner 34 can also include its own outlets 34A running down its length to support flame. The outlets 34A can be sized to and spaced to maximize flame life because of the pilot light's 34 role in providing flame to the burners 32. Similar to the burners 32, the pilot burner 34 can feature varied outlet distribution. For example, as shown in FIG. 9, the pilot light can include a set of outlets that form an indicator 34B. The indicator 34B provides a clear and readily identifiable indication to user that the pilot burner 34 is properly lit. Gaseous fuel, such as propane, burns blue when it is burning efficiently. Blue flame can be difficult to see in certain ambient conditions, including when another light source like the sun shines on the propane grill 10. Grilling is especially popular in summer months and on sunny days, which means it can be difficult for a user to know if their pilot light 34 and their burners 32, in turn, are properly lit.

The indicator 34B, as depicted, takes the form of a plurality of outlets in close proximity. The exact number and size of the outlets can vary, but the principle remains the same. For flames created by the combustion of natural gases, complete combustion, resulting from sufficient oxygen supplied to the flame, yields blue flames. Incomplete combustion, resulting from insufficient oxygen supplied to the flame, yields orange flames. By clustering a plurality of outlets close together on the pilot light, a primary flame emitted by the indicator 34B (via the central outlet of the indicator 34B) can receive a smaller proportion of secondary air as compared to flames of the other outlets 34A because the secondary flames (via the peripheral outlets of the indicator 34B) starve the primary flame of oxygen, leading to incomplete combustion. A lower proportion of secondary air results in a more inefficient combustion of gas fuel, which turns the flame from blue to orange. Orange flame is much easier to spot than blue flame, even in when another light source, like sun, shines on the propane grill 10. Thus, the indicator 34B provides a better visual indication to a user in a wider variety of ambient conditions than traditional pilot flame. The incomplete combustion of gaseous fuel at the indicator 34B can be harnessed for this benefit. The exact number of outlets and their position relative to each other can vary so long as an indicator flame is starved of enough oxygen that it turns from blue to orange. In general, the distribution density of the outlets that make up the indicator 34B is greater than a distribution density of the rest of the outlets 34A of the pilot burner 34. Additionally, this kind of desirable incomplete combustion can arise by adjusting the individual sizes of the outlets that make up the indicator 34B, with or without increasing the distribution density of those outlets.

This indicator 34B can be located in a variety of positions on the pilot burner 34, but as shown, the indicator 34B is located on the pilot burner 34 in a position upstream that of the burners 32. This can be useful to inform a user of the overall flame health of the system because gaseous fuel entering the burner system must pass by this region with the indicator 34B in order to reach any other portion of the burners 32 or pilot burner 34. Additionally, the outlets 32C of the burners 32 located at the first end of thereof are described as varying in shape and/or distribution. These outlets 32C can also act as indicators for the respective burners 32. If the outlets 34C are showing flame, a user can know the respective burner 32 is receiving fuel properly. If an outlet 34C is not showing flame, a user can know that either the burner 32 is not functioning properly or the burner's 32 respective internal valve is closed, such as may be the case for certain cooking arrangements to be described in greater detail below.

Creating the flames required to heat and cook food is but one aspect to proper operation of the propane grill 10. As explained herein, the propane grill 10 includes a convection system 100, which provides numerous challenges simply not found with traditional propane grills. Because there is a convection system 100 moving heated air within the interior cooking chamber 16 of the propane grill 10 proximate to the burners 32, a number of features are also included within the propane grill 10 to ensure that the flames are protected. These features include burner ducts, flame tamers, skirts, and grease collectors, each of which makes an important contribution to the operational and functional capabilities of the propane grill 10 with respect to flame protection and grease management.

As introduced above, traditional grills typically include flame tamers or another kind of protective layer positioned directly between a main cooking surface and the flames outputted by the heating elements of the grill. This layer acts to protect the health of the flames from food waste dropped from the main cooking surface toward the flames by receiving and diverting that waste.

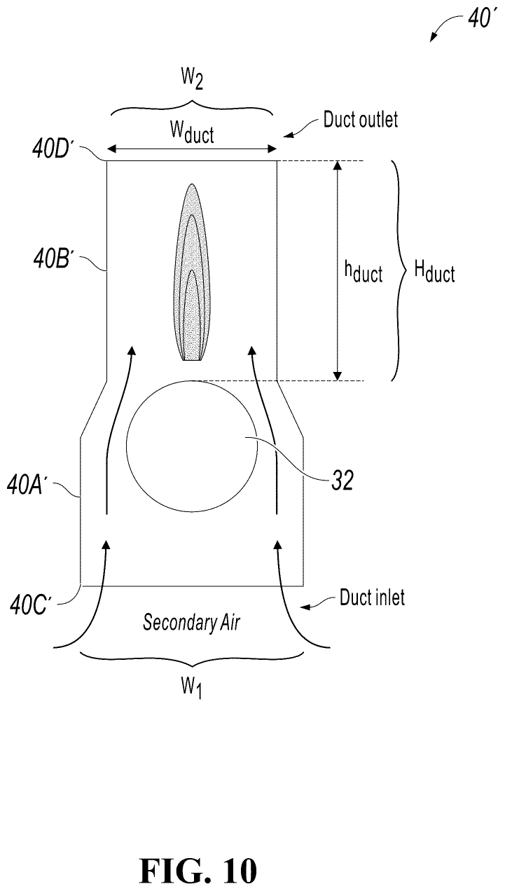

In principle, burner ducts operate both to shield flame from unwanted airflow and to guide wanted airflow, in the form of secondary air, to the flame in order to feed it. The form of a burner duct can vary to accommodate design requirements, including burner structure, cavity spacing, and more. Burner ducts can be built around most burner geometries, including burners having round or tube geometries, and they include a duct exit protected by a flame tamer which can expel heated combustion products and radiate heat into a cooking cavity. The duct inlet should have access to ambient air to ensure sufficient oxygen can be supplied to the enshrined burner in the form of secondary air supplied to the flame. For example, as shown in FIG. 10, a general concept of a burner duct 40′ is depicted, which is applicable to the propane grill 10. A burner 32 is disposed within the burner duct 40′. The burner duct 40′ includes a lower region 40A′ of a first width W₁ and an upper region 40B′ of a height H_{duct} second width W₂ smaller than the first width W₁. The lower region 40A′ has a bottom opening in the form of a duct inlet 40C′, which allows for air to enter into the burner duct 40′. The upper region 40B′ has another opening in the form of a duct outlet, which allows for air to flow out of the burner duct 40′. Thus, in conjunction, the burner duct 40′ forms a flow path between the duct inlet 40C′ and duct outlet 40D′. The burner 32 is disposed within the burner duct 40′ and is depicted as being centered within the lower region 40A′ (although specific position relative to the burner duct 40′ can vary). In operation, flames exit the burner 32 from a top thereof, which creates a natural convection current upward through the burner duct 40′ as the combustion products from the flames rise out of the duct outlet 40D′. As these products rise, they draw air into the burner duct 40′ via the duct inlet 40C′, and through a combination of Venturi flow and natural convection, secondary air, sourced from ambient air outside the system, flows around the burner 32 to the flames to provide them with a consistent supply of oxygen. This flow upward through the burner duct not only assists with drawing in fresh air but also prevents the backflow of air in a downward direction to harm the flames.

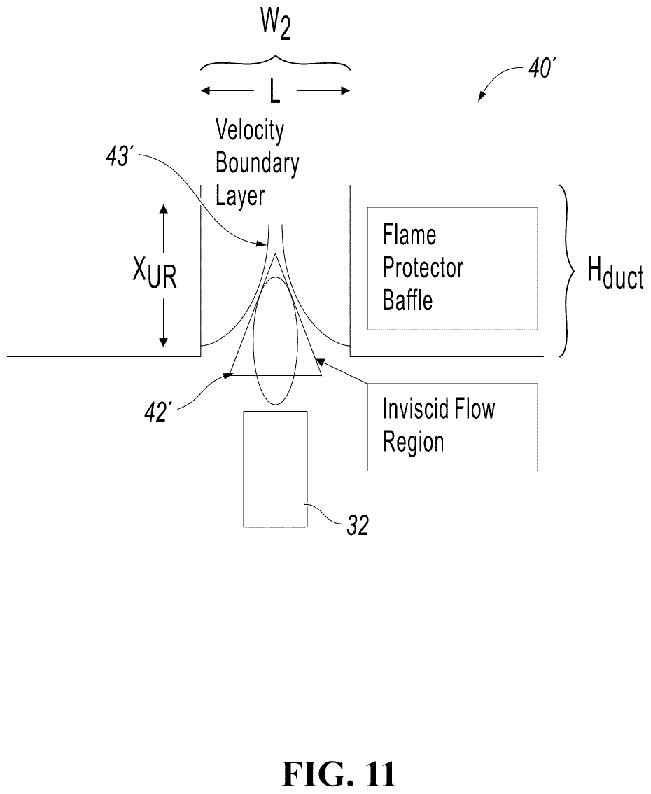

Through the specific burner duct 40′ geometry and position relative to the flames emitted by the burner 32, the burner duct 40′ is able to provide protection to the flames while also providing an effective channel of fresh secondary air, as introduced above. An illustration of this principle can be seen in FIG. 11. A simplified burner, flame, and burner duct are all depicted, which is similar to the arrangement of FIG. 10. The specific height and width of the burner duct keep the flame, as it's fed with secondary air, within the inviscid flow region 42. Within this region, shear and normal stresses on the flame are minimized, thereby keeping the flame insulated from the ingress of errant airflow which may otherwise extinguish it. The velocity boundary layer 43, beyond which these stresses are no longer negligible, is also depicted. Duct width and height can be optimized to keep the flame within this inviscid flow region, and it has been found that, within the propane grill 10, a minimum viable burner duct height H_{duct}, is approximately 6 cm based on minimum flame height. A range for a viable duct width, equivalent to W₁, is between about 12 and 50 mm, based on a flow rate of the combustion products and secondary air, as well as the viscosity of the air, which is affected by factors including temperature and pressure. When airflow through the burner duct 40′ is sufficient, excess air is effectively unable to enter the burner duct 40′ through the duct outlet 40D′ to reach and affect the flame.

Depending on the operative requirements of a grill, the flames may need to be larger or smaller. Using the above principles, properly-burner ducts can protect the flames no matter their size and no matter the operative requirements of the grill. These principles are applicable to all burner duct geometries described herein.

The burner ducts 40′ can be capped with flame tamers 44′, which also assist in flame protection. Flame tamers generally provide additional airflow protection to the combustion region, protect burner components from grease/food debris, and other items from interfering with the flame or damaging/corroding the burner 32. Further, flame tamers receive direct heat from flames and are heated to high temperatures. Thus, flame tamers can also vaporize received food drippings to enhance smoky flavors and aromas of food, while also directing excess grease and drippings toward a grease management system. In general, flame tamers can be build out of a variety of materials capable of withstanding the high temperatures and can be shaped into a variety of configurations. For example, the flame tamers shown can be made of steel and formed into an A-frame structure. Steel meets the material requirements of operation as the flame tamers themselves can reach temperatures excessively high temperatures. Depending upon the operative outputs of a propane grill, the material and design requirements of flame tamers can vary, and steel may not always be necessary. However, in the case of the propane grill 10, temperatures at the flame tamer level can reach values in excess of 1,100 degrees Fahrenheit, which could damage lesser materials, especially after many uses. More specifically, the flame tamers can be made of stainless steel so that they are rust- and corrosion-resistant. For example, a simplified flame tamer 44′, in the form of a generally A-frame structure, is depicted in conjunction with the burner duct 40′ in FIG. 9. The flame tamer 44′ can have a variety forms, as will be described herein. It is positioned over the burner 32, as explained above, to receive and direct combustion products and excess air outward. The flame tamer 44′, as shown, is wider than the burner outlet to ensure that the duct outlet 40D′ and flame are each well-protected from the circumstances described previously.

There are arrangements of grills that do not require the use of flame tamers or another protective layer between flames and a cooking surface. For example, in some arrangements, the burner ducts themselves can be designed so that the unwanted ingress of food waste is virtually non-existent. Burner ducts could be designed so that there is no direct path from a main cooking surface to a flame through the use of curving and/or variable burner duct geometries. If food waste is unable to fall onto the flames, the flames are protected. In other arrangements, the main cooking surface itself could be modified to protect flames. Grills often rely on a grill grate design for their main cooking surface. These designs feature deliberate gaps to expose the food to the convective products of the flames, but the gaps also allow food waste to drop downward. Rather than using a traditional grate design, a main cooking surface can be modified so that there are no gaps over areas above the burners and/or the flames themselves. This arrangement may result in a checkerboard-type or striped-type cooking surface in which more solid regions are located directly above the burners and/or flames, and gapped regions are located above regions away from the burners and/or flames for drainage of food waste from the main cooking surface. Relatedly, the main cooking surface can also feature channels to guide food waste to drains set within the cooking surface, which also may be located above regions without flames.

In addition to flame protection from excess air, grease management is also an important factor for the protection of flames and minimizing the risk of grease fires. However, while traditional propane grills can leave large openings through which grease can fall to be collected, a propane grill with the convection system, like the kind described herein, cannot manage grease in the same way. Large holes for grease can become another pathway through which air can flow unchecked. If these holes and gaps are too large, airflow management becomes largely destructive, as convection created by the propane grill 10 disrupts the flames, and proper airflow through the burner ducts is not achieved. Moreover, proper airflow is critical for controlling humidity and ambient air exchange within the propane grill. Grease management systems must balance proper grease drainage with minimal unintended air exchange.

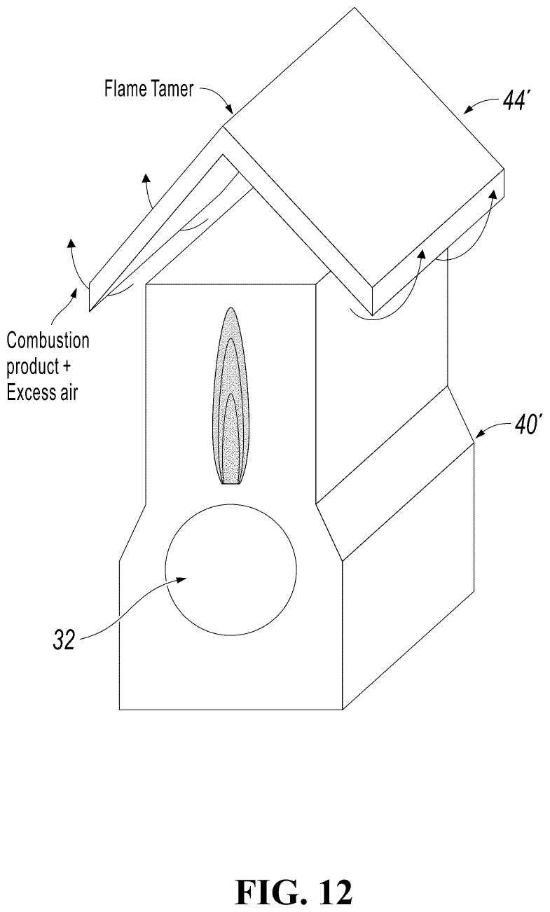

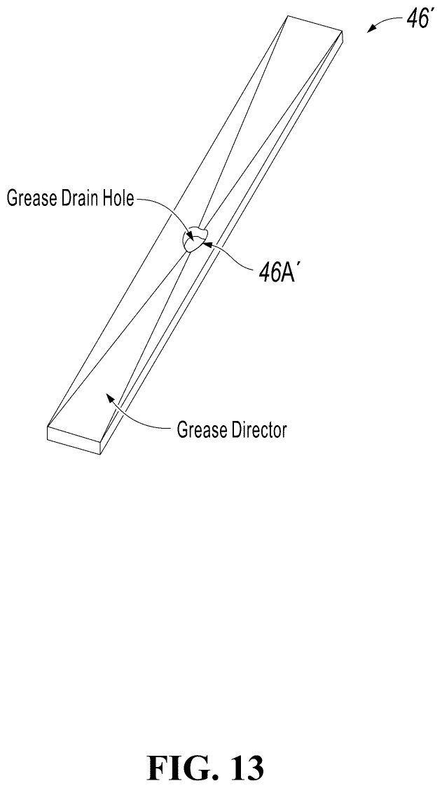

A simplified example of a grease management system is depicted in FIGS. 12-14 in the form of a grease director 46′ and in conjunction with the burner duct 40′ and the flame tamer 44′. In a propane grill (e.g., propane grill 10), more than one burner duct and flame tamer would be present to ensure sufficient heat coverage therein. The grease director 46′, as shown, spans a gap between the burner ducts 40′ so that grease directed to the gap will necessarily encounter the grease director 46′. The grease director 46′ has a generally sloped form leading to a grease drain hole 46A′ in the central region thereof, making the grease director 46′ a generally elongate funnel. The grease director 46′ can be removable from the propane grill 10 in order to facilitate maintenance and cleaning, and where required, more than one grease director 46′ can be present in the propane grill 10 such as when there are multiple burner ducts 40′.

In operation, the burner ducts 40′, flame tamers 44′, and grease directors 46′ are located beneath food being cooked. As grease drips downward, it can fall either directly onto the grease director 46′ or onto the flame tamers 44′. If it falls directly onto the grease director 46′, the sloped nature of the grease director 46′ will guide the grease toward and through the grease drain hole 46A′, where it can then be collected in a reservoir in the form of a pan or tray of some sort. If grease falls onto the flame tamers 44′, a substantial portion of it will likely be vaporized due to the heat of the flame tamer 44′ during operation of the propane grill. What does not vaporize will roll off the A-frame slopes of the flame tamer 44′ where it will land onto the grease director 46′ and be directed to the grease drain hole 46A′. The grease will then ultimately be collected in the reservoir as explained previously.

Importantly, the placement of the grease director 46′ and its relatively small grease outlet provides a degree of separation for the duct inlet 40C′ and the interior cooking chamber of the propane grill. This placement and grease outlet ensures that air drawn into the burner duct 40′ is not oxygen-depleted air recirculated from the interior cooking chamber 16, but instead the air is ambient air drawn into the propane grill 10. Ambient air has a much higher concentration of oxygen due to the lack of convection products it contains, and this oxygen is necessary to feed the flames. By divvying up the propane grill 10 to areas above and below the burner ducts, air pathways are clearly defined and demarcated to both protect and feed the flames and to ensure proper function of the propane grill 10.

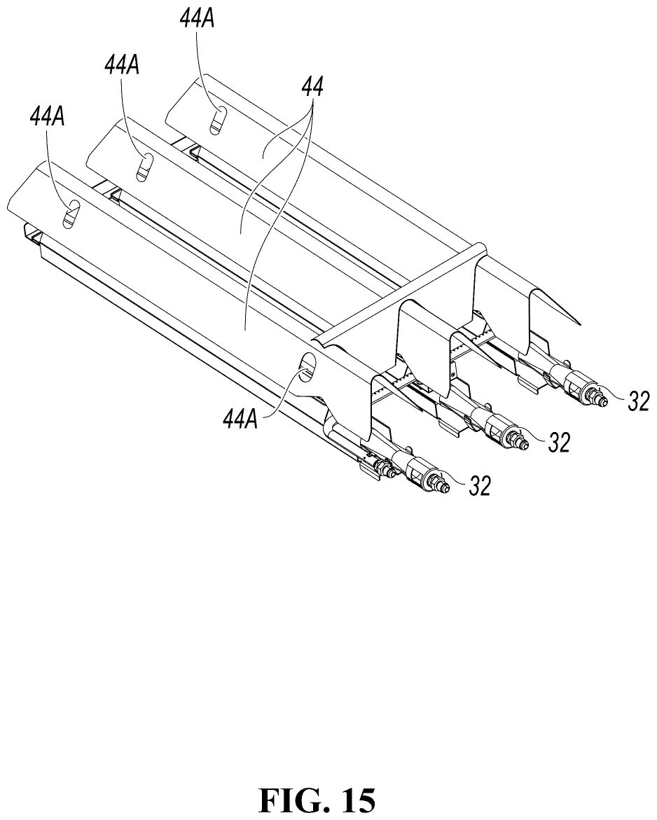

FIGS. 15-17 depict burner ducts 40 and flame tamers 44 in relation to the burners 32 and pilot burner 34 as part of the propane grill 10. While no grease directors, such as grease director 46′, are depicted, the arrangement can be used with grease directors in addition to the burner ducts 40 and flame tamers 44.

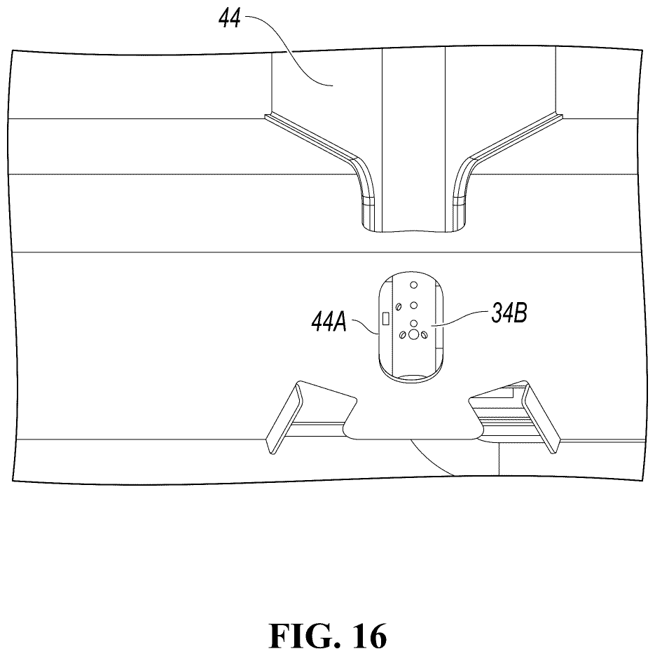

The pilot burner 34 runs substantially perpendicular to three substantially parallel burners 32 as explained previously, so to properly protect the emitted flames, the burner ducts 40 and flame tamers 44 are disposed in a corresponding arrangement, with one burner duct 40 and flame tamer 44 pair running substantially perpendicular to three substantially parallel burner duct 40 and flame tamer 44 pairs. As shown in FIGS. 15 and 16, the flame tamers 44 can include view ports 44A defined therein, which can be placed deliberately so as to permit viewing of the indicators of the burners 32 and pilot burner 34. For example, as shown in FIG. 16, the indicator 34B can be seen through the view port 44A of the flame tamer 44. As the positions of the indicators move, so too can the view ports 44A.

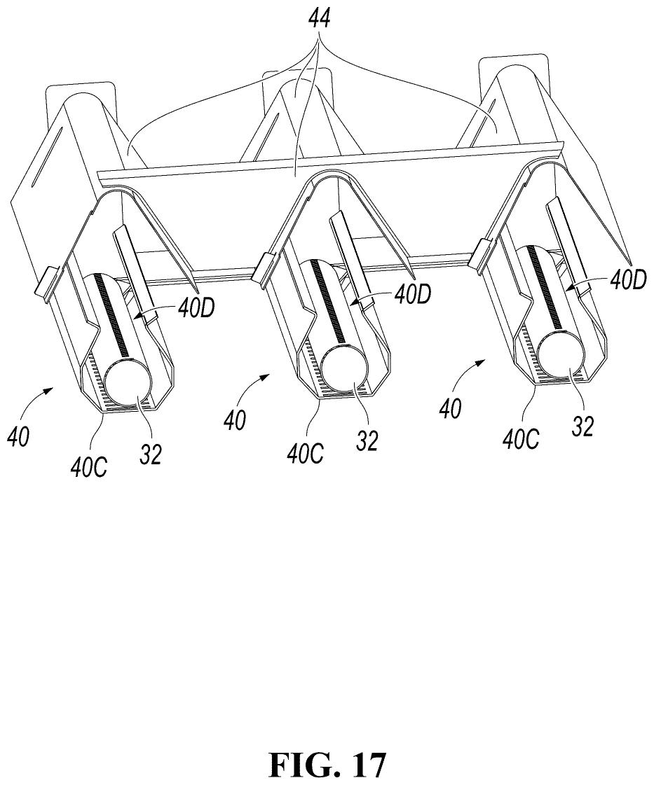

FIG. 17 depicts a cross-section of the burners 32, burner ducts 40, and flame tamers 44. As shown each burner duct 40 includes air inlets 40C along a bottom thereof, which permit secondary air to enter the burner duct 40. The burner ducts 40 themselves are shaped to generally follow a contour of the burner 32 form, tapering toward the burner duct outlets 40D in order to direct secondary air to a flame emitted by the burners 32. The very top of the burner ducts 40 proximate the burner duct outlets 40D can flare outward to more clearly define a flow pathway, which can ensure convective products leaving the burner ducts 40 do not flow the wrong way back into the burner duct outlets 40D and interfere with healthy flame. The flame tamers 44 are substantially triangular in form, like an A-frame, with a shape that helps define the flow pathway as well. As described with reference to the general flame tamers 44 of FIG. 17, the flame tamers 44 are made to be wider than the burner duct outlets 40D in order to prevent grease and debris from interfering with the flames of the burners 32.

When installed within the propane grill 10, the burner ducts 40 and flame tamers 44 assist in the management of both grease and airflow within the greater context of cooking operations.

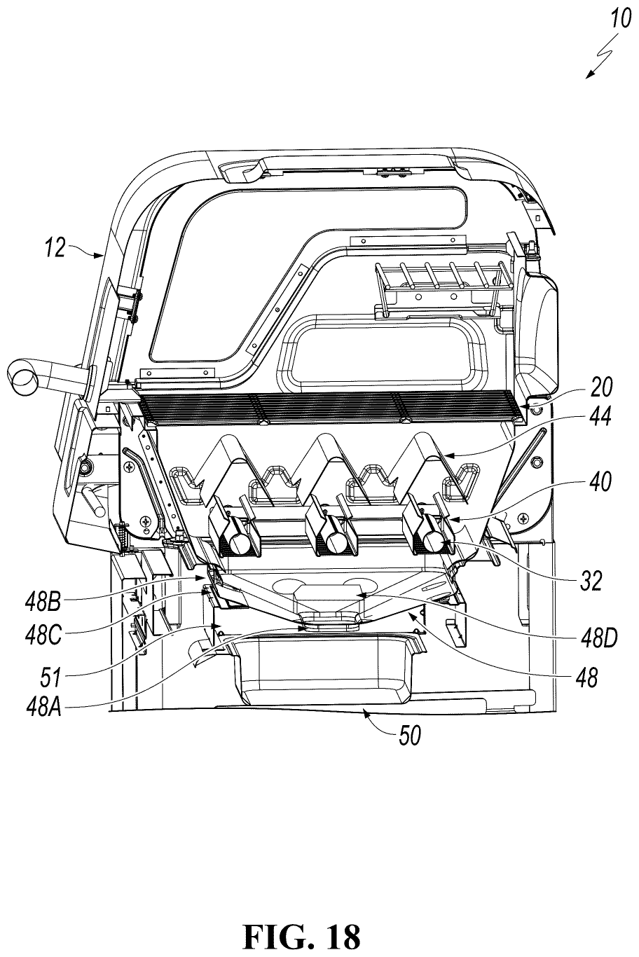

From top to bottom as depicted in FIG. 18, the main cooking surface 20 is shown in the form of one or more removable cooking grates. Beneath the main cooking surface 20 are the flame tamers 44, the burner ducts 40, and the burners 32. The flame tamers 44 and the burner ducts 40 are arranged in the exact same arrangement as that shown in FIG. 17. Their depiction in FIG. 18 highlights their relationship to all other components of the propane grill 10. Positioned beneath those elements is a grease catch 48, which takes the form of a large funnel. The grease catch 48 can extend an entire length and width of the propane grill 10 underneath the entirety of the main cooking surface 20 so that no matter where grease falls, it will encounter the grease catch 48. The grease catch 48 includes a main grease outlet 48A positioned in the grease catch 48. While the main grease outlet 48A is shown generally located in a center of the grease catch 48, the exact position can vary. An upper rim 48B is disposed around a top of the grease catch 48, and a plurality of inlet holes 48C are defined within the upper rim. During operation of the propane grill 10, ambient air can enter the propane grill 10 and pass through the inlet holes 48C in order to feed flames produced by the burners 32 with sufficient secondary air. An outlet tent 48D is positioned over the main grease outlet 48A. The outlet tent 48D can have a sloped top so that any grease landing on the outlet tent 48D will slide off, rather than collecting there. A grease trough 50 is positioned beneath the main grease outlet 48A to catch and retain grease diverted thereto. The grease trough 50 can be removably coupled to the propane grill 10 in a number of ways, including being supported by a rack 51. As needed, a user can remove the grease trough 50 to dispose of the accumulated grease and debris.

In one example of operation of the propane grill 10, food (e.g., meat products) is placed atop the main cooking surface 20 where it can be cooked by the flames created by the burners 32. As the food is cooked, grease can drip downward through the main cooking surface 20. Some of the grease will impact the flame tamers 44. Due to the shape of the flame tamers 44, the grease will roll off the top or sides of the flame tamer 44, depending on where it lands, and roll downward still and through the gaps defined either between adjacent flame tamers 44 or between a flame tamer 44 and the housing unit 12 of the propane grill 10. Some grease will travel directly from the main cooking surface 20 to one of these gaps without touching a flame tamer 44. Either way, the grease will then impact the grease catch 48 or will impact the outlet tent 48D before rolling onto the grease catch 48. From the grease catch 48, grease will travel through the main grease outlet 48A where it will then settle in the grease trough 50 until it is disposed of by a user.

One of the greatest risks in a grill is a grease fire, so it is critical to manage grease properly. Over time, grease can settle and harden on a surface of a grill component where it creates a hotspot for further grease to accumulate. If left uncleaned, the accumulated grease can ignite and start a chain reaction in the grill, which can compromise food through the creation of acrid smoke and direct contact with flame, or can result in serious safety concerns. The flame tamers 44 are sloped so that grease falls off their surface, and the grease catch 48 is sloped for the same reason. While counter-intuitive, too great a slope can also be detrimental as it means grease falling from the main cooking surface has less time to cool off before settling in the grease trough 50. If a piece of debris or a drop of grease ignites and stays lit until it reaches the reservoir of grease in the grease trough, a fire can start. Thus, the correct degree of slope on all sloped grease management surfaces is critical. Additionally, the outlet tent 48D serves two main purposes. Not only does it also have a sloped top surface to properly guide grease, but it covers the main grease outlet 48A from direct drippings from the main cooking surface. There is a non-zero chance that some grease or debris could fall from the main cooking surface 20 and land directly in the grease trough 50. The outlet tent 48D minimizes that chance by blocking direct contact and increasing the travel time for grease and debris. Essentially, food is the starting line, and the grease trough 50 is the finish line. The travel time between the two must be great enough that the grease and debris can either cool off or extinguish before reaching the reservoir of grease in the grease trough 50, and the travel time must be quick enough that the grease and debris cannot congeal somewhere in the propane grill 10.

Other variations of grease management components, including grease directors, burner ducts, and flame tamers will be described. Each is usable with the propane grill 10 or any other propane grill described herein.

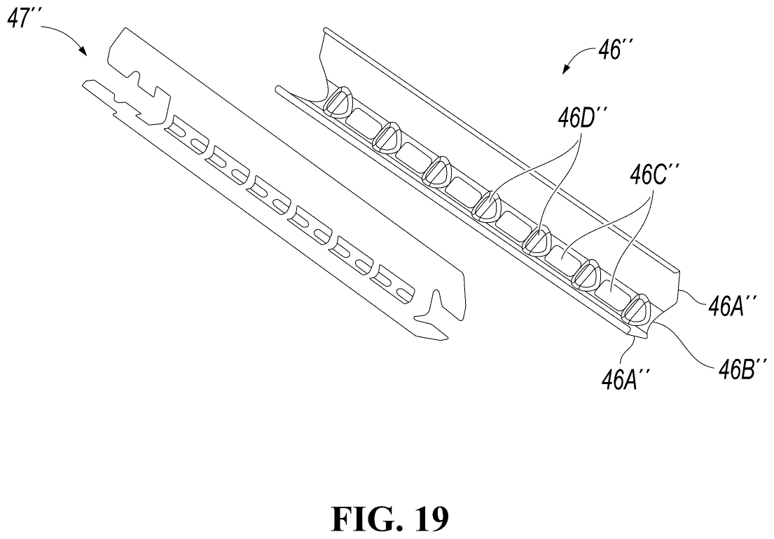

Two variations of a grease director are depicted in FIG. 19. The grease directors 46″, 47″ can be substantially similar to the grease director 46′ in that they receives grease from above and direct it to a specific location via an outlet. Description will be made to grease director 46″. The grease director 47″ has a similar construction, and for brevity, grease director 47″ will not be separately described.

Straight on, the grease director 46″ has a substantially V-shaped form with sidewalls 46A″ slopping downward and meeting at a bottom 46B″ of the grease director 46″. The grease director 46″ also features multiple grease outlets 46C″ disposed in the bottom 46B″ and along a length thereof. Between each of the grease outlets 46C″ are smaller sloped regions 46D″ that form a plurality of slopes within the grease director 46″ itself. The slopes assist with proper air circulation as air that is flowing beneath the burners 32 and grease director 46″ will be diverted toward the burners 32 and away from the grease outlets 46C″, thereby minimizing the unwanted egress of air up through the grease outlets 46C″, which could otherwise detrimentally affect the proper circulation of airflow. Where the wall of the propane grill (e.g., propane grill 10) meets the grease director 46″, a grease director 46″ can be used that has a slightly different sidewall 46A″ shape. For example, one side of the grease director 46″ could have a different size or shape to accommodate the area within which it is disposed.

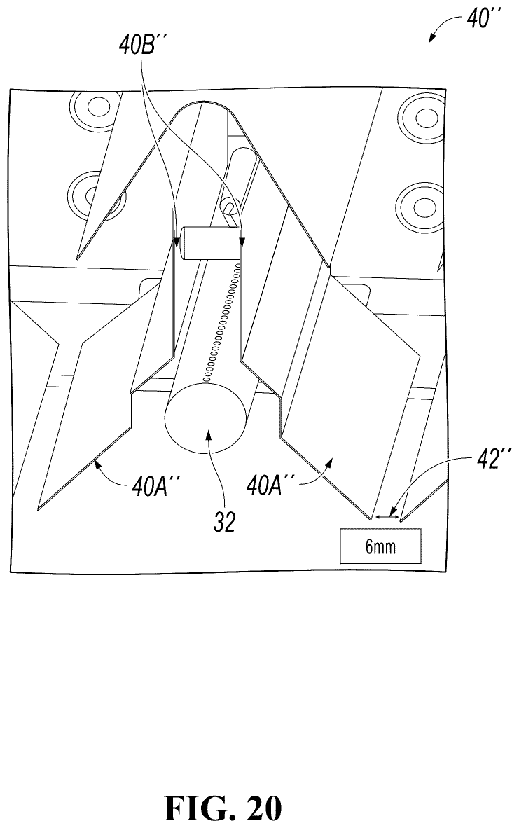

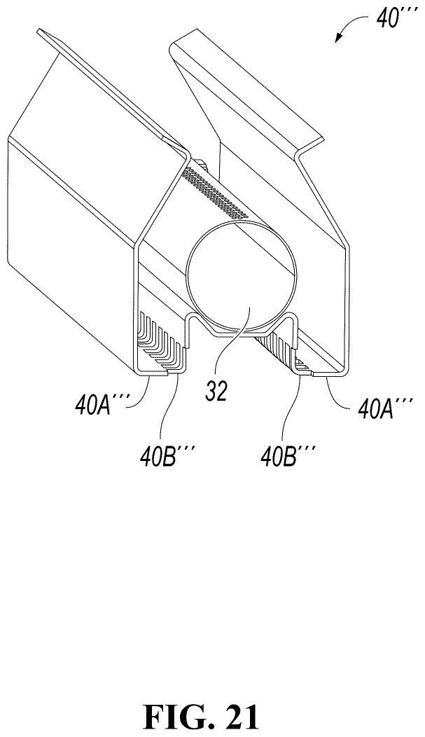

FIGS. 20 and 21 depict alternative designs for a burner duct and grease director usable with the propane grill 10. For example, as depicted in FIG. 20, a burner duct 40″ is depicted that has a substantially similar shape to the burner duct 40′ depicted in FIG. 10 with the exception of a lower skirt 40A″ that can operate to divert grease as desired. The burner duct 40″ includes a pair of sidewalls 40B″, which flank either side of a burner 32. The sidewalls 40B″ also taper inward around the burner 32 and extend upward away from the burner 32. The skirt 40A″ is connected to a lower portion of the sidewalls 40B″, and the skirt 40A″ slants outward and away from the burner 32.

As shown, when two burner ducts 40″ are placed adjacent to each other around neighboring burners 32, the skirts 40A″ from the burner ducts 40″ approach one another and define a grease gap 42″ through which grease is able to drain. The grease gap 42″ operates similarly to the grease outlets 46C′, of the grease director 46′ in that grease is directed to a specific location in the propane grill 10, and excess air is prevented from passing either upward through the grease gap 42″ or downward through the grease gap 42″. The grease gap 42″ can vary in size and form, however in an example, the width of the grease gap 42″ is between approximately 4 and 8 mm and can be approximately 6 mm. Instead, as a result of the design of the burner duct 40″, similar to other designs and operations described herein, ambient air entering the propane grill 10 from beneath the burners 32 can be directed up through the burner duct 40″ and around the burner 32 to feed flames generated by the burner 32 as secondary air. The burner duct 40″ allows for the convective products of the flame, including heat and heated air to be directed upward toward food.

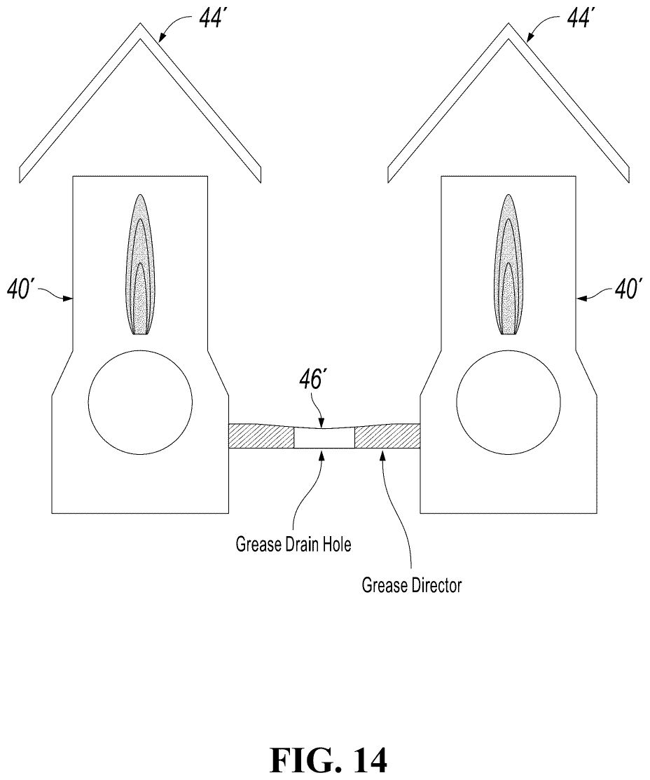

The burner duct 40″ in FIG. 14 is also usable with the propane grill 10 in conjunction with a flame tamer and/or a grease director as described herein. The burner duct 40″, as shown, substantially surrounds a burner 32, and notably, the burner duct 40″ is a single piece that extends upward on either side of the burner 32. The burner 32 is disposed on top of a middle portion of the burner duct 40″, which extends downward, outward, and then back upward past a top of the burner 32 to form a pair of recesses 40A″ located on either side of the burner 32. The burner duct 40″ includes a pair of sloping sidewalls that extend upward and inward before flaring back outward, giving the burner duct 40″ a substantially U-shaped form. The burner duct 40″ includes a plurality of air intake holes 40B″ defined in the pair of recesses 40A″, which allow air to flow upward and around the burner 32 to provide flames of the burner 32 with secondary air as described herein.

As introduced above, the propane grill 10 includes a convection system 100, which can enable cooking operations involving convection heating of food products within the propane grill 10. Convection cooking in general opens up new cooking possibilities that are unavailable with traditional propane grills. The convection system 100 and aspects thereof are depicted in FIGS. 3 and 22-33. Generally, the convection system 100 in the propane grill 10 makes up part of the housing unit 12 defines a portion of the internal cooking chamber 16. The convection system 100 is positioned such that convection generated by the convection system 100 is in fluid communication with the internal cooking chamber 16 and food cooking on the main cooking surface, as shown in FIG. 3. That is, no matter the arrangement of the convection system 100, convection it generates can reach food cooking on the main cooking surface 20 or the secondary cooking surface 21. Although the convection unit 100 can define part of the internal cooking chamber 16, variations of the propane grill 10 are contemplated herein which involve a convection system entirely remote from the internal cooking chamber 16 but that is still in fluid communication with the internal cooking chamber 16 through ducts, baffles, etc. These variations will be described in more detail below.

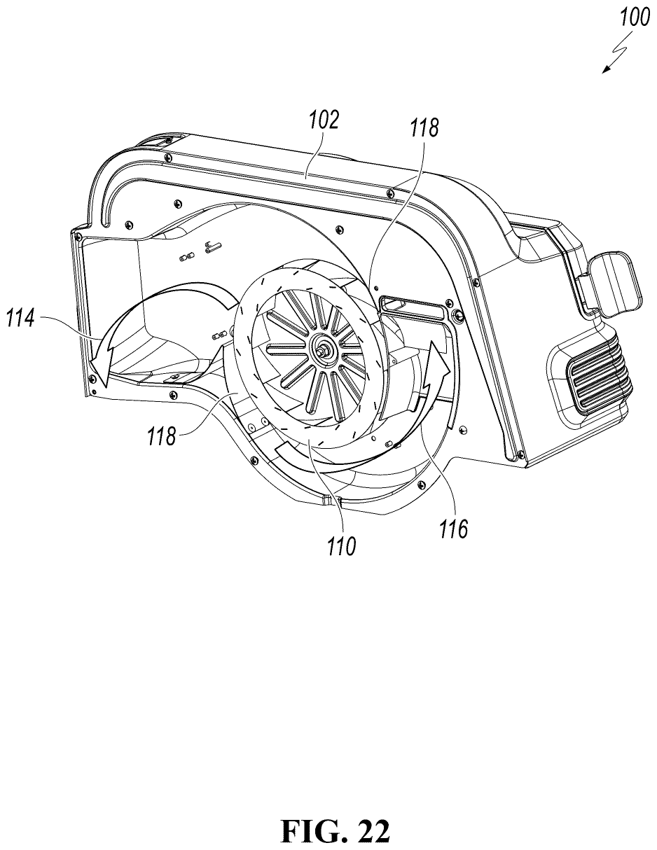

FIG. 22 depicts an isolated view of the convection system 100 according to an embodiment. As depicted, the convection system 100 includes a fan 110 set within a split volute 102. The fan 110 is depicted as a turbine-type fan, however this is exemplary as various fan types can be used with the convection system 100. The fan 110 is designed to take draw in air axially, i.e., in a direction substantially parallel to an axis of rotation, and direct air outward radially, i.e., in a direction substantially parallel to any radius of the fan 110 and substantially perpendicular to the axis of rotation. The fan 110 can be driven by a fan motor 112 and which can drive the fan 110 at varying speeds depending upon the demands of a user and/or demands of the propane grill 10 itself.

Convection cooking in the propane grill 10 can result in more even heating throughout the entirety of the internal cooking chamber 16 as compared to traditional propane grills, which in turn results in faster and more even cooking. The fan 110 by itself, when rotating, will direct air generally equally in all radial directions. The split volute 102 harnesses the output of the fan 110 to direct it throughout the internal cooking chamber 16 to create deliberate airflow patterns within the internal cooking chamber 16. These deliberate airflow patterns can take into account the overall geometry of the propane grill 10, operational capabilities of the propane grill 10, and the size location of food cooked therein in order to optimize the convective capabilities of the propane grill 10. Namely, the split volute 102 has a generally S-shaped form and defines a first flow path 114 and a second flow path 116 leading away from each other in two different directions. Although a split volute 102 is depicted in FIG. 15, a volute of another shape or form, including a single volute or a split volute 102 with three or more flow paths or a different air guide system entirely are all contemplated herein. No matter the number of flow paths, the principle remains the same: one or more airstreams-regardless of number, location, strength—in the propane grill 10 increase an average airspeed within the propane grill 10, which contributes to convection and convective cooking operations.

In a single volute system, for example, air directed by the fan 110 can be directed along a single flow path to be circulated within the internal cooking chamber 16. The air traveling along this single flow path can be substantially equal to the total volume of air moved by the fan 100, which is harnessed for convective cooking. The same principal can apply to volutes of different constructions. For example, volutes with three or more airflow paths can direct air to those airflow paths, which then, in turn, circulate air in the internal cooking chamber 16.

Turning back to the split volute 102, directed air outputted by the fan 110 radially travels along one of either the first flow path 114 and the second flow path 116 using path walls 118. These flow paths, indicated with the arrows, effectively channel the air as desired as a result of the circumferential coverage of the fan 110. More generally, the fan 110 moves air at some specific flowrate equally in all radial directions. By changing the circumferential coverage of the fan 110 by the path walls 118, the ratio of airflow between possible flow paths can be adjusted. For example, if a first flow path covers 90% of a fan's circumference and a second flow path covers the remaining 10%, approximately 90% of the total airflow output by a fan will be directed to the first flow path versus approximately 10% to the second flow path. Knowing this, the specific ratio of airflow between present flow paths can be adjusted as desired to manipulate the airflow patterns created by a convection system (e.g., convection system 100). This principal can also be applied to volutes of other constructions, where the air traveling along a given flow path can be generally proportional to the radial coverage of the flow path. In practice and as shown in FIG. 15, the fan 110 is disposed within the middle of the split volute 102 with access to both the first flow path 114 and the second flow path 116. The path walls 118 extend around the fan 110 in such a way as to make the airflows between the first flow path 114 and the second flow path 116 generally equal. That is, in a given time, about half the total air moved by the fan 110 will travel the first flow path 114, and about half the total air moved by the fan 110 will travel the second flow path 116. More specifically, this ratio can be between about 60% and 40%, in favor of either flow path 114, 116. In another example, the ratio can be between about 55% and 45%, in favor of either flow path 114, 116. In yet another example, the ratio can be about 50% and 50%.

The first flow path 114 and the second flow path 116 generally direct air to different locations within the internal cooking chamber 16, and these varied air currents increase the average airspeed in the propane grill 10. The exact methods of transmission of air via the first and second flow paths 114, 116 can vary and are not necessarily limited to what is described with reference to the figures.

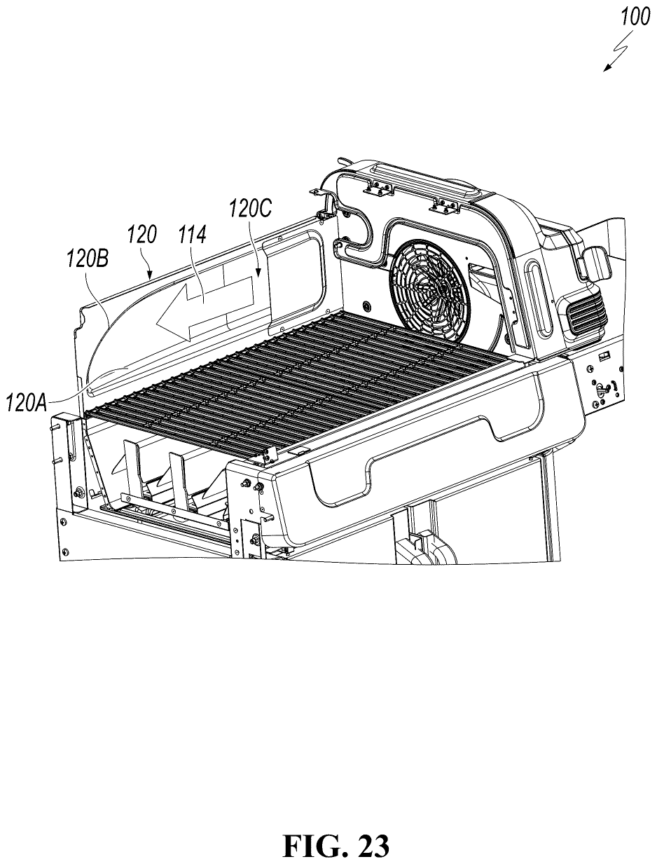

The first flow path 114, as shown, leads toward the back of the propane grill 10. The propane grill 10 includes a recirculation duct 120 located along the back of the propane grill 10 to receive air from the first flow path 114 at the rear right corner of the propane grill and output it near a left end of the rear wall of the internal cooking chamber, as depicted in FIG. 23. Because the recirculation duct 120 is open, some of the air traveling along the first flow path 114 can enter circulation before traveling along the recirculation duct 120. However, most of the air traveling along the first flow path 114 can travel the length of the recirculation duct 120.

In general, the recirculation duct 120 has a substantially trapezoidal shape with a flat bottom edge 120A and a rounded top edge 120B that tapers toward the bottom edge 120A. This shape assists with airflow through the recirculation duct because the cross-sectional area decreases the further the recirculation duct 120 extends from the fan, which helps to maintain air speeds to overcome momentum losses due to friction and temperature change. In other words, the tapered cross-sectional area of the duct ensures air delivered along the first flow path 114 arrives as needed for even airflow throughout the internal cooking chamber 16. While the dimensions of the recirculation duct 120 can vary, especially depending upon the overall geometry of the propane grill and capabilities of the fan 110, in an example, the recirculation duct can have a maximum height of about 14 cm and a depth of about 4.5 cm. The duct opening 120C can vary both in size and location.

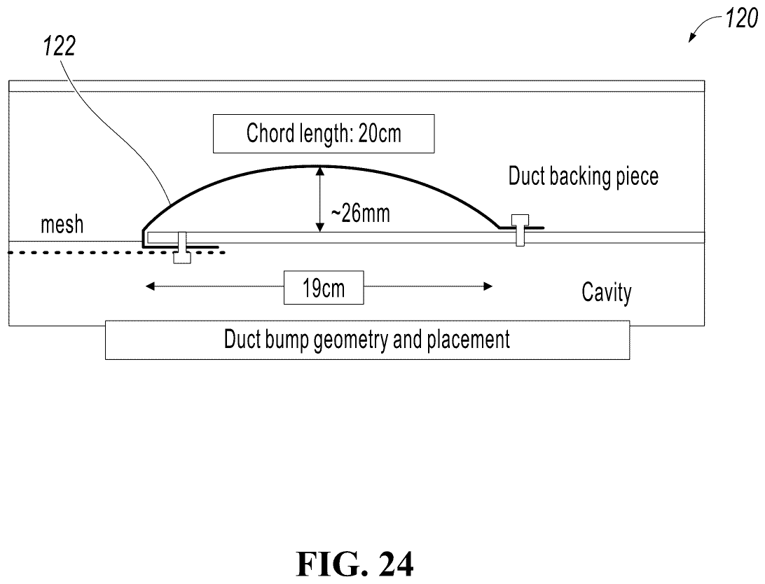

In some variations, the recirculation duct can include a bump-out 122, as depicted in FIG. 24. The bump-out 122 can direct air exiting the recirculation duct 120 into the internal cooking chamber 16 into a more uniform airflow in certain arrangements. Without the bump-out 122, this exiting air can primarily flow around the perimeter of the cooking cavity, rather than in the circular forms described above. In the example depicted in FIG. 24, the bump-out 122 can be about 19 cm wide and about 2.6 cm tall, giving the bump-out a chord length of about 20 cm. As with other elements of the propane grills described herein, these values can vary to maximize performance, which can depend on many factors.

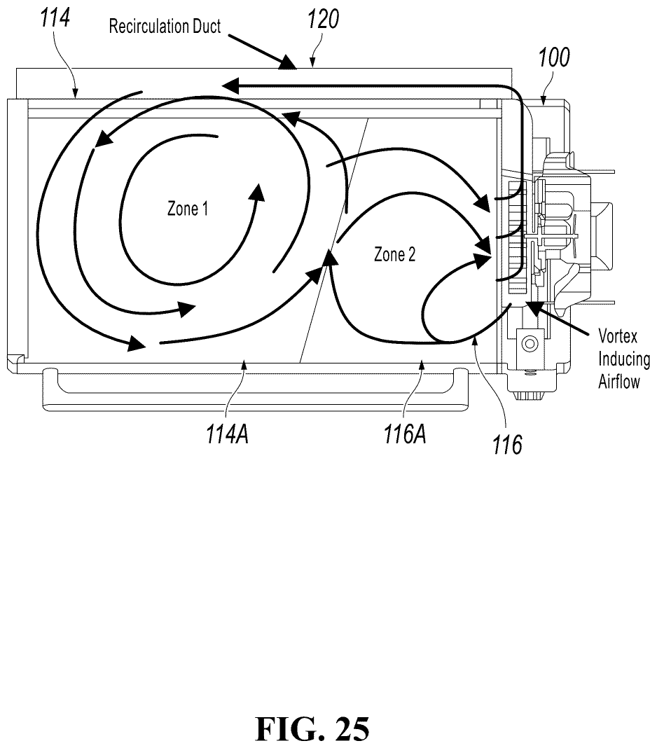

FIG. 25 depicts a top-down view of the propane grill 10 with a general depiction of exemplary airflow patterns created by the convection system 100 as a result of the first flow path 114 and the second flow path 116. Air from each of the first and second flow paths 114, 116 can create separate circular flow patterns within the internal cooking chamber 16, which can ensure that all areas of the internal cooking chamber 16 receive sufficient coverage of heated air. Moreover, the circulating air must circulate with enough velocity that it can successfully transfer the desired level of thermal energy to a food product, while also carrying away moisture as needed to cook and crisp food. Specifically, as shown in FIG. 25, air emitted along the first flow path 114 from the recirculation duct 120 can create a first flow pattern in a first zone 114A located on a left side of the internal cooking chamber 16. Air circulates in a circular (or toroidal) pattern within the first zone 114A before being taken back in by the fan 110 to be circulated again. Air emitted from the second flow path 116 can be deposited directly into the internal cooking chamber 16 into a second zone 116A, and this air spins in a circular (or toroidal) pattern that is opposite to the first flow pattern of the first zone 114A, i.e., clockwise as opposed to counter-clockwise. Like the air in the first zone 114A, the air in the second zone 116A is eventually taken back in by the fan to be circulated again. Without the spinning airflow in each of the first and second zones 114A, 116A, dead zones, or areas with little airflow, would be created within the internal cooking chamber 16. This is undesirable for effective convection.

In other arrangements of the propane grill 10, different flow patterns may be created. These different flow patterns may arise due to the use of a different convection system, i.e., a single volute system, a different duct configuration, etc. Depending upon the demands of the grill and the performance of the grill during convective cooking operations, airflow can be selectively curated to maximize operative capabilities. For example, maximizing evenness of heating (through minimization of hot- and cold-spots) can be one metric by which performance can be measured.

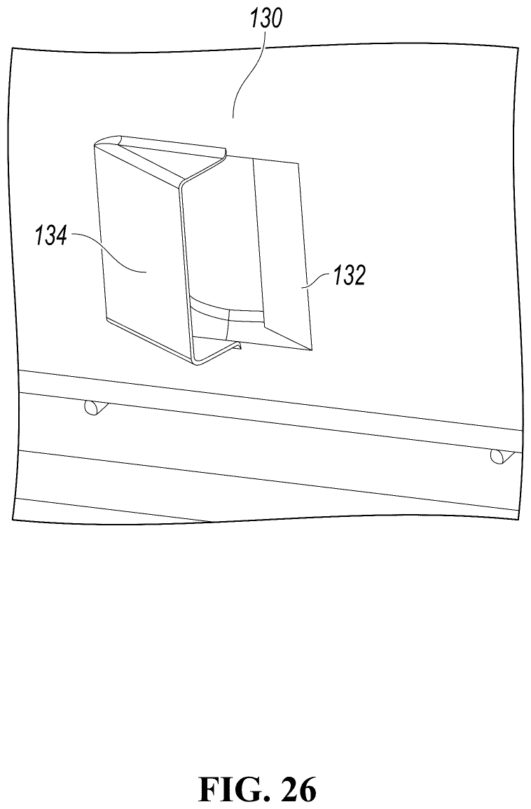

Exhaust is also a critical component to proper convection in the propane grill 10. Air enters the internal cooking chamber 16 to feed the propane flames and smoke generation, described below, and air must also exit the internal cooking chamber 16 to carry away moisture and to provide proper pressure in the internal cooking chamber 16 to maintain sufficient air intake. Critically, the size and location of the exhaust port(s) on the propane grill 10 greatly affect exhaust and the overall health of the system. If too much air enters the system without the proper amount of air leaving the system, flame health can suffer because the air can become full of combustion waste products. Conversely, if too much air leaves the system without enough air entering the system, flame health can also suffer because the flames do not receive the proper amount of oxygen to feed combustion. This can cause flames to grow weaker, leading to drops in temperatures in the cavity and flame outages due to the air circulated in the propane grill 10. Due to the number of the elements in the propane grill 10 affecting airflow, and air constantly entering and exiting the propane grill, local regions of higher and lower pressure are created in the internal cooking chamber 16. An exemplary exhaust port 130 is depicted in FIG. 26. In general, the exhaust port 130 can be placed in a substantially pressure-neutral region. That is, the exhaust can be placed in a region near which air flow in the chamber 16 would not be exiting rapidly, indicating a positive pressure region (relative to the chamber 16) and near which ambient air would not be entering the chamber 16, indicating a negative pressure region (relative to the cavity). Instead, the pressure neutral region placement of exhaust 130 can ensure natural convection and air circulation within the chamber 16 leads a rate of air exchange through the exhaust 130 at a rate sustainable for proper flame and convective health. Some air will exist the chamber 16 via the exhaust 130, but pressure-neutral in this context can mean located in a region without excessive and/or undesirable (e.g., uncontrolled) ingress or egress of air. In an example, an exhaust port 130 can be located on a rear of the propane grill 10 to vent heat and exhaust away from a user, who is presumably standing at the front of the propane grill 10. The exhaust port 130 can include an inward-curving fin 132 to assist with guiding out of the internal cooking chamber 16 and an external hood 134 to also guide exhaust in a proper fashion. While not pictured, the exhaust port can also include an external cover to ensure external elements, like rainwater, enter the exhaust port 130. The exhaust port, as depicted, lead to the recirculation duct 120, which provides a relatively stable region for exhaust to leave the propane grill 10. Other locations, such as locations near the front of the propane grill 10 may meet the pressure-neutral requirements, but it is generally inadvisable to exhaust convective and combustive products toward a user, who is most likely positioned toward a front of the propane grill 10.

In operation, the propane grill 10 can reach air temperatures of up to 700 degrees Fahrenheit, which can easily spill over to heat the fan motor 112 in an undesired manner. Localized temperatures, such as at the flame tamers 44, can reach even higher as explained above. Excess heating of the fan motor 112 and other components of the propane grill 10 can damage over time, rendering the fan motor 112 and propane grill 10 ineffective for its cooking operations or wholly inoperable. To mitigate this, the propane grill 10 can include an integrated cooling system to ensure that the temperature of the fan motor 112 does not exceed the rated temperature of its various components during operation of the propane grill 10. The need to cool the convection motor represents one additional challenge for a propane grill with a convection system, which again operates at temperatures not reached by other convective cooking devices, such as convection ovens.

In general, some amount of heat generated by the propane grill 10 can radiate outward and reach the fan motor 112. Certain arrangements of the fan motor 112 may receive less heat than others. For example, placing the fan motor 112 further from the internal cooking chamber 16 can lead to less total heat reaching the fan motor 112. The task of any cooling system is to therefore operate to ensure heat reaching the fan motor 112 is less than some threshold that leads to wear or damage on the fan motor 112 and its components. Depending on the exact configuration of the propane grill 10, the amount of heat to be moved by a cooling system may be more or less than systems of differing configurations.

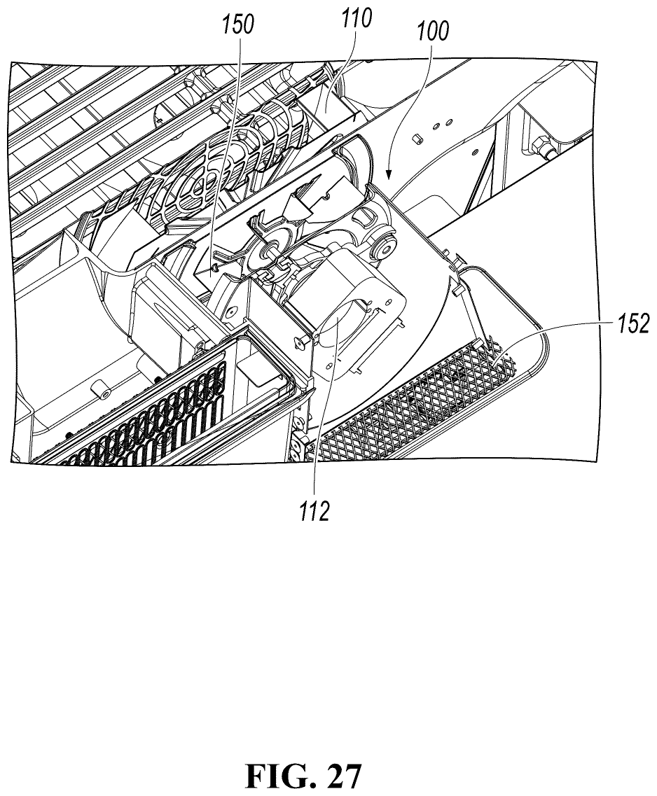

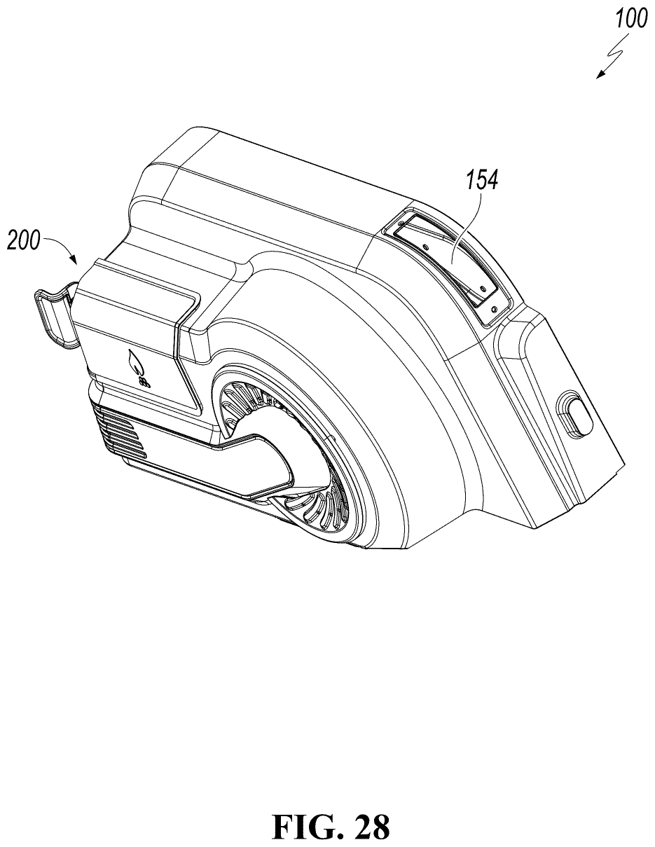

An exemplary integrated cooling system for the propane grill 10 is depicted. As shown in the cross-section FIG. 27, the integrated cooling system can include a cooling fan 150 that is coaxial with the fan 110 so that operation of the fan 110 also drives the cooling fan 150. This arrangement is variable, and the cooling fan 150 may operate along a different axis than the fan 110. The cooling fan 150 can take on various forms, but as shown, the cooling fan 150 is in the form of a turbine. When driven, the cooling fan 150 draws in ambient air over the fan motor 112 and exhausts radially out of the propane grill 10. This ambient air must be drawn at a rate sufficient to maintain the temperature of the fan motor 112 at the necessary level for proper operation. As shown in FIG. 27, the integrated cooling system draws in ambient air over the motor through an intake 152. While certain operations of the propane grill 10 can take occur at temperatures that are below the temperature ratings of the fan motor 112 components, propane grills can simply reach higher temperatures than are possible with other kinds of cooking systems such as ovens. As shown in FIG. 28, the convection system 100 can include a cooling fan exhaust 154 defined therein to emit waste air and heat from the propane grill 10. The exact location of the exhaust 154 can vary, but its position is one contribution to the integrated cooling system of the propane grill 10, which again must move enough heat such that the fan motor 112 and its components are kept at reasonable temperatures. The details of the integrated system can vary in any combination so long as, in total, enough heat is moved away from the fan motor 112 that it is able to operate properly over time. As introduced above, the propane grill 10 can include a smoke unit 200 to generate smoke used to flavor food during or independent of other cooking processes. The smoke unit 200 can combust a fuel source, such as wooden pellets, in order to generate smoke of a desired temperature, which can impart desired flavors onto food while avoiding bitter and/or acrid flavors associated with smoke generated by excessive temperature.

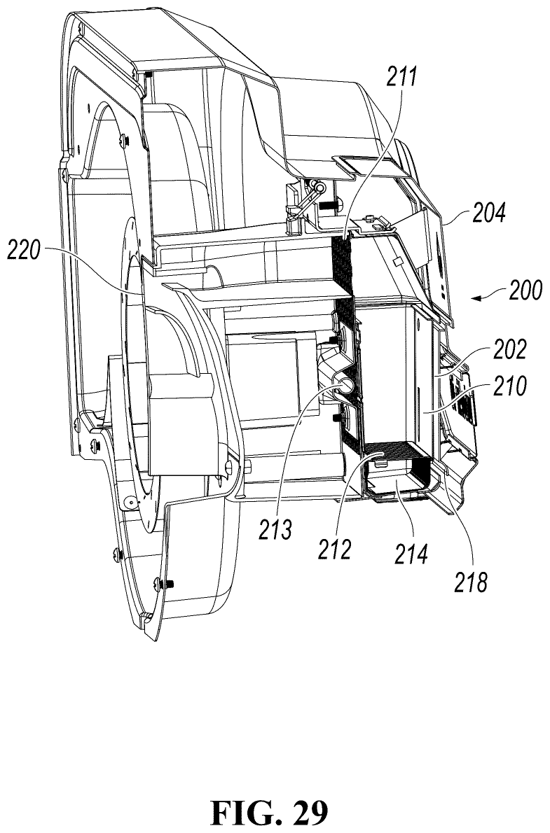

FIGS. 29-33 depicts the smoke unit 200 disposed on a side of the propane grill 10 proximate to the convection system 100. The smoke unit 200 generally includes a smoke unit body 202 and a smoke unit lid 204 pivotally coupled to the smoke unit body 202. A cross-section of the smoke unit 200 is shown in FIG. 29 to provide more detail. Inside the smoke unit 200 is a removable cartridge 210 that is configured to hold a fuel source. The cartridge 210 includes a bottom divider 212 having one or more apertures therein, which are sized to retain fuel above the divider 212 but allow ash and debris to fall through and settle into an ash catch 214, a lower region of the cartridge 210, to prevent the accumulating ash from interfering with combustion of the fuel source. The cartridge 210 can further include one or more apertures 211 in a side thereof. The one or more apertures 211 can be positioned such that an ignition source 213, in the form of a tubular heater or like, can have direct and unimpeded access to the fuel source. Further, the smoke unit 200 can include a smoke unit intake 218 located at a bottom of the smoke unit 200, which can allow ambient air to enter the smoke unit 200 to feed combustion of the fuel source.

The intake rate of air through the smoke unit intake 218 drives a burn rate of fuel stored in the smoke unit 200. The intake rate of air can be dictated by a rotational speed of the fan 110, which can be selectively driven to draw more or less smoke into the internal cooking chamber 16. Generally, the exact flow rate can vary depending on the rotational speed of the fan and dimensions of the smoke unit 200. For example, a flowrate of between about 800 to 1000 mL/s through the pellets would be reasonable for the smoke unit 200. In some variations, a flow rate between about 900-950 mL/s can be expected.

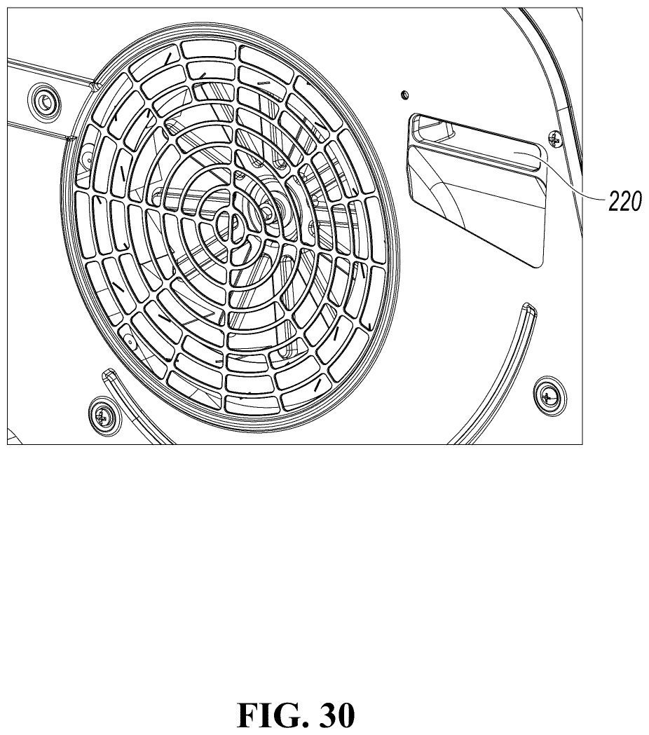

Toward an upper end of the smoke unit 200 is an aperture 220 disposed proximate to the second flow path 116 of the split volute 102. This aperture 220 can also be seen from a perspective positioned inside the interior cooking chamber 16, as depicted in FIG. 30, and it is evident that the aperture 220 is located immediately next to an airstream exit of the second flow path 116.

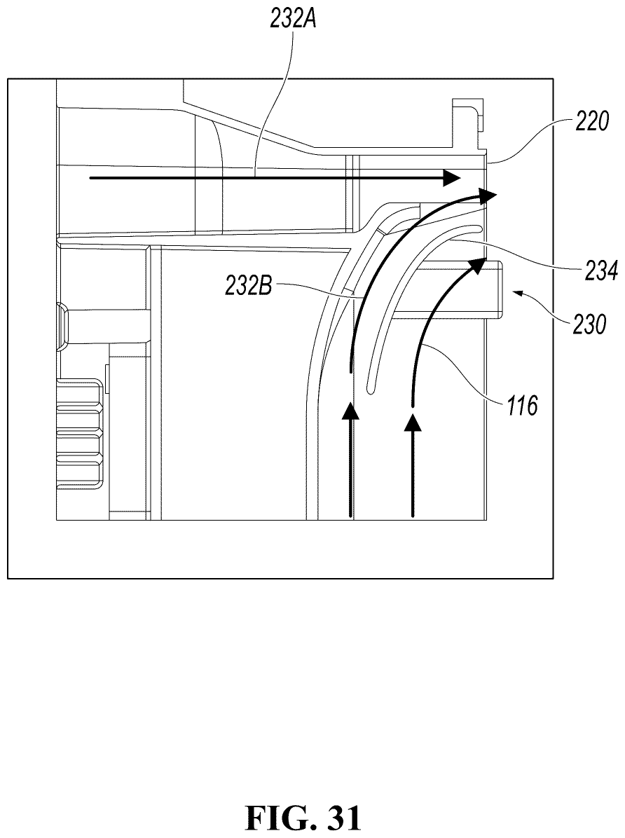

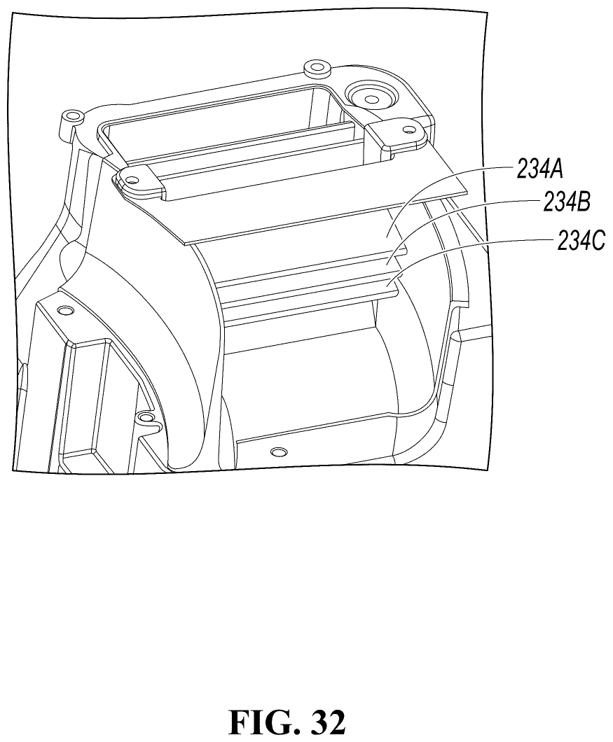

In addition to the intake 218, the smoke unit 200 can also feature an aspirator 230, seen in FIGS. 31 and 32, to increase smoke flow entering the internal cooking chamber 16 along a smoke path 232A. The aspirator 230 includes a tongue 234 set beneath the aperture 220, and the tongue 234 defines an aspirator pathway 232B that receives airflow separate from the airflow traveling in the second flow path 116, generally circulated during convection operations. The tongue 234 is positioned so that air traveling through the aspirator pathway 232B draws smoke entering from the smoke unit 100 along the smoke path 232A and pulls it through the aperture 220. In general, airflow through second flow path 116 has less interaction with smoke entering along the smoke path 232A. The aspirator 230 can increase smoke draw into the internal cooking chamber by a significant margin as compared to systems without such an aspirator 230.

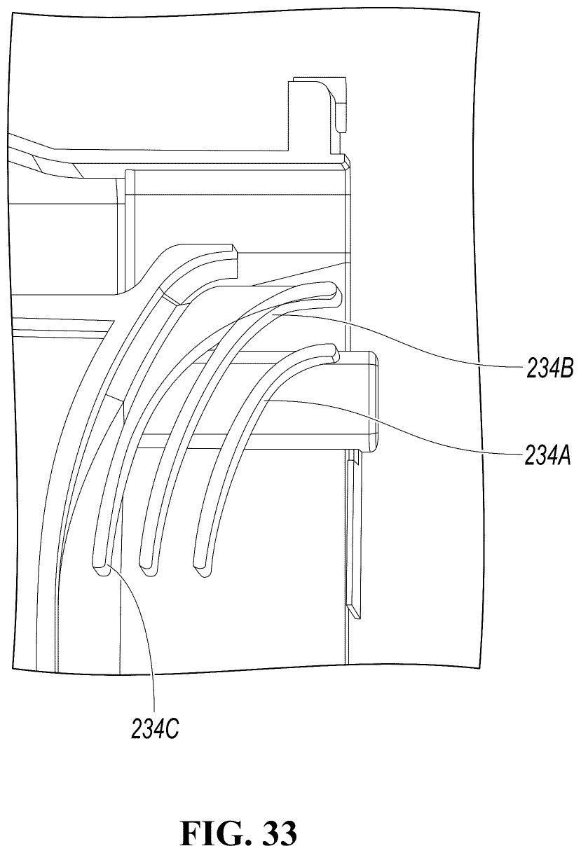

The specific design of the aspirator and tongue can vary. For example, FIG. 33 depicts an aspirator 230A with three differently-shaped tongues 234A, 234B, 234C. Each tongue 234A, 234B, 234C was designed and positioned so that total airflow through the aspirator pathway 233B versus the second flow path 116 could be expressed as a ratio. These ratios (aspirator pathway 233B: second flow path 116) include 50:50, 33:67, and 17:83. Each ratio improved smoke draw into the internal cooking chamber 16, but the 33:67 ratio provided the greatest increase to smoke draw as compared to similarly-situated systems without an aspirator.

In operation of the smoke unit 200, a user can open the smoke unit lid 204 and remove the cartridge 210 and load it with a fuel source, such as wood pellets. The user can then reinsert the loaded cartridge into the smoke unit 200. When smoke is desired, the ignition source 213 can activate to combust the fuel source and generate smoke within the cartridge 210. As the fuel source combusts, ash can fall through the divider 212 and settle in the ash catch 214. Ambient air can flow into the smoke unit via the smoke unit intake 218 to feed combustion of the fuel source, and the natural convection currents of the combusting fuel source can take the generated smoke upward and toward the aperture 220.

Further, this process can occur in conjunction with operation of the convection system 100. Operation of the convection system 100 will involve rotation of the fan 110 and airflow through the second flow path 116. This airflow through the second flow path 116 will create a negative pressure in the region proximate to the aperture 220, which can then assist the natural convection currents of the fuel source combustion to pull generated smoke from the smoke unit 200 into the internal cooking chamber 16.

For smoke draw to work well in the propane grill 10, a few parameters must be taken into account. First, the internal cooking chamber 16 must have a relative pressure (P_{Total Cavity}) less than ambient pressure (P_{AMB}), as presented in Eq. 1.

$${P}_{AMB} > {P}_{Total Cavity} \qquad Eq . 1$$

By utilizing Bernoulli's equation for static fluids, the following equation (Eq. 2) can be achieved, where total cavity pressure (P_{Total Cavity}) is a measure of the pressure within the internal cooking chamber 16, and the inlet velocity (vᵢₙₗₑₜ) is a measure of the airflow velocity at the aperture 220.

$${P}_{AMB} > {P}_{Total Cavity} - ρ ( {v}_{Inlet}^{2} ) / 2 \qquad Eq . 2$$

From this Eq. 2, it becomes evident that increasing the inlet velocity will increase the pressure differential between the internal cooking chamber 16 and ambient air pressure, which in turn increases smoke draw. Inlet velocity increases by increasing the rotation speed of the fan 110, therefore smoke draw is increased as fan speed is increased.

Additionally, the size of the aperture 220 can affect smoke draw, where an increase in the area of the aperture 220 can create more draw through the aperture 220.

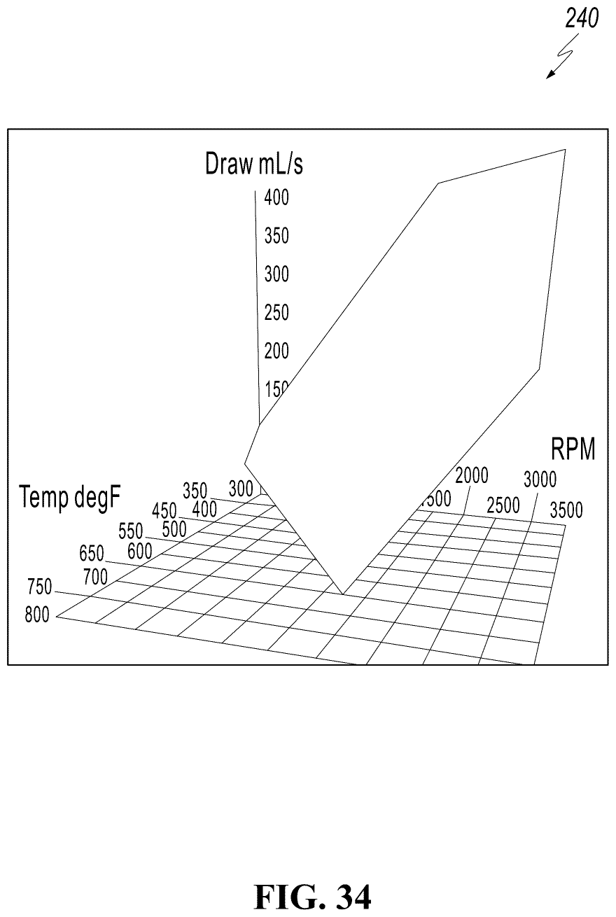

Further, smoke draw correlates with the temperature of the propane grill 10 as well as fan speed, as explained above. Through testing, this relationship can be graphed as shown in the graph 240 of FIG. 34, where the axes include temperature of the propane grill 10 in degrees Fahrenheit, fan speed (RPM), and smoke draw (mL/s).

Coordinating the systems of the propane grill 10 can involve fine-tuning the sub-systems of the grill, including the burners 32, the convection system 100, the smoke unit 200, etc. so that operations can occur safely and effectively. Various systems will be described, each of which is compatible with the propane grills described herein. Many of the features of these systems are already described herein, and for brevity those components will not be described again, as they are each generally interchangeable with corresponding components previously described.

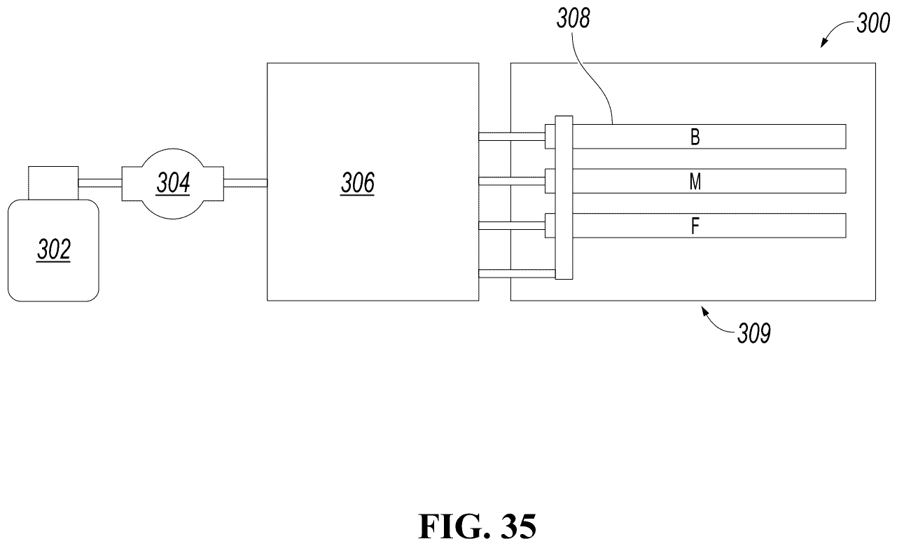

FIG. 35 depicts a general view of a control system 300 for grills, which can be applied to propane grill 10. The depicted system 300 includes some kind of regulated gas input involving a gas source 302 (e.g., a portable propane tank) and a regulator 304. The system 300 also includes some kind of ignition and flow control system 306, and then finally some combination of one or more burners 308 (e.g., burners 32 and pilot burner 34) in a cavity 309 (e.g., internal cooking chamber 16). The ignition and flow control system 306 generally ignites some or all selected one or more burners 308 and controls the amount of fuel entering those one or more burners 308 based on the temperature of the cavity 309.

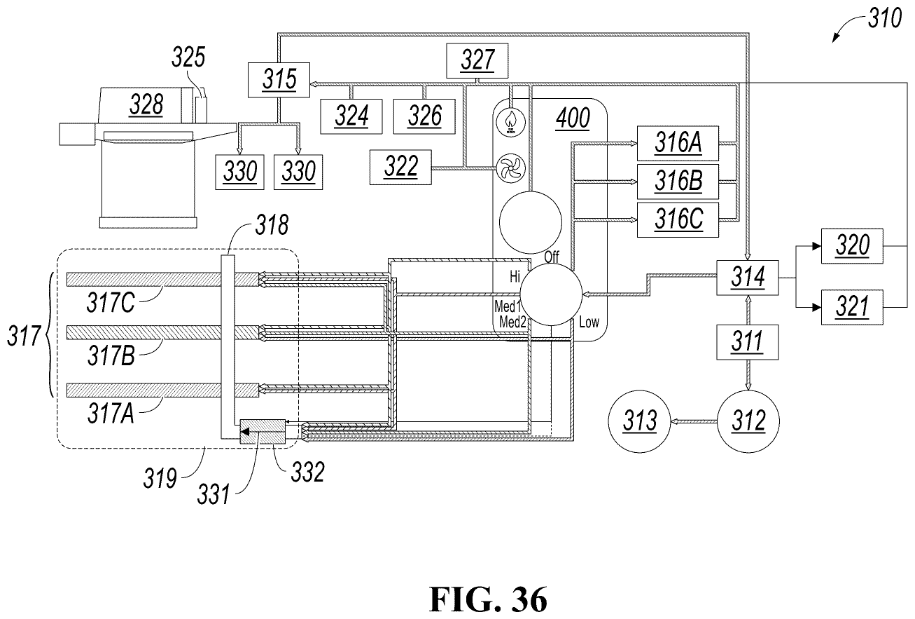

A more specific system 310 of a gas train for the propane grill 10 is depicted in FIG. 36, including both physical and electronic components. The system 310 maps to the system 300 but with greater detail and specificity. The system 310 is but one set-up for the propane grill 10 and for propane grills generally, and more are described below.

The system 310 includes a gas supply 311 leading down to an optional side burner valve 312 and accompanying side burner 313, which may be positioned on the propane grill 10 in a variety of positions, including one of the side shelves 22, for example. The gas supply 311 also leads to a integrated valve 410, which in electronic communication with a controller 315, such as a microcontroller or PCBA The integrated valve 410 will be described in detail below. Each of the burners 317 are fed through the integrated valve 410, which can be actuated to control fuel flow to a specific burner arrangement as desired by a user. The pilot burner 318 does not go through the integrated valve 410. Instead, gas flow is fed along a separate pathway to the pilot burner 318 for various safety and control reasons described later. integrated valve 410

Additional electronics include a limit switch 320 in communication with the integrated valve 410. The limit switch 320 can be used both for error detection and for locating the integrated valve 410. Also included is a sensor 321 to determine a valve position. The sensor 321 can vary, but in some examples, the sensor 321 can be a Hall-effect sensor used to track motor ticking of the motor of the integrated valve. A fan RPM sensor 322 is in communication with the convection fan 323 to measure a rotational speed of the convection fan 323, and additional sensors include a smoke NTC 324 to measure pellet box 325 (or smoke unit) temperature and an air NTC 326 to measure a temperature of the internal cooking cavity 319. Also included is a lid microswitch 327, which provides feedback as to a state of the lid 328 of the propane grill 10. Operations of the propane grill 10 can drastically change depending on whether the lid 328 is in an open position or a closed position. This relationship is explored in greater detail below. Finally, connected to the controller 315 are a smoke unit fuel ignition source 329 and a convection system motor 330.

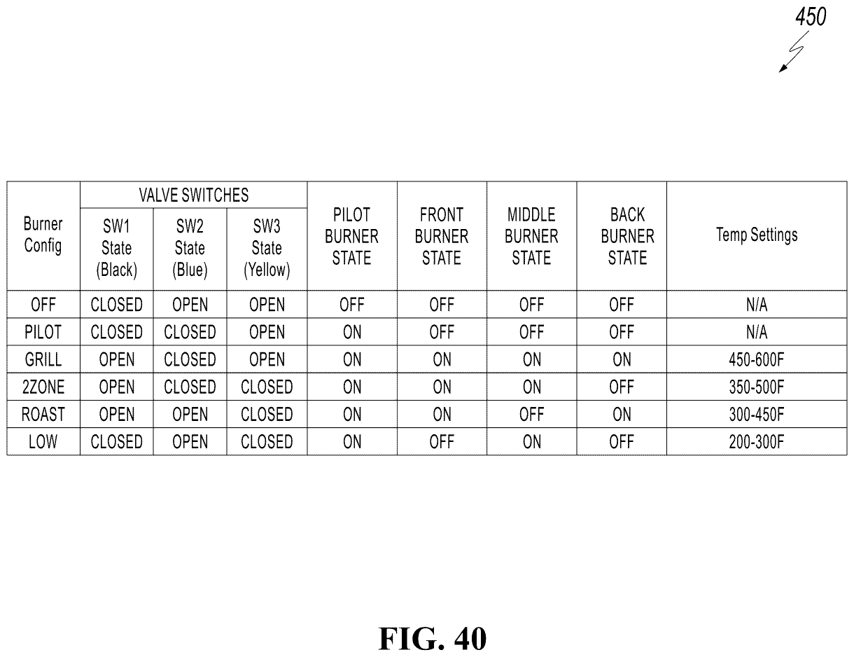

The cavity 319 is depicted in the lower left with three parallel burners 317 (front burner 317A, middle burner 317B, rear burner 317C) and a pilot burner 318 running generally perpendicular to the parallel burners 317. In communication with the pilot burner 318 is an ignition source 331, such as a sparkplug or the like, and a flame detector 332, such as a thermopile or other such system. In variations where the flame detector 332 is a thermopile, the thermopile can be electronically isolated from all other electronic components in the propane grill 10. The thermopile can be configured so that its default state cuts off fuel access to the burners 317. Unless the pilot light 318 is on and the pilot flame is detected, no gas can flow. The thermopile is placed in the pilot flame such that if the pilot flame goes out, the thermopile will automatically shut off to prevent any gas from entering the burners 317. The closure of this valve prevents free-flowing gas and fuel from entering the system, which could lead to potential safety concerns. Each of the burners 317 and the pilot burner 318 are connected to the integrated valve 410. The integrated valve 410 communicates with the burners 317 and the pilot burner 318, a series of three switches 316A, 316B, 316C read a state of the integrated valve 410 to know which burners 317 are active at a given time. The burner selection process is fully mechanical, and the switches 316A, 316B, 316C provide feedback to the UI 400 as to a current burner 317 configuration. The switch states are depicted in the table 450 of FIG. 40 and will be detailed below.

The UI 400 can be a user's first point of interaction with the propane grill 10 when they aim to begin a cooking operation, an example of which is depicted in FIG. 37. The UI 400 of FIG. 37 maps to the propane grill 10 and to the system 310 of FIG. 36 and will be used for reference. In general, the UI 400 includes a first dial a first dial 402 corresponding to various desired temperature ranges and burner configuration, and a second dial 404 corresponding to a specific temperature within the desired temperature range. The UI 400 also includes a display 406, which can output various information including temperature readouts, cooking operation information, error messaging, burner configuration, and more. Optionally, the UI 400 can include a button 405 marked “WOODFIRE FLAVOR” or similar message. Activation of this button can cause the smoke unit 200 to generate through the ignition of the smoke unit's ignition source 213 to ignite fuel stored in the fuel box 210. This can be useful for a user who desires smoke flavor and/or aromas in their food. From the top and working clockwise, it can be seen that the first dial 402 has six positions as follows: OFF, LOW & SLOW, ROAST/BAKE, 2 ZONE GRILL, GRILL, and IGNITE. Each of these six positions corresponds to a specific burner arrangement in which some or all burners 317 are ignited, and this in turn corresponds to an achievable temperature range of the propane grill 10. Specifically: OFF corresponds to all burners closed; LOW & SLOW corresponds to the pilot burner 318 and middle burner 317B being lit; ROAST/BAKE corresponds to the pilot burner 318 and front and rear burners 317A, 317C being lit; 2 ZONE GRILL corresponds to the pilot burner 318 and front and middle burners 317A, 317B being lit; GRILL corresponds to all burners 317, 318 being lit; and IGNITE corresponds to just the pilot burner 318 being lit.

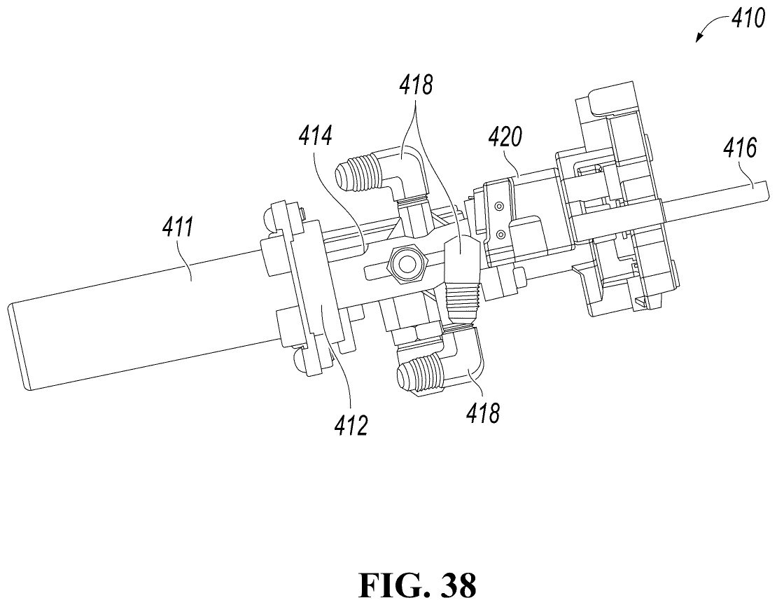

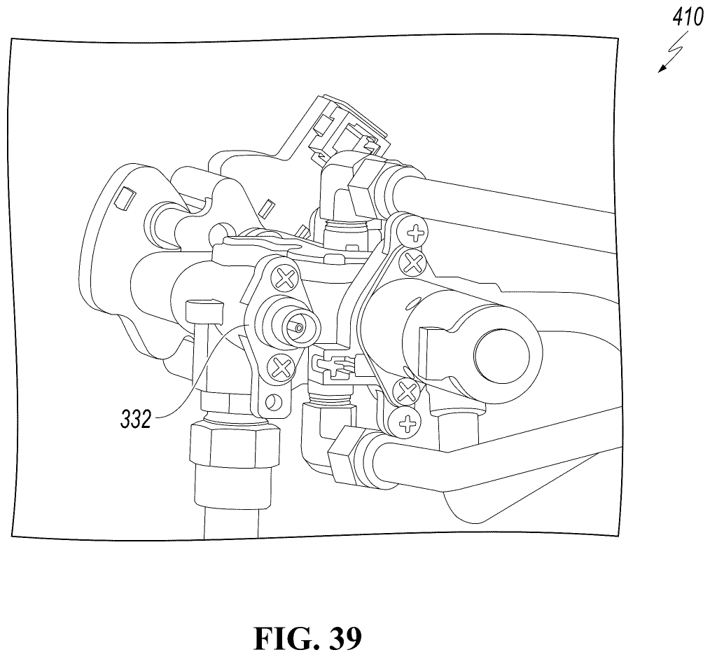

Inputs received at the UI 400 can be translated into changes in the propane grill 10, which result in cooking operations desired by a user. This translation can occur through the use of various components, and one example of a component, introduced above, is an integrated valve 410. The integrated valve 410 can vary in form to effect certain changes in the propane grill 10. In the variation shown in FIGS. 38-39, the integrated valve 410 generally includes a motorized valve 412 combined with a burner selection valve 414 to select active burners and control gas flow to those burners to maintain a temperature value inputted via the second dial 404 of the UI 400.

Specifically, the integrated valve 410 includes a motor 411 coupled to the motorized valve 412. The motor 411 can be used to set and adjust a valve angle of the motorized valve 412 as required by the controller 315. The integrated valve 410 also includes the burner selection valve 414, which is coupled to the first dial 402 of the UI 400 via an elongate dial core 416. When a user places the first dial 402 into a desired position, the burner selection valve 414 opens or closes access to the burners 317 as required to align with the user's expected burner state. The integrated valve 410 includes gas flow paths 418 fluidly joining the gas supply 311 and the burners 317. When the burner selection valve 414 is placed in a certain state, one or more of the gas flow paths 418 will be closed to prevent gas flow to the corresponding burners 317. The integrated valve 410 also includes one or more microswitches 420 that can read out a state of the burner selection valve 414 and present that information to the UI 400 and to a user. The ignition and burner selection process via the first dial 402 is purely a mechanical operation, and the microswitches 420 provide that electronic feedback to the UI 400 so that the current burner configuration can be properly displayed. The controller 315 plays no part in burner selection as will be discussed below.

FIG. 39 depicts a view of the flame detector 332 in the form of a thermopile. The flame detector 332, as introduced above, is positioned to read a current status of the pilot burner 318. IF the pilot burner 318 is on, the thermopile can ensure gas can flow to the pilot burner 318. If the pilot burner 318 goes out, the thermopile can automatically prevent fuel from flowing to the burners 317.

In total, the first dial 402 can be placed in one of six positions, so a minimum of three binary valve switches are required to read out six unique output configurations. These configurations are summarized in the table 450 in FIG. 40. Namely, the switch states, burner states, and temperature ranges are provided for each of the six positions. Based on the user-specified inputs and readouts from the air NTC 326, the controller 315 will adjust the motorized valve 412 of the integrated valve 410 to control gas flow to the burners 317. Depending upon the position of the first dial 402, only certain burners may be accessible by the flowing gas as explained. As the temperature readout from the air NTC 326 changes, data sent to the controller 315 will also change. The controller 315 can feather and/or adjust the position of the motorized valve 412, with feedback provided in a number of ways, including via the Hall-effect sensor and the like, as described above.

If a user wanted to slow cook food at 250 degrees Fahrenheit, they would first (assuming the gas is turned on) move the first dial 402 from the OFF position to the IGNITE position to ignite the pilot burner 318. They would then have to place the first dial 402 on the LOW & SLOW position because 250 degrees Fahrenheit falls within the corresponding temperature range of the first position. This adjustment triggers the burner selection valve 315 to open access to the middle burner 317B only. Once on this first position, the user can turn the second dial 404 to select a specific temperature within the range at which they would like the propane grill 10 to operate. The exact temperature can be shown on the display 406. As feedback is provided to the controller 315, it can transmit information to the motorized valve 412 to feather gas flow to the middle burner 317B as needed to adjust flow rate of gas to the burner 317B and adjust temperature of the propane grill 10 as a result.

When the propane grill 10 reaches a set temperature, that temperature is present across the entire internal cooking chamber 16 with minimal deviation. The circulation of heated convection provides ample benefits as compared to traditional grills or ovens. For example, food placed on the main cooking surface 20 is the primary place for cooking. In traditional grills, this is the location food will be placed to achieve desired results. Steaks, burgers, etc. are cooked on the equivalent main cooking surface closest to the heat in these traditional systems. Other foods, or foods to be kept warm, are relegated to a secondary space, such as atop a shelf further away from the heat. Cooks know that this secondary shelf will be held at a noticeably lower temperature, even with the lid closed, because the temperature gradient across the cavity is so great.

In contrast, the propane grill 10 has a minimal temperature gradient, and food placed atop the secondary cooking surface 21, as opposed to the main cooking surface 20, can be cooked in a substantially the same identical manner. The convection circulating within the internal cooking chamber 16 when the lid is down evenly heats the entire cavity space. Measurements confirm that the difference between the set-point temperature and the minimum temperature of any place in the propane grill 10 where food can be reasonably placed is less than about 5% difference. In some instances, this difference can be less than about 2%.

The system will also take into account variables including level of gas in the gas supply 311, ambient temperature outside of the propane grill 10, lid state measured by a lid microswitch 327, and more.

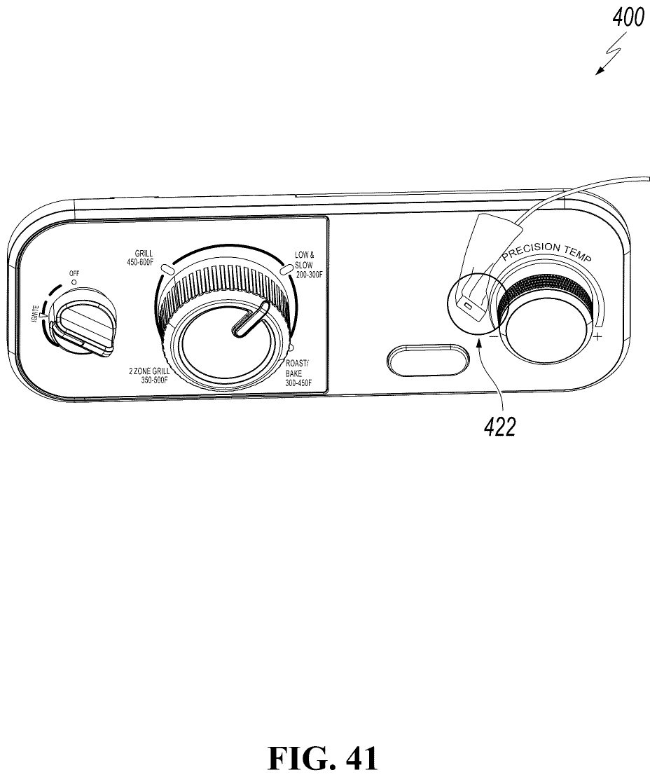

As introduced above, users may have difficulty determining whether a pilot burner in the propane grill 10 is ignited in certain ambient conditions. The indicator 34B can provide clear visual feedback to a user to know that the pilot burner is properly lit. This indicator 34B does not need to be the only feedback for proper ignition. For example, the UI 400 can include its own indicator for ignition feedback. Upon ignition, the UI 400 can provide feedback in the form of a signal, such as a light, a sound, a displayed message, or some combination, to alert a user that ignition has taken place. One such example can be seen with respect to FIGS. 40-41 in the form of an ignition light 422 on the UI 400. In FIG. 40, a variation of the UI 400 is shown including the ignition light 422 in the form of an extra LED. In FIG. 41, the associated mechanism for this ignition light 422 is depicted. As shown in FIG. 41, a thermocouple 424 can be placed near the flame detector 332 (e.g., a thermopile) and the pilot burner 34, 318 so that the thermocouple 424 can experience similar temperature readouts from the pilot burner 34 as the flame detector 332. When the flame detector 332 is a thermopile, for example, the thermocouple can provide feedback to the ignition light 422, which can blink for a user when the thermopile is heating up. Once the thermopile is properly heated, indicating ignition, the ignition light 422 can be solid. The state of the ignition light 422 can inform a user whether the pilot burner 34, 318 is lit.

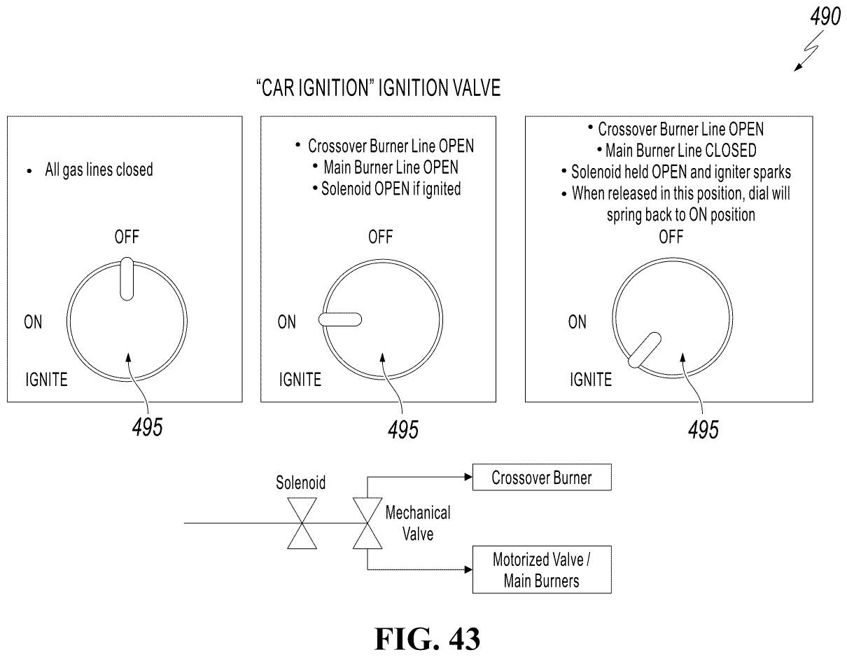

In some variations, the UI 400 can feature a separate ignition dial, which is described with respect to the diagram 450 of FIG. 43. The ignition dial 480 can operate similar to a car ignition, where a user must move a dial from an OFF position (all gas lines closed) to an ON position (crossover burner line and main burner line open, solenoid open if ignited), past the ON position to an IGNITE position (crossover burner line open, main burner line closed, solenoid open, igniter sparks). When released after placed in IGNITE, the ignition dial 480 will spring back to the ON position. To enter other operational modes, a separate selection dial similar to the first dial 402 can be moved to a corresponding operational mode position.

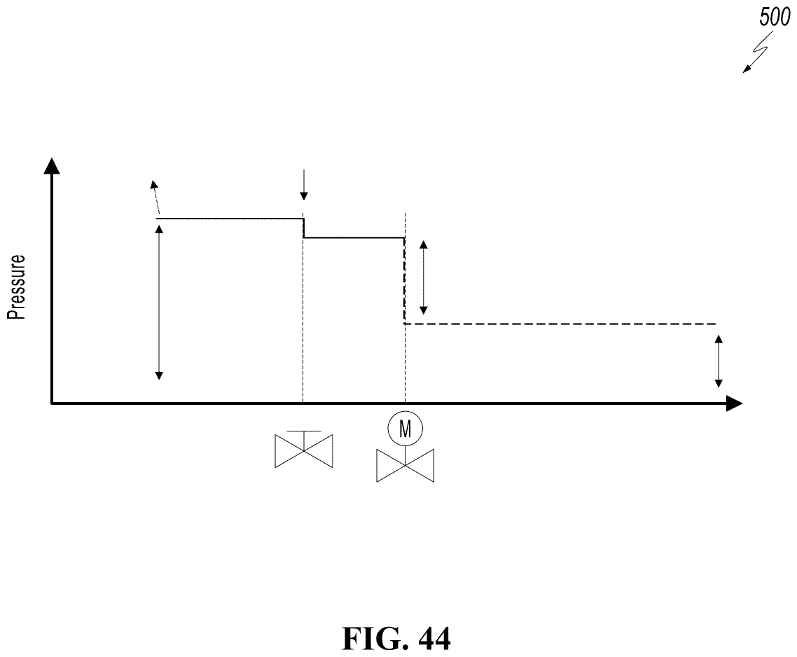

A robust system to manage operations of the propane grill 10, including temperature control, convection, smoke generation, error reporting, etc., all in view of external factors, is highly desirable. The basic operating principles of the propane grill 10 are as follows. There is some regulated pressure of gas supplied to the system via a fuel source and a regulator. A valve assembly is sued to direct fuel to specific burners at specific times, and an automated valve applies some variable resistance to flow, via valves, solenoids, etc., to adjust burner output. The output of the valve assembly determines the level of combustion in the cavity, which corresponds to some output pressure. FIG. 44 depicts a diagram 500 of pressure as a function of this described pathway. As gas flows through a gas train, pressure losses naturally result from interactions with components, including valves, burners, etc. The introduction or removal of different components in the gas train affects the ultimate output pressure. By tailoring these components and their arrangement, flame output can be fine-tuned as desired. As seen in the diagram 500, regulator pressure results in gas flow at a first level, valve losses from the valve assembly contribute to a first drop, the automated valve contributes to a second, greater drop, and then finally an output pressure is achieved. By controlling the ultimate output pressure after fuel has traveled through the system, a temperature of the grill can be controlled.

In total, operation of the propane grill 10 involves a number of moving parts, as explained herein. Further, environmental factors can greatly impact performance of the propane grill 10. At a high level, a cooking vessel containing a heat source will exhibit a linear relationship between power generated by the heat source and the steady state temperature within the cooking vessel. Accordingly, it is theoretically possible to achieve a target temperature within the cooking vessel by setting a power generation rate according to this relationship. It is upon this principle that the propane grill 10 can be controlled. Such an approach allows the propane grill to leverage higher levels of power generation without risking damage to itself or impacting performance. For example, the primary driver to material degradation within combustion-powered devices is high temperature. The components nearest the flame are the hottest, and the steady state operating temperature of those components at maximum burn rate inversely correlates to component life. Given that analog devices require user intervention to adjust gas flow in gas-fueled combustion devices, the maximum burn rate of those devices is used to define maximum component temperatures and, in turn, expected component life. On a temperature-controlled device, however, software-imposed limits may be applied to artificially reduce the maximum operating temperature even while providing excess power to the product when needed to allow faster preheat and recovery. This allows the burners to be “overpowered” while maintaining lower temperatures on critical components, which will then extend component life.

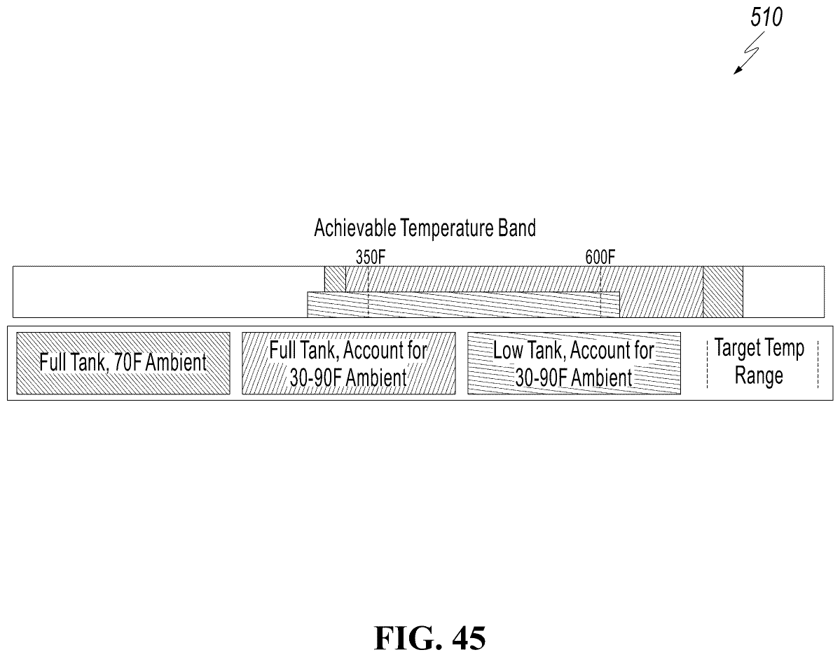

Of course, there are many factors that make such an approach more difficult. For instance, the absolute temperature within the vessel is wholly dependent on the temperature outside of the vessel, as achieved steady state temperatures are measured as a rise above ambient temperature. Further, the power source itself may be impact effectiveness of this approach, either through voltage drop on an electrical system or tank pressure drop on a gas-driven system. This is depicted in FIG. 45, which shows achievable temperature bands in a chart 510 for several states: 1) full fuel tank at 70 degrees Fahrenheit ambient temperature; 2) full fuel tank at 30 degrees Fahrenheit to 90 degrees Fahrenheit ambient temperature; and 3) low fuel tank at 30 degrees Fahrenheit to 90 degrees Fahrenheit ambient temperature. The target temperature is also indicated, falling between about 350 and 600 degrees Fahrenheit, although temperatures can vary locally within systems, including the propane grill 10. Moreover, when a thermal load is added to the system, such as food placed atop a grill, the amount of power required to maintain a certain temperature may vary depending upon that thermal load. These challenges can be compounded by unit-to-unit variations as well.

For the propane grill 10, meaningful temperature control can be achieved by a feedback-backed control method, which will be described below. Reference will be made to the descriptions of the propane grill 10 above, including especially to FIG. 36. In general, a temperature sensor is placed in fluid communication with the air or cooking surface within the propane grill (e.g., propane grill 10), depending on whichever is most critical to performance. This sensor should be placed so that its reading is representative of the average temperature within the system, or in a location that is proportionally related to the average temperature of the system in order to provide meaningful and comprehensive data read-outs. An electronically-controlled analog regulation valve can be placed in-line with the burner or burners to adjust gas flow rate thereto, and components can be added as necessary to this valve assembly to provide confidence in absolute valve position. This may include an RPM sensor, rotary encoder, and/or any number of limit switches. A pressure sensor placed in line with the burners, for example, could also provide meaningful information related to the motorized valve's position or setting. Temperature can be set at a user interface, and the system can adapt to reach that temperature.

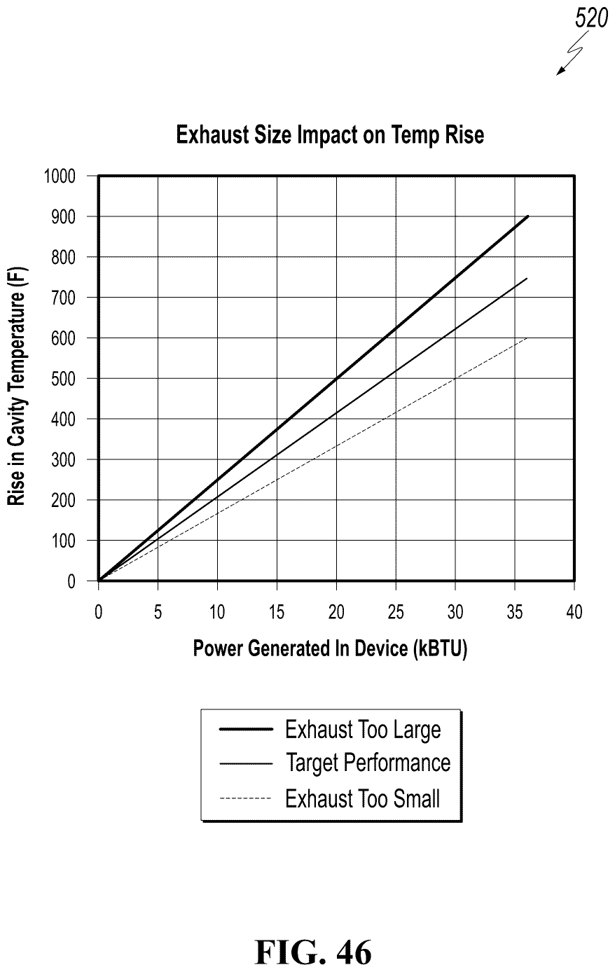

In operation, the first step is to adjust the thermal loss of the propane grill 10 to match the target relationship between BTU and steady state cavity temperature. This can be done by running the propane grill 10 at a known BTU output, measuring the steady state temperature rise in the cavity, and adjusting the exhaust opening to match the target temperature rise for the provided BTU output. This step is important to achieve consistent temperature in as wide a temperature band as possible as the turndown of the burner or burners limits the achievable temperature within the cavity. This relationship can be seen in the graph 520 of FIG. 46, where power generation (kBTU) is measured against rise in cavity temperature (degrees Fahrenheit). The plots are indicative of the exhaust being too large, too small, or just right.

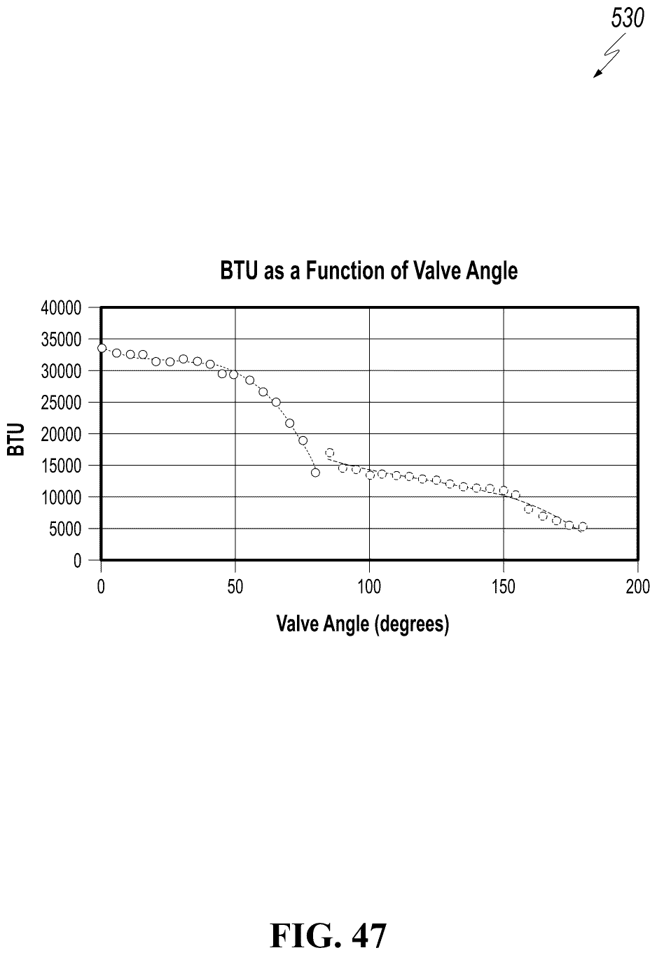

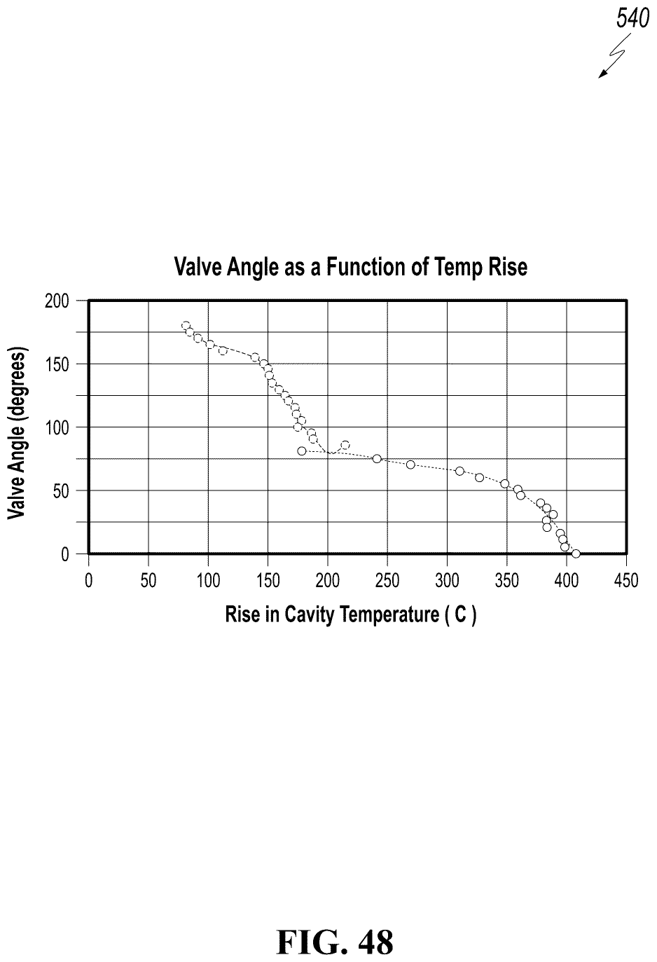

It is also necessary to characterize the flow through the regulator valve as a function of angle in order to properly estimate which angle to target when trying to achieve a target temperature. This can be done by adjusting the valve in discrete increments and measuring the flowrate of gas through the regulator while applying standard operating pressure (e.g., 11″ water column for US LP gas). The results of these measurements are depicted in FIG. 47, which shows a graph 530 of BTU output as a function of valve angle, and FIG. 48, which shows a graph 540 of valve angle as a function of temperature rise.

Once these steps are completed, a proportional-integrated-derivative (PID) controller may be used with the valve to dynamically adjust the valve angle to maintain the target cavity temperature as defined on the user interface of the system. The PID controller implements feedback from the temperature sensor to anticipate the necessary adjustments to system power or valve angle to quickly reach and maintain a target temperature as defined on the user interface. This controller may include proportional adjustments based on the current temperature differential between measured temperature and target temperature, integral adjustments based off of the accumulated temperature differential over a longer period of time, and/or derivative adjustments based off of the current rate of change of the temperature differential. These parameters may be tuned to improve the responsiveness of the system, prevent overshoot of the target temperature, and reduce oscillation about the target. The adjustment limits of the valve may be artificially bounded by the software to avoid adjusting the gas flow outside of the range where flame is stable.

When designing the PID controller, the controller output can either be a direct valve position or a target power output measured in BTUs, which can then be backed out to a target valve position using the valve characterization data. While the former is more direct, the nonlinearity of the valve angle versus power output curve inherently adds instability to this control scheme. For instance, when the controller outputs an adjustment of 5 degrees there may be a power change anywhere from 26 to 674 BTU, which corresponds to a temperature impact between 0.5° C. and 14° C. This variable impact can lead to system oscillation or instability. Thus, while both approaches can be effective, the more robust method involves having the PID controller target a power output as the relationship between power output and temperature is substantially more linear.

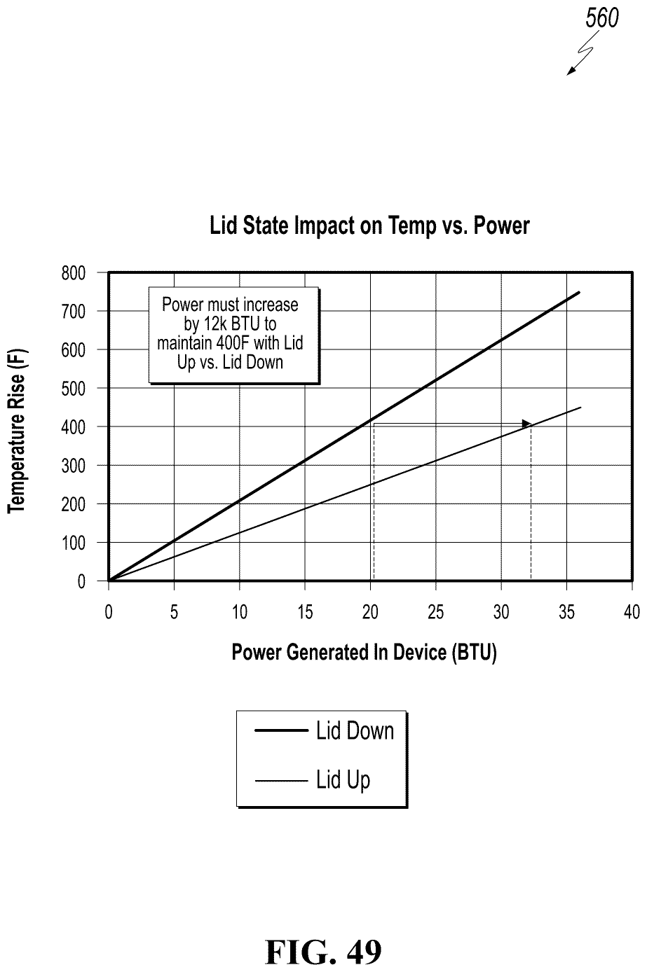

There are many ways to increase the capability of the system further while utilizing the same principles outlined above. For instance, the addition of a lid switch and characterization of cooking surface temperatures at varying BTU while the lid is open allows the system to dynamically adjust valve angle differently based on lid state to try to maintain constant temperature independent of lid state. This is important since thermal loss is much higher with the lid open, so it is necessary to substantially increase BTU to maintain constant temperature at the cooking surface. As shown in FIG. 49, a graph 560 depicts a relationship between power generated and temperature rise when the lid 12B is in an up or open position versus a down or closed position.

The inclusion of additional burners allows much greater temperature flexibility by allowing the system to achieve temperatures below the minimum turndown of the original burner. Shown below are configurations with 3 burners, but any number of burners can be used. Burners can be activated using manual On/Off valves, a manual Burner Selection valve, electronically controlled solenoid valves, or by any other method that can turn gas flow on or off. Microswitches or other indicating devices can be placed on the valves to inform the controller as to which burners are active and adjust the available valve position range appropriately to maintain stable flame. The switches also allow the system to change which temperature set points are available to the user on the UI.

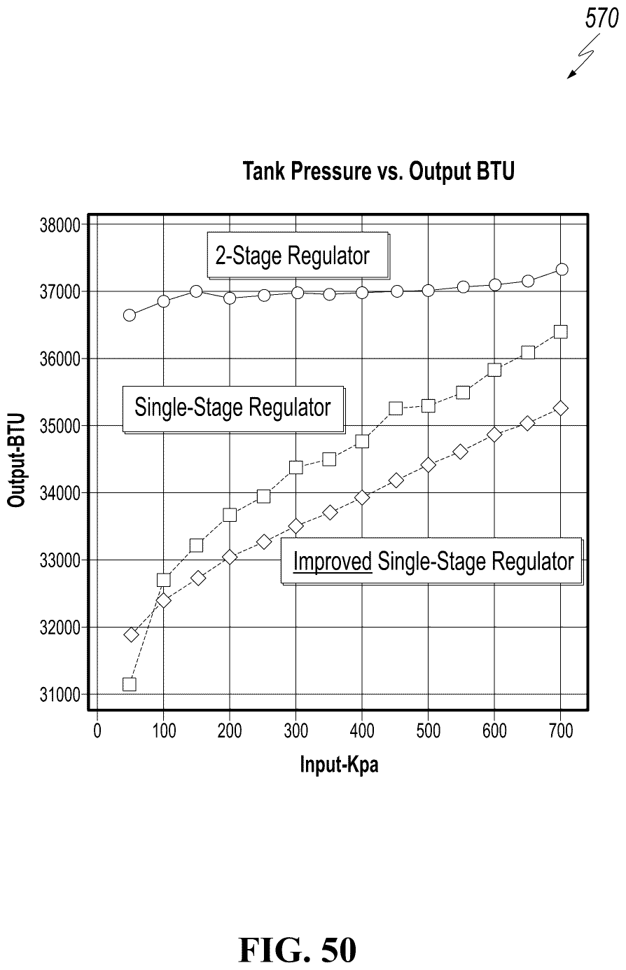

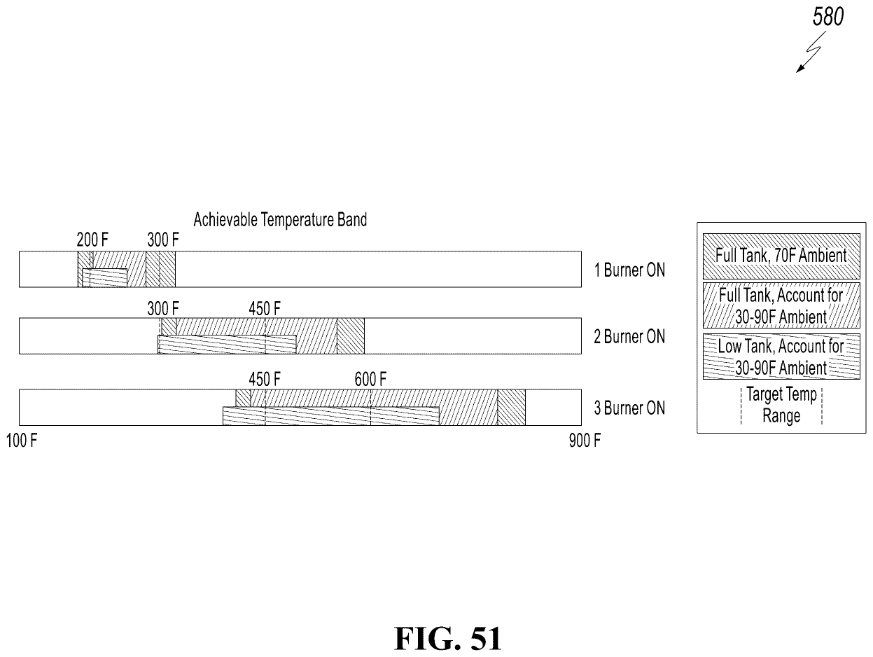

Finally, temperature bands can be further extended through the use of improved or even dual-stage regulators, shown in the table 570 of FIG. 50. Reductions in BTU output from varying tank fill levels or ambient temperatures will have direct impact on achievable temperatures. Reducing the dependence of the system operating pressure on tank pressure greatly improves the consistency of achievable temperatures under varying conditions. An example of the extended temperature bands is depicted in the table 580 of FIG. 51 as applied to one burner, two burners, and three burners, as described below in greater detail.

As introduced above, the propane grill 10 can use an integrated valve 410, combining both a controller-operated motorized valve 410 and a purely mechanical burner selection valve 414, in order to both select a combination of burners and then supply gas to the selected burners to reach a temperature set by a user via the UI 400. During product development, features must be included to meet certain regulatory standards for both worker and consumer safety. These features can take various forms, including certain onboard control logic to handle unsafe scenarios that may occur during normal operation of the product, features that cause intentional failures if certain behaviors are detected, automatic shut-offs, robust materials, etc.

During product development, certain steps may be deliberately taken to avoid falling under certain regulatory regimes. For example, if a cooking device uses a computer-controlled ignition sequence to light a burner, that cooking device may need to meet more rigorous standards than a cooking device using a manual ignition. The computer presents an additional, complex point of failure, and certain benchmarks must be met to keep workers and consumers safe.

In the context of the propane grill 10, the manually-actuated burner selection valve 414 and inputs received via the first dial 402 are one example of design features that take the propane grill 10 out of certain regulatory requirements for computer-operating, gas-powered cooking devices that otherwise would need to be met. To a user, the UI 400 can present as entirely digital. However, as noted in the chart on FIG. 40, when the first dial 402 is placed in any position other than OFF, the pilot burner 318 is ignited. This makes the propane grill 10 and manually-ignited grill. So long as the propane grill 10 remains on, the pilot burner 318 is lit. As a user adjusts the burner states via the first dial 402 to open or close one or more of the burners 317, fuel can enter those selected burners 317, and the pilot flame is merely carried from the pilot burner 317 to the selected burners 317. The motorized valve 412 is operated by a controller 315, but because ignition is always manual and the pilot flame is always lit when the propane grill 10 is in operation, certain regulatory requirements (such as UL certification), do not need to be met, as opposed to grills with an electronic ignition sequence.

Various steps may be taken to improve the safety of the propane grill 10 beyond what a normal grill can achieve. For instance, temperature can be monitored during the cook cycle to respond to events like grease fires (temps much higher than expected) or extinguished burners (temps much lower than expected) by automatically reducing gas flow to the minimum flow rate of the regulation valve. Notifications can be provided to the user of these events using the user interface or using wireless communication to another device.

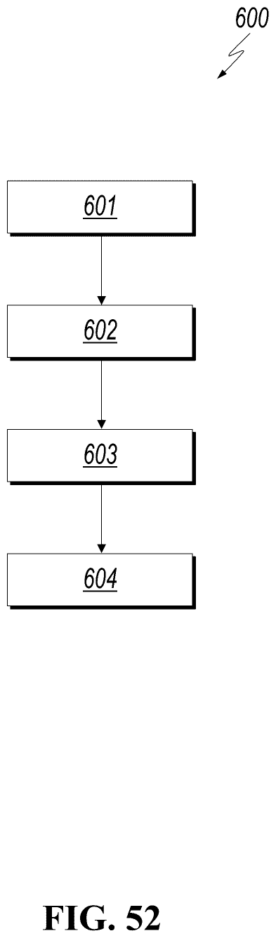

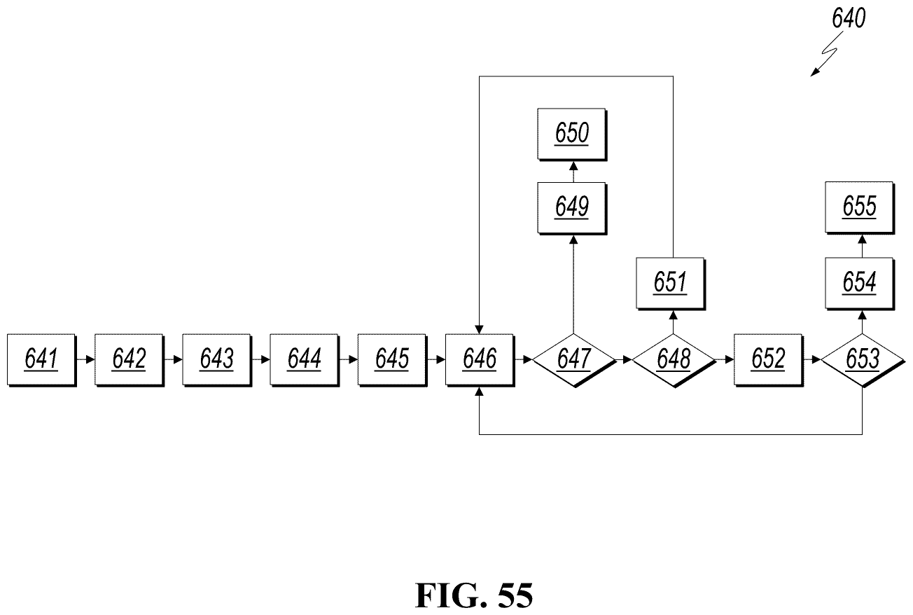

The propane grills described herein, including the propane grill 10, can monitor for errors and respond in a number of ways. This control logic, centered on basic monitoring, error detection and error response, is laid out and described with reference to FIGS. 52-57. In order, the control logic includes description of: a PID control loop; gas-out detection; flare-up detection; flare-up response and overheat check; flame-out detection; and overheat/flame-out response.

In general, a valve angle of the motorized valve 412 can be read via a sensor (e.g., a Hall-effect sensor), and this valve angle can used to ultimately adjust the operating temperature of the propane grill 10. On start-up, a homing sequence can be performed to calibrate the motorized valve 412 to establish a so-called “home” position. The motorized valve 412 can move between its fully open and fully closed states, and then the home position can be calibrated based on this upper and lower bound. This home position can correspond to a low or minimal flow state of fuel through the integrated valve 410. In the event of certain error conditions, the home position can provide a default position to which the motorized valve 412 can return to reduce, minimize, or cut-off gas flow in the propane grill 10.

FIG. 52 depicts an example method 600 of control using a PID controller loop associated with the propane grill 10. Each block in the example method 600 includes control logic to explain calculations performed to result in movement of the valve. From the top, step 601 defines: an average air reading (AirAVG) as a ten-second average temperature reading in the grill cavity by an NTC as measured in degrees Celsius; a temperature rate of rise (AirSlope) over a ten-second period as measured in degrees Celsius per second; an iterated temperature error value (TempError); and an integrated error value (IntegralError) proportional to a summation of the TempError iterations. Step 602 follows by introducing a variable (ThetaNom) representing a constant equal to either 0 or 180, depending on a summation calculation. Step 603 is a calculation of the valve position (TargetValvePosition) using a known PID equation and prior data and/or variables. If the calculated value of the valve position is below a permissible minimum, valve position is set to the minimum, and if valve position is above a permissible maximum, valve position is set to the maximum. At step 604, the valve is moved to the valve position calculated at step 603.

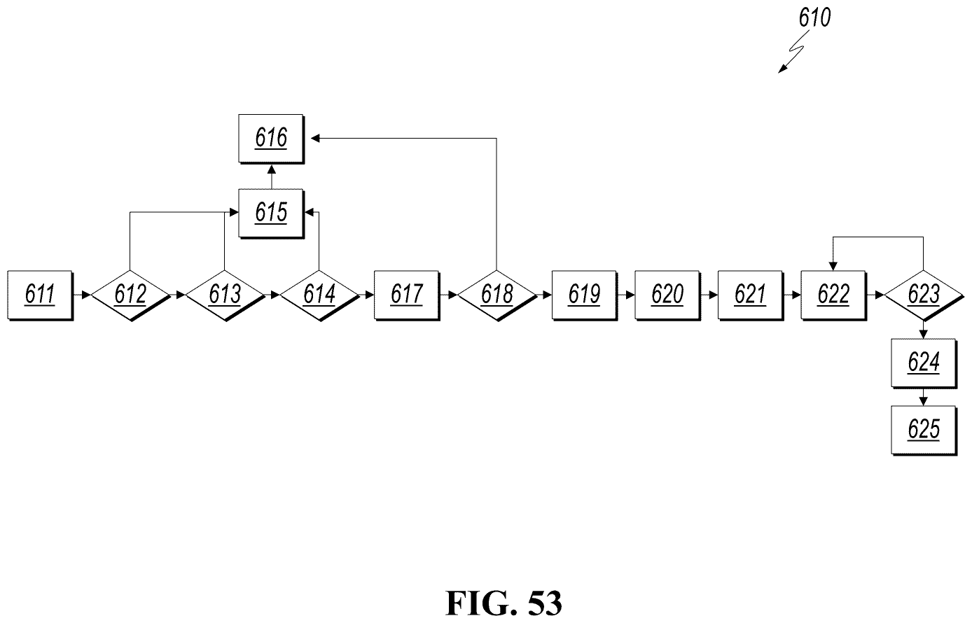

FIG. 53 depicts an example of a control flow 610 for a no-gas detection in which gas may not be flowing to the burners. The control flow 610 begins at step 611. At step 612, data is received from the air NTC 326 indicating a current temperature of the propane grill 10. If the current temperature is less than 60 degrees Celsius, flow proceeds to step 612 and data is received indicating a current integrated valve 410 angle. If the current angle is set to the minimum allowable position for the current burner configuration, flow proceeds to step 614 and data is then received indicating current temperature slope or trend. If the current temperature slope is less than a preset threshold, a variable indicative of no fuel is iterated by one at step 617. If the answer at any of steps 612, 613, 614 is that, respectively, current temperature is greater than 60 degrees Celsius, current valve angle is not at the appropriate minimum, or temperature slope is greater than the preset threshold, then the no-fuel variable is reset to a value of zero at step 615, and then the check is exited at step 616.

If after step 617 the no fuel variable is iterated by one, the flow proceeds to step 618. If the no-fuel variable is less than or equal to another preset value, the gas check is exited at step 616. A future check may result in the no fuel variable being iterated again if necessary conditions are met. If at step 618 the no-fuel variable is greater than the other preset value, thereby indicating a flame-out scenario, the fan is turned on at step 619, a target valve position is set at step 620 to be the minimum valve position for the given burner configuration, the valve moves at step 621, and an error indicating the flame-out is displayed on the UI 400 at step 622. If the burners 317, 318 are turned off at step 623, the error is cleared at step 624, and normal logic resumes at step 625. If the burners 317, 318 are not turned off at step 623, the error is re-displayed at step X. The burner check at step 623 and the error display at step 622 will continue to loop until the burners 317, 318 are turned off.

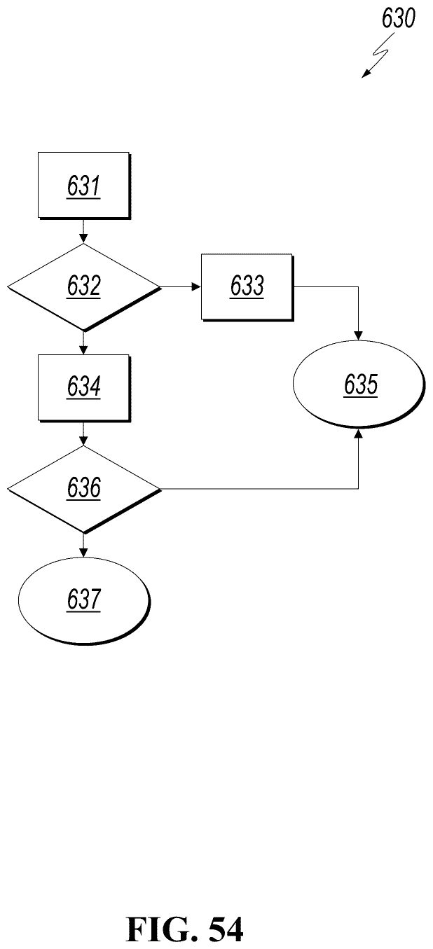

FIG. 54 depicts and example of a control flow 630 for flare-up detection. In some cases, uncontrolled flame may be created through operation of the propane grill 10. For example, if grease or food ignites, a flare-up can occur and excessive and potentially damaging or dangerous flames may appear in the cavity. Unchecked convective currents in the propane grill 10 can feed these flames if moving at certain speeds and exacerbate the risk presented. The control flow 630 can be used to detect whether a flare-up is occurring.

At step 631, the flare-up control loop beings. At step 632, current temperature of the propane grill 10 is measured via the air NTC 326, and if the current temperature meets or exceeds a preset value, an internal counter is iterated at step 634. At step 636, a check is performed to determine whether the internal counter exceeds a certain threshold. If no, the control loop is then exited at step 635. If yes, the control loop proceeds to the flare-up response control loop depicted in FIG. 54 at step 637. If the current temperature is less than the preset value at step 632, the control loop sets the internal counter back to zero at step 633, and the loop is exited at step 635.

If a flare-up is detected using the control loop 630, the response loop 640 of FIG. 54 begins at step 641, and the convection fan RPM is set to a heightened value equal to about 1200 RPM. At step 642, the target temperature is set to the minimum possible value, and at step 643 this target temperature is converted to a specific valve angle for the integrated valve 410. At step 644, the valve angle becomes the target valve position, and at step 645 the integrated valve 410 moves to this target valve position. At step 646, an error is displayed on the UI 400 indicating the flare-up. At step 647, a temperature check is performed. If the current temperature, as measured by the air NTC 326, is less than a first threshold, the error is removed at step 649 and cooking operations resume at step 650. If the first threshold is met or exceeded, the control loop 640 proceeds to an overheat detection sub-loop beginning with step 648.

Excessive temperatures in the propane grill 10 for extended periods of time can damage components, including components critical to performing safety checks. The overheat detection sub-loop is meant to discern whether temperatures are reaching or exceeding potentially damaging levels and whether these levels are met for extended periods of time. At step 648, an overheat temperature check is performed to measure temperature via the air NTC 326. If current temperature is less than a second, heightened threshold, an internal counter associated with overheat detection is reset to a zero value at step 651, and the control loop 640 proceeds back to step 646. If current temperature meets or exceeds the second, heightened temperature threshold at step 648, the internal counter for overheat detection is iterated at step 652, and a check is run on the internal counter at step 653. If the internal counter is less than some value, indicating that the potential overheated temperature has not existed long enough to present a risk, the control loop will return to step 646. If the internal counter meets or exceeds the required value, indicative of excessive temperature for an extended period of time on the order of several minutes, the error displayed at step 646 is removed at step 654 and a new, critical error is displayed at step 655.

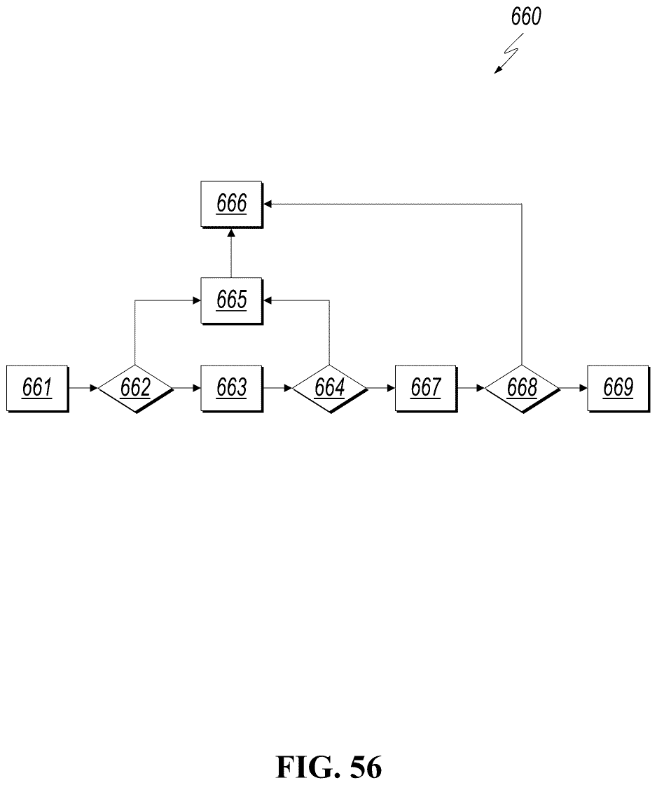

The control loop 660 of FIG. 56 depicts a flame-out check for when gas is flowing but the flames are extinguished. The control loop begins at step 661, and a check is performed at step 662 to determine whether the current valve angle of the integrated valve 410 is at its allowable minimum position for the current burner configuration. If it is not, an internal flame-out counter is set to zero at step 665, and the loop 660 is exited at step 666. If the current valve angle is at its allowable minimum position, a measurement is taken at step 663 to determine current temperature slope over some time interval. At step 664, if the measured current slope is greater than a preset negative value, indicative of a stable or increasing internal cavity temperature in the propane grill 10, the loop proceeds again to step 665. If it is less than the preset negative value, indicative of a decreasing internal cavity temperature, the internal flame-out counter is iterated at step 667. A check of the counter is performed at step 668. If the counter is less than a preset threshold, the control loop 660 proceeds to step 666 to exit the loop. If the counter is greater than or equal to the preset threshold, an error is displayed indicating a flame-out at step 669.

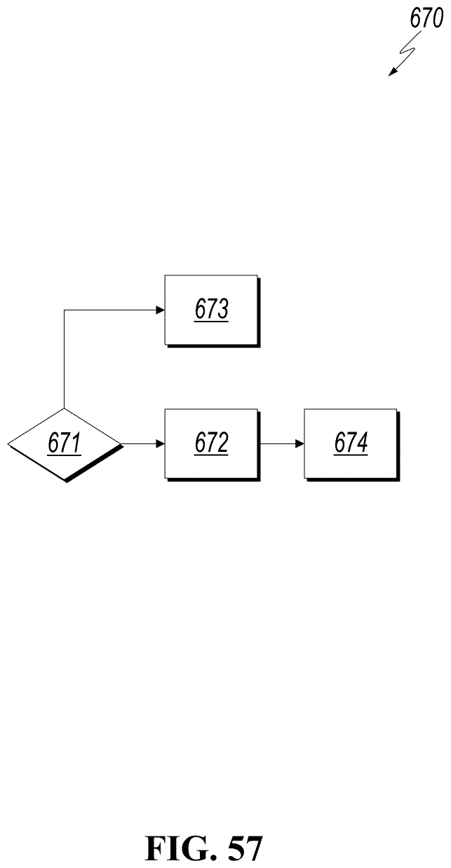

If either an overheat scenario is detected via loop 640 or a flame-out scenario is detected via loop 660, a similar response is triggered. This response is characterized by the control loop 670 of FIG. 57. At step 671, the control loop 670 begins if the relevant error for the given scenario is active. If the error is not present, the control loop 670 is exited at step 673. At step 672 the convection fan 110, 323 is turned to max speed, and at step 674 gas flow is turned to its minimum via the integrated valve 410 angle. One slight difference in the responses is that for an overheat scenario, gas flow is turned to as minimum a value as is possible without risking flashback based on the current burner configuration. For a flame-out scenario, gas flow is set to an absolute minimum.

Although ignition of the propane grill 10 can be entirely mechanical, other operations of the propane grill 10, including temperature adjustment, can be electronically-controlled. These electronically-controlled operations—and associated components—can be susceptible to a power-loss scenario. With no power in the unit, the motorized valve 412 is unable to adjust its valve position to control gas flow to the burners 317. Despite power loss, the pilot burner 318 can remain lit. This scenario can leave the user without control over the gas flow of the system.

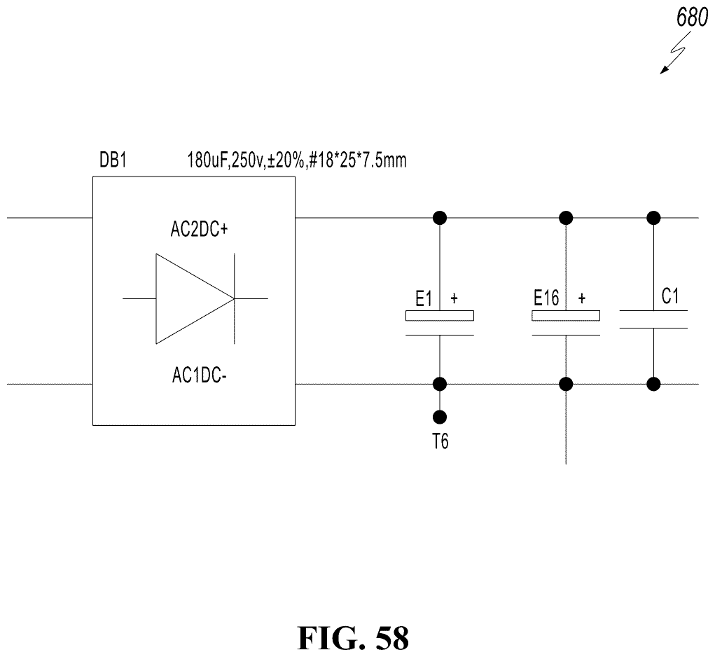

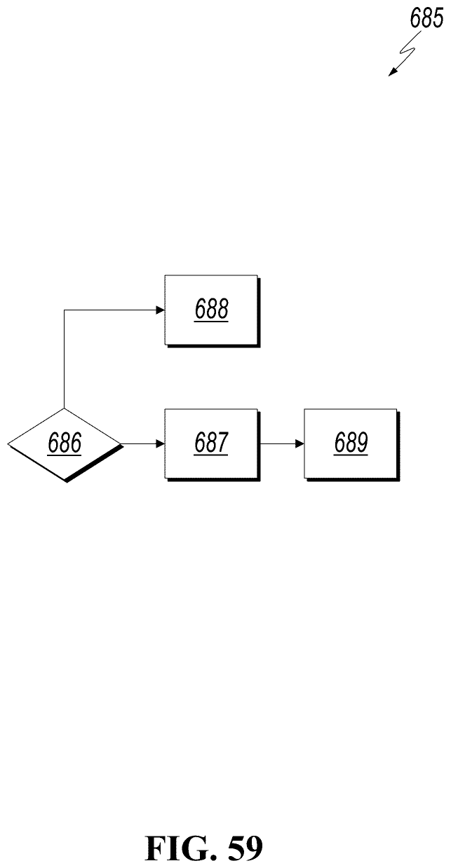

To address a power loss scenario, the controller 315 can include an on-board capacitor circuit 680, depicted in FIG. 58, able to store enough energy to return the propane grill 10 to a safe state. Specifically, this stored energy can be enough to run the motorized valve 412 from a fully open state to a fully closed state, and with enough energy, the motorized valve 412 can be returned it its home state from any other possible state. The associated flow 685 of FIG. 59 starts at step 686 where a power state can be checked. If power is active, the flow can proceed to 688 where operations continue as expected. If there is no power in the system, the flow 685 can proceed to step 687 where the capacitor circuit 680 will de-load at step 686 with enough energy to adjust the integrated valve 410 to an off state at step 689. The capacitor circuit 680 can also include additional features, such as an adapted diode bridge to prevent the capacitor from discharging improperly. This adapted diode bridge can ensure the energy discharges to the motorized valve 412 in a power-loss scenario.

In most electronic devices, even when the device is powered off, there may be standby circuits that continue to run, e.g., an internal clock, safety mechanisms, etc. These devices are subject to certain standby power requirements to ensure that these standby circuits do not pull excessive energy from a power source, such as the grid, resulting in excessive inefficiency. These standby circuits may also present a risk to an unsuspecting user tinkering with the electronic devices, and precautions must be taken both to abide by the power requirements while also protecting a user. The same can be true for cooking devices such as the propane grill 10. Users may have a desire to disassemble and reassemble their devices in order to adjust or fix components, or to inspect connection points, assemblies, etc. While not every user will disassemble and reassemble a given devices, devices must be made safe so that in the event a user decides to do so, they are not at risk. The same is the case for the propane grill 10, which can include features to make disassembly and reassembly safe, and to check to ensure the propane grill 10 is properly reassembled. Some disassembly may include the disconnection/reconnection of electronic circuits in the propane grill 10.

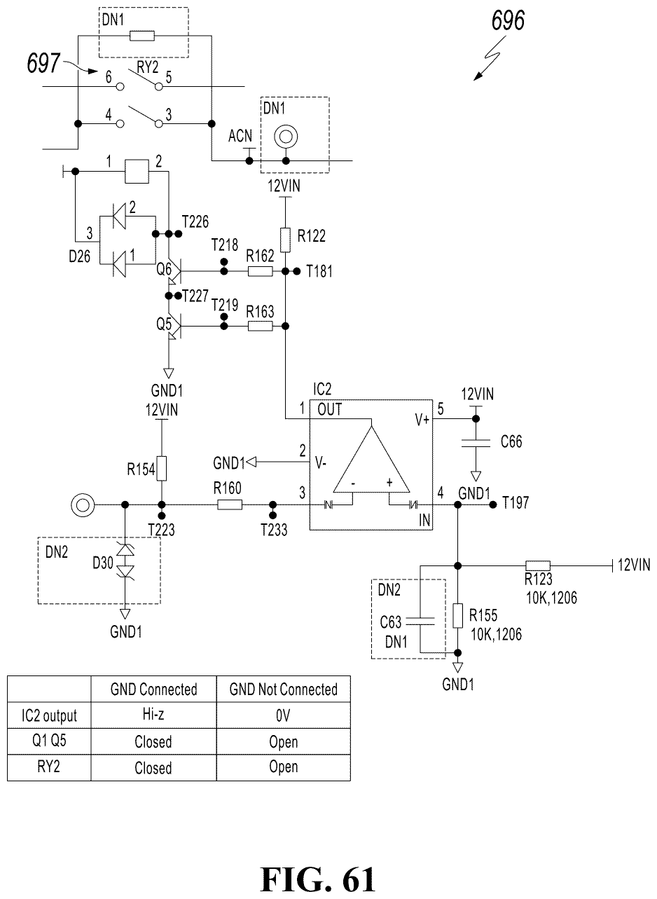

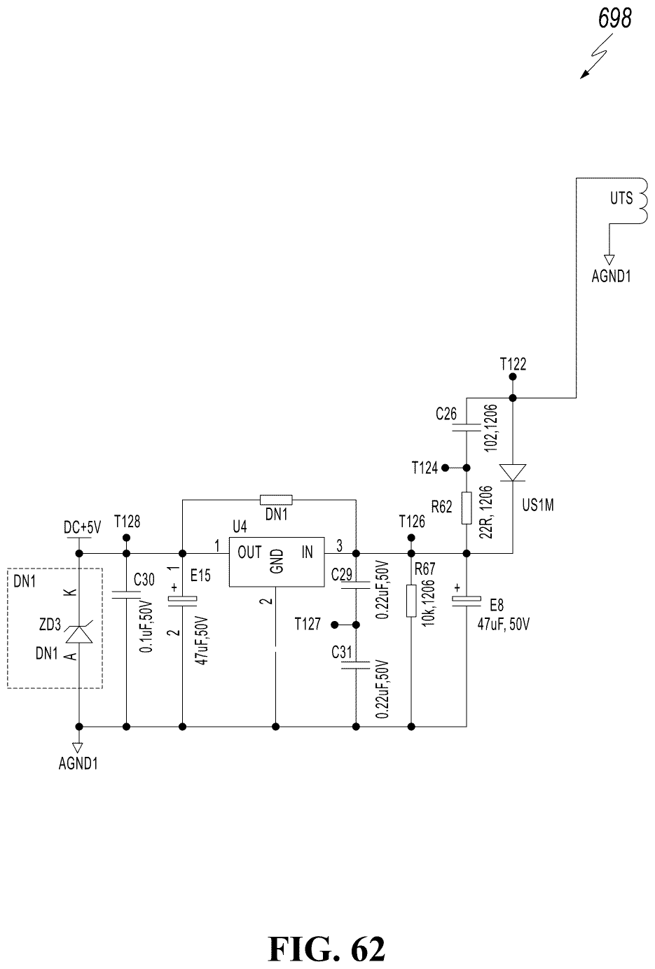

Electronic components in the propane grill 10 can be grounded so that electricity does not flow in the system and/or to a user and cause harm. If a user tinkers with the propane grill 10, the propane grill 10 can become disconnected from ground, putting the user at risk. To mitigate this risk, the propane grill 10 can include additional safety features to protect a user, including a ground-monitoring circuit and a low-power implementation of a standby power supply for onboard standby circuits, respectively featured in FIGS. 61 and 62.

The ground-monitoring circuit can operate as a standby circuit and determine if the propane grill 10 becomes disconnected from ground. If a disconnection is detected, the ground-monitoring circuit can take action. However, the ground-monitoring circuit must also determine whether the entire product has become disconnected from ground or if only the ground-monitoring circuit has lost access to ground. If only the ground-monitoring circuit has lost access to ground, an error can be raised by the propane grill 10 to inform a user. If the entire propane grill 10 has lost access to ground, the ground-monitoring circuit can cut power to the propane grill's 10 controls until ground is reconnected to the propane grill 10. The system accomplishes by sampling values at two pins, one located within the ground-monitoring circuit and one located outside of the ground-monitoring circuit. If the sampled energy value at each pin is equal then it can be known whether or not the entire system is grounded, the entire system has become disconnected from ground, or if only the ground-monitoring circuit has become disconnected from ground.

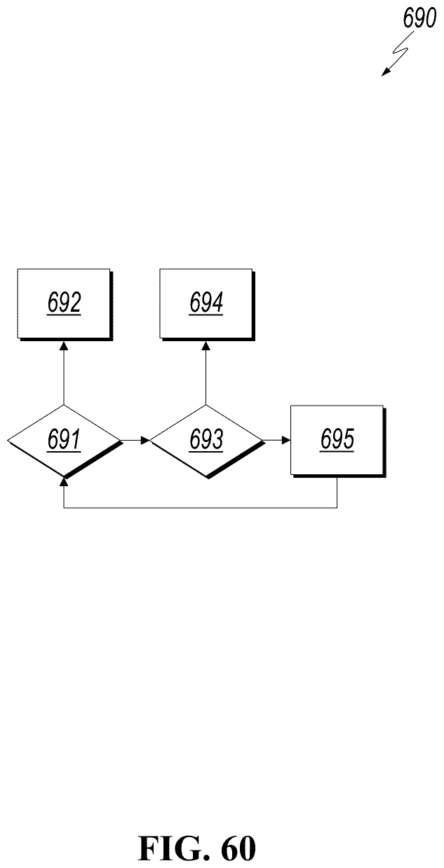

This flow 690 is captured in FIG. 60. At step 691, a ground status is checked. If ground is connected, the flow 690 exits at 692. If ground is not connected, a check is performed at step 693 to determine whether ground is lost for the entire propane grill 10 or just for the ground-monitoring circuit. If ground is only lost for the ground-monitoring circuit, an error can be displayed at step 694. If ground is lost for the entire propane grill 10, power to in the propane grill can be cut at step 695. The flow 690 can proceed back to step 691.

An exemplary ground-monitoring circuit 696 is depicted in FIG. 61. If the ground-monitoring circuit determines that the propane grill 10 has been disconnected from ground, switches 696 are opened to cut power to the propane grill 10. If ground remains connected, the switches 696 are closed allowing power to flow properly and the propane grill to operate as normal.

An exemplary low-power implementation of a standby power supply circuit 698 is depicted in FIG. 62. As introduced above, electronic devices may contain consume power even in an off state, but to meet regulatory requirements, that power consumption cannot exceed a certain value or “budget.” The implementation of the circuit 698 is one of low-power, which does not consume much of the allotted standby power budget.

This check can necessary following disassembly of the propane grill 10. In some circumstances, ground may be not properly reconnected during reassembly. The ground-monitoring circuit ensures that the propane grill 10 will not be operable while in an unsafe and incomplete state. The user reassembling the propane grill 10 must properly ground the propane grill 10 before functions can resume.

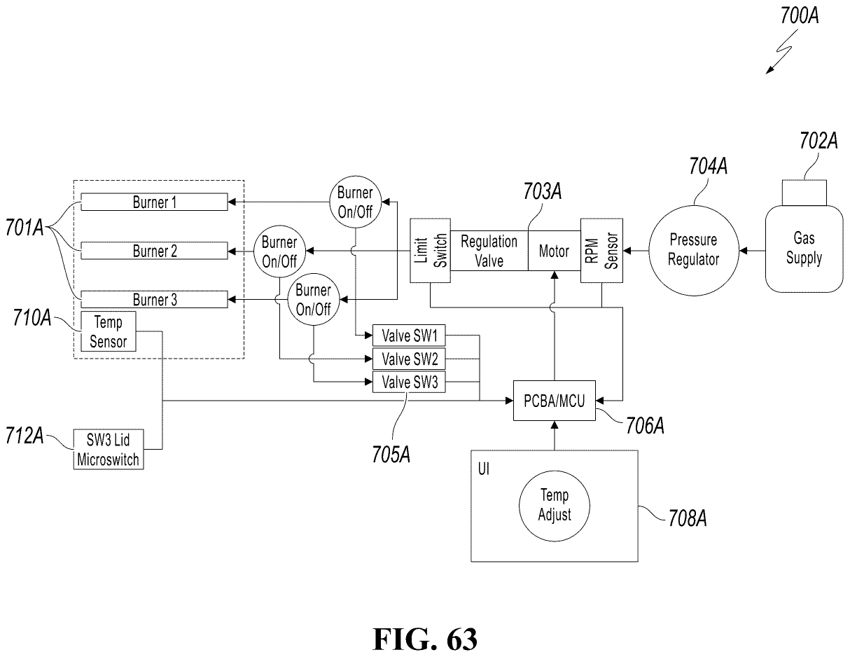

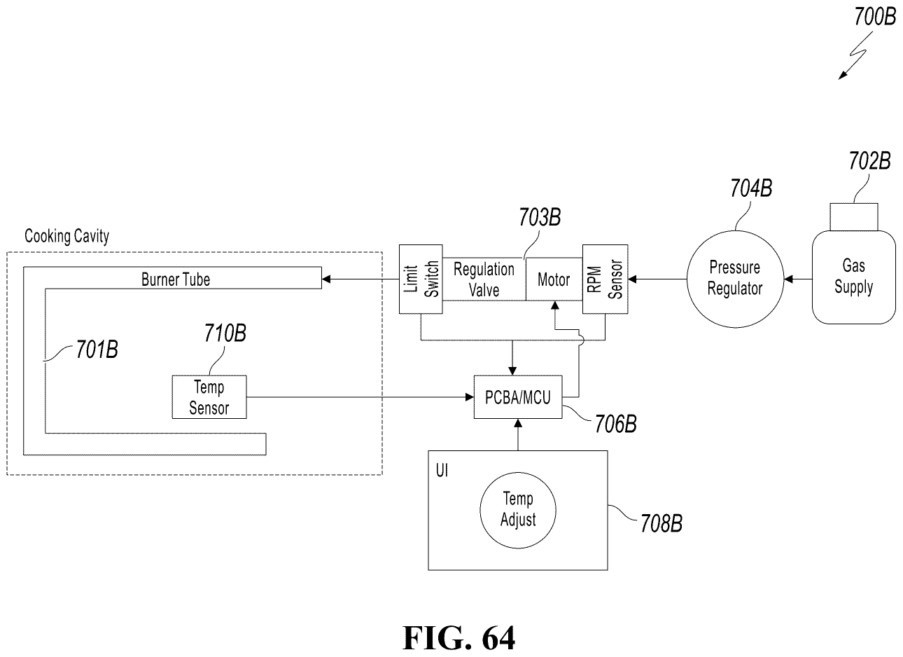

Additional variations of propane grill set-ups are shown in FIGS. 63-64. many features of the systems depicted are similar to those previously described, and for brevity, like components will not be described in detail again. The setup 700A of FIG. 63 has no pilot burner. Instead, each of the three burners 701A can be individually ignited and controlled via an integrated valve 703A with its own valve switches 705A. The setup of FIG. 64 differs in that there is a single U-shaped burner 701B spread throughout the cavity. The U-shaped burner can be controlled via an integrated valve 703B that can automatically adjust gas flow as required for a set temperature value, but there are no different burner configurations associated with the single U-shaped burner 701B.

Because the length of the U-shaped burner 701B is greater than a length of the straight burner tubes described previously, additional changes may be required to render the U-shaped burner 701B effective for all of the operational demands of the propane grill 10. For example, as the length of a generic burner increases, it is almost certain that the number of flame outlets along that length will increase as well. In order to feed the gas-air mixture evenly along the length of the burner, the gas-air mixture may need to be fed into the U-shaped burner 701B under a higher pressure than as compared to a pressure required for a typical straight burner tube. This higher pressure can ensure that enough gas-air mixture reaches the furthest flame outlets of the U-shaped burner 701B. In addition to or in place of this higher pressure, the sizing, spacing, and/or shape of the flame outlets themselves may vary. For example, as the flame outlets become located further from the input of the gas-air mixture, the flame outlets may become smaller in size to increase a flowrate of the gas-air mixture therethrough. In another example, the distribution of flame outlets nearer to the input of the gas-air mixture may be less dense to provide for a better flow throughout the entirety of the U-shaped burner 701B.

The system 700A and the system 700B each include a gas supply 702A, 702B, a regulator 704A, 704B, a controller 706A, 706B, a UI 708A, 708B, and an air NTC 710A, 710B. System 700A further includes a lid microswitch 712. Each of these components of both systems 700A, 700B are functionally the same as comparable components described herein, and for brevity, this description is not repeated.

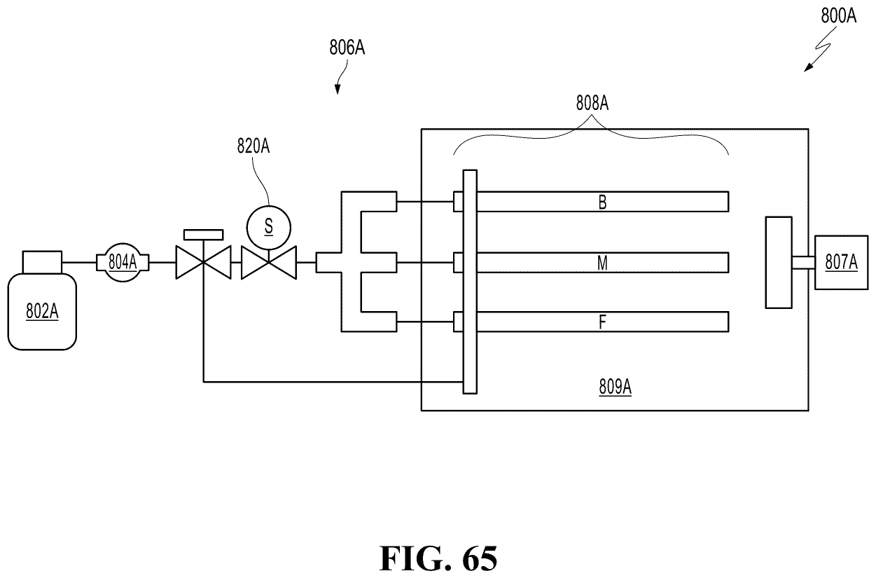

In addition to the setups described herein that center on the use of an integrated valve and set valve-angles to modulate gas flow to burners placed in different configurations, one or more modulation solenoids can instead be used to control gas flow to burners. The solenoids can be duty-cycled to achieve certain temperature values in a cooking cavity. Setups with one or more modulation solenoids are depicted in FIGS. 65-68. These setups follow the same principles described with respect to the system 300 of FIG. 35, which involves a regulated gas input involving a gas source 302 (e.g., a portable propane tank) and a regulator 304, an ignition and flow control system 306, and one or more burners 308 in a cavity 309.

The systems 800A-C each include a gas source 802A-C, a regulator 804A-C, an ignition and flow control system 806A-C, and one or more burners 808A-C in a cavity 809A-C. They further include convection systems 810A-C. Here, the ignition and flow control systems 806A-C use one or more modulation solenoids. Described components can appear and operate similarly to those corresponding components detailed herein.

For example, in FIG. 65, a system is depicted that includes a high-low solenoid 820A to regulate gas flow. The high-low solenoid can cycle through two or more gas flow states—at least a high flow state and a low flow state—to control gas flow reaching the burners 808A. Feedback provided to the high-low solenoid 820A in the form of temperature data, for example, can be used to instruct the solenoid 820A how much of its time should be spent on a given flow state in order to maintain a set temperature. Just as with the previously-described setups, some combination of the burners 808A can be selected, depending on the desired temperature of operation.

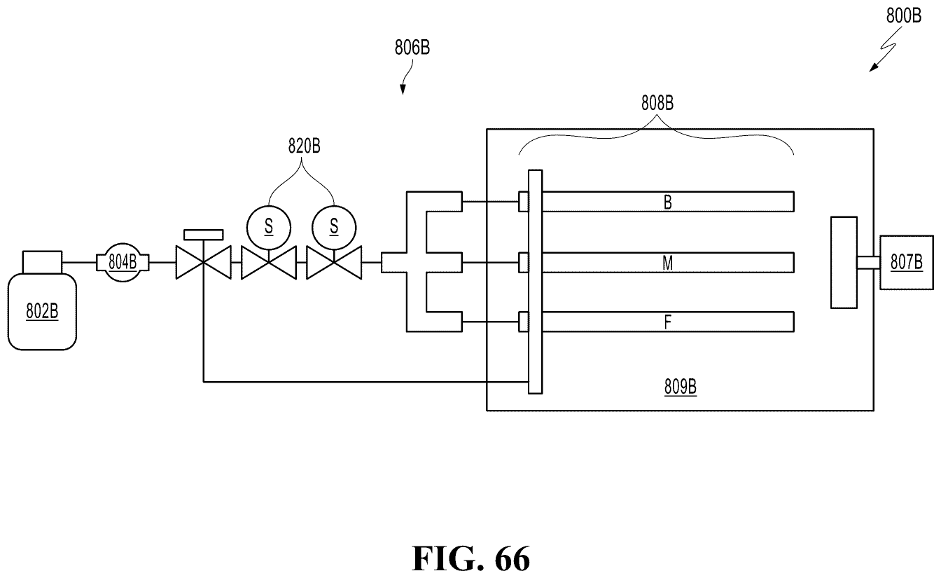

FIG. 66 depicts a similar setup 800B as the setup 800A of FIG. X but instead with two high-low solenoids 820B. These solenoids 820B can be placed in series, as depicted, or in parallel to provide a finer degree of control. By controlling pressure drops across the solenoids 820, grill temperature can be precisely adjusted.

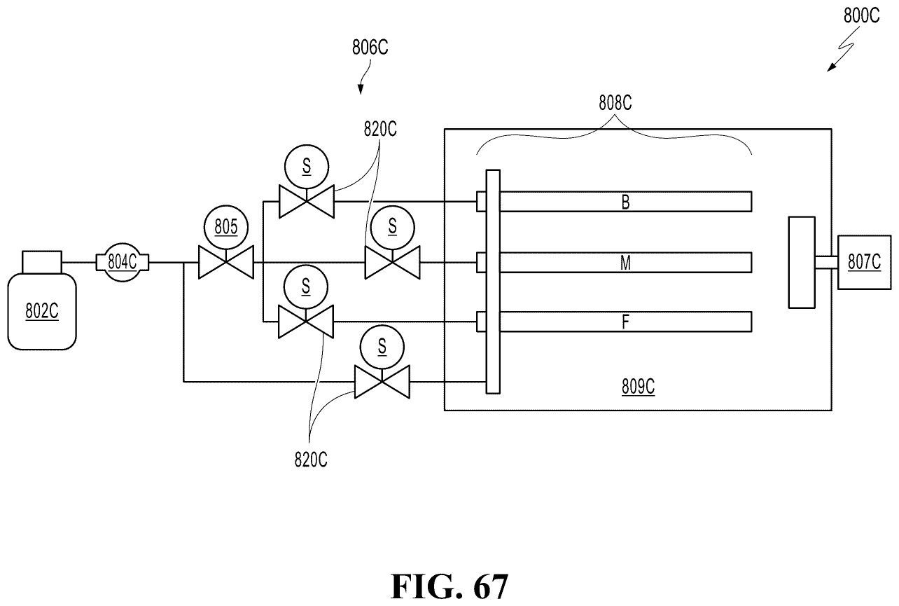

The system 800C of FIG. 67 differs from the systems 800A, 800B of FIG. 65 and FIG. 66 in that there is no burner selection capability. Instead, a series of solenoids 805, 820C control gas flow to the burners 808C depending on a desired temperature. Additionally a high-low solenoid 805 can cycle between an off state, a low flow state, and a high flow state such that fuel can be selectively provided to the solenoids 820C with which it is in series. For example, if a low-temperature cooking operation is desired, the solenoids 820C can be duty-cycled so as to maintain that low temperature. This may result in one or more of the solenoids 820C remaining in an off state and preventing gas from reaching one or more of the burners 808C entirely during the some or all of the cooking operation. Again, based on feedback from one or more temperature sensors or pressure sensors placed at various locations, the state of the solenoids 820C can be adjusted to achieve desired results for a given cooking operation. This cycling can occur in any of the states of the high-low solenoid 805 to provide more control over an operating temperature within the cavity 809C.

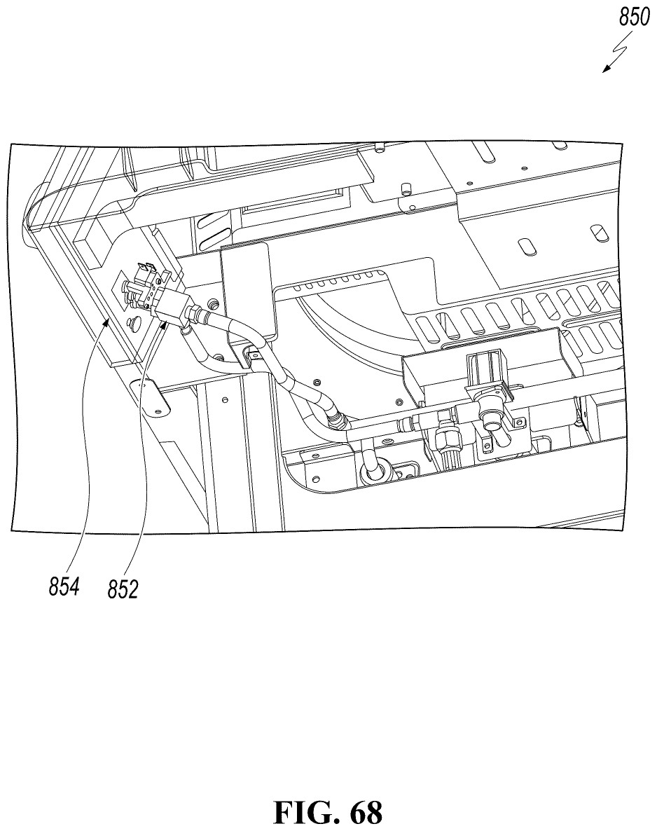

FIG. 68 depicts a view of an implementation of a propane grill, such as the propane grill 10, with a single solenoid configuration. As explained previously, the number and arrangement of solenoids—in those variations of grills that include solenoids—can vary depending on numerous factors, including number and arrangement of burners, degree of control desired, etc. The implementation 850 in FIG. 68 includes a single solenoid 852 tied to a single burner. While a single solenoid 852 tied to a single burner will not impact operations of other burners, control over a single burner will still impart some degree of control to the operations of the propane grill. The solenoid 852 can be any of the solenoids described herein, including high-low solenoids and the like, to provide several states of control over the associated burner. Through control over the solenoid 852, such as via duty-cycling, the temperature of the propane grill can still be controlled. As explained herein, some combination of burners less than the total burners available can still provide a wide range of temperatures in the propane grills. Duty-cycling a single burner via the solenoid 852 will still provide benefit. In this way, a temperature inputted at the UI 854 (which can be similar to any of the UI variations described herein) can be carried out to a desired cook temperature.

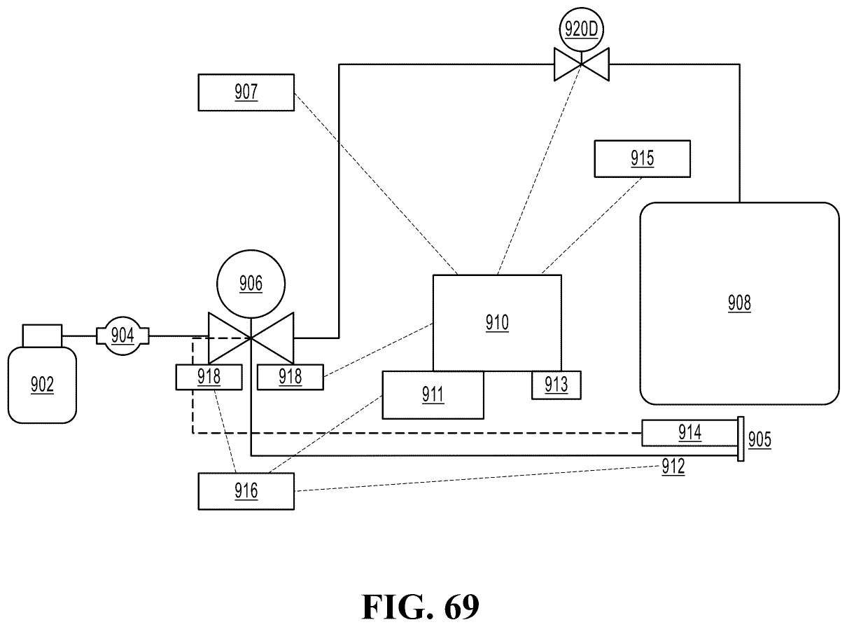

Additional grill variations with solenoids are depicted in FIGS. 69-72. These variations, 900A-D each include a fuel source 902, a regulator 904, a pilot burner 905, a manual valve 906, a convection system 907, a controller 910, a power source 911, an ignition source 912, a UI 913, a flame detector 914, a temperature sensor 915, an ignition module 916, and switches 918. Again, for brevity, like components will not be described in detail. All depicted variations are compatible with the grills described herein, including propane grill 10.

The variation of FIG. 69 is a basic single-burner setup with solenoid control. The setup 900A includes an electronically-controlled solenoid 920A along one direction and the pilot burner 905 along another. An ignition module 916 is associated with the pilot burner 905 as well. A single burner 908 of some kind, such as a burner tube or circular burner, is placed in series with the solenoid 920A. A controller 910 coupled to a power source 911, a UI 912, and the convection system 907, in addition to the solenoid 920A is also included. One or more switches 918 can be associated with the manual control valve 906 and the controller 910 to determine a state of the valve 906 and to inform operations of the overall system.

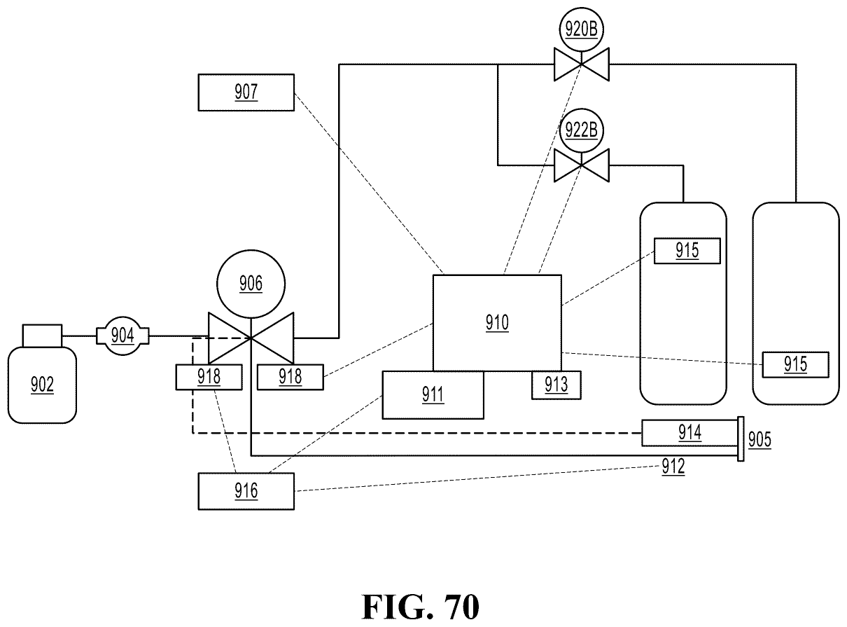

The variation of FIG. 70 features many of the same components as the variation of FIG. 69 but instead with two independent burners 908 instead of one. Each burner 908 has its own solenoid 920B, 922B to control gas flow to the burners 908. Each burner 908 can also have its own NTC 915 to provide temperature feedback to the controller 910. Both burners 908 can be ignited by the pilot burner 905, and each burner 908 can be independently controlled.

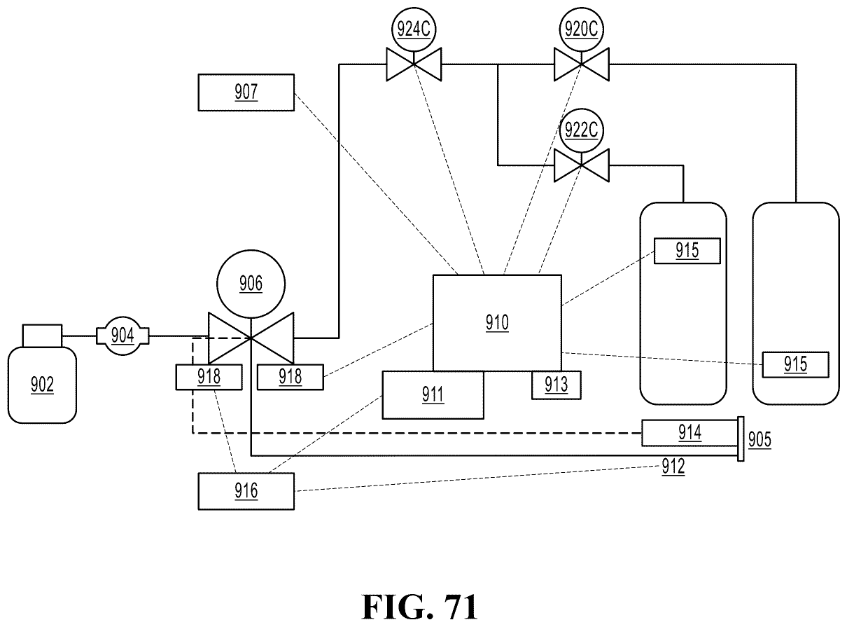

The variation of FIG. 71 adds a high-low solenoid 924C in series with the two solenoids 920C, 922C and two burners 908 to provide multiple flow levels to each burner 908.

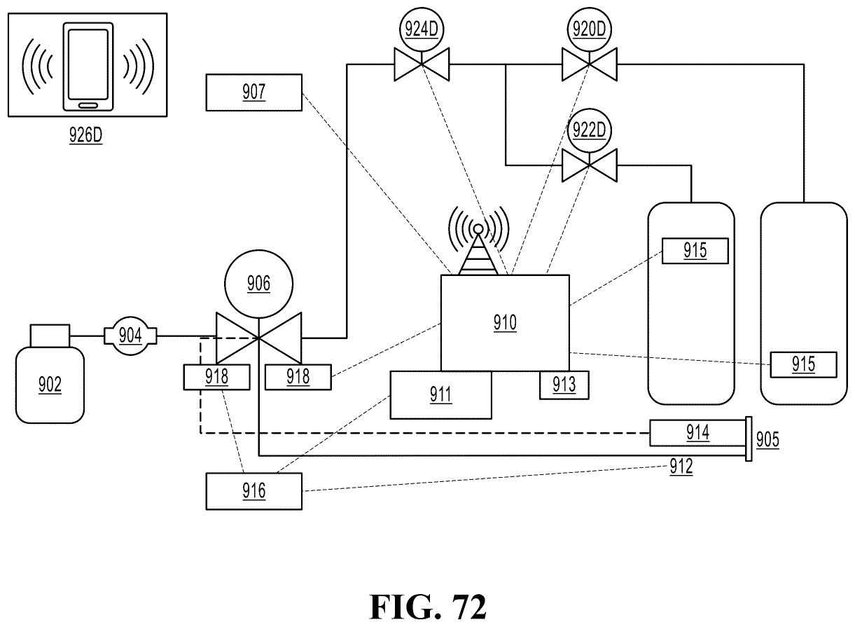

The variation of FIG. 72 adds wireless communication to the variation of FIG. 71. A mobile device 926D, such as a smartphone, computer, tablet, etc. can wirelessly communicate with the controller 910 to receive and transmit information pertaining components, cooking operations, etc. For example, a user could set a desired cook temperature via the mobile device 926D, and that cook temperature information can be transmitted to the controller 910, which then carries out the steps required to reach that cook temperature.

Certain illustrative implementations have been described to provide an overall understanding of the principles of the structure, function, manufacture, and use of the systems, devices, and methods disclosed herein. One or more examples of these implementations have been illustrated in the accompanying drawings. Those skilled in the art will understand that the systems, devices, and methods specifically described herein and illustrated in the accompanying drawings are non-limiting illustrative implementations and that the scope of the present invention is defined solely by the claims. The features illustrated or described in connection with one illustrative implementation may be combined with the features of other implementations. Such modifications and variations are intended to be included within the scope of the present invention. Further, in the present disclosure, like-named components of the implementations generally have similar features, and thus within a particular implementation each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described implementations. Accordingly, the present application is not to be limited by what has been particularly shown and described, except as indicated by the appended claims. All publications and references cited herein are expressly incorporated by reference in their entirety.

1. A cooking device, comprising:
a housing defining an internal cooking chamber;
at least one gas-powered heat source disposed in the internal cooking chamber, the at least one gas-powered heat source being configured to heat air within the internal cooking chamber and a food product disposed in the internal cooking chamber during a cooking operation; and
a convection fan in fluid communication with the internal cooking chamber and configured to circulate the heated air within the internal cooking chamber during the cooking operation.

2. The cooking device of claim 1, wherein the housing includes a base and a lid hinged to the base.

3. The cooking device of claim 1 further comprising:
a smoke unit coupled to the housing, the smoke unit being configured to generate and supply smoke to the internal cooking volume.

4. The cooking device of claim 3, wherein the smoke unit includes an aspirator configured to divert circulated convective air through an aspirator pathway to create a low-pressure zone in the smoke pathway to increase a flow rate of smoke entering the internal cooking chamber.

5. The cooking device of claim 4, wherein the aspirator includes a tongue configured to divert a fraction of the circulated convective air to the aspirator pathway.

6. The cooking device of claim 1 further comprising:
at least one burner duct disposed at least partially around the at least one burner, the at least one burner duct being configured to prevent circulated heated air from extinguishing the at least one gas-powered heat source.

7. The cooking device of claim 6, further comprising:
a flame tamer disposed above the at least one burner duct and the at least one burner, the flame tamer being wider than the at least one burner duct and being configured to prevent falling debris and/or waste from interfering with the at least one gas-powered heat source.

8. The cooking device of claim 7, further comprising a grease catch disposed beneath the at least one burner and the at least one burner duct, the grease catch defining at least one fluid drain, the grease catch being sloped toward the at least one fluid drain such that fluid impacting the grease catch is directed to the at least one fluid drain.

9. The cooking device of claim 1 further comprising:
a convection motor configured to drive the fan; and
a cooling fan configured to reduce an operating temperature of the convection motor.

10. The cooking device of claim 9, wherein the convection motor is configured to drive the cooling fan.

11. The cooking device of claim 1, wherein the at least one gas-powered heating device comprises at least one burner tube and a pilot light.

12. The cooking device of claim 11, wherein the pilot light defines a first plurality of outlets having each having a first distribution density and a second plurality of outlets each having a second distribution density greater than the first size;
wherein the first plurality of outlets are configured to support a first plurality of flames and the second plurality of outlets are configured to support at least one secondary flame, and
wherein the first plurality of flames are configured to burn the air-fuel mixture more efficiently than the at least one secondary flame.

13. The cooking device of claim 12, further comprising a flame tamer disposed over the pilot light, the flame tamer defining at least one window therethrough, the at least one window being positioned such that the at least one secondary flame is visible from a vantage point disposed above the flame tamer.

14. The cooking device of claim 11, further comprising a thermopile configured to detect the presence of flame generated by the pilot light.

15. The cooking device of claim 14, wherein the thermopile is electrically isolated from all other electronic components in the cooking device.

16. The cooking device of claim 1 further comprising a duct configured to receive airflow from the fan at a first end of the internal cooking chamber and expel the received airflow at a second end of the internal cooking chamber.

17. The cooking device of claim 1 further comprising an exhaust configured to vent air from the internal cooking volume, the exhaust vent being disposed proximate a pressure-neutral region.

18. The cooking device of claim 1, further comprising a split volute defining a first airflow path and a second airflow path, the fan being disposed within the split volute.

19. The cooking device of claim 18, wherein the heated air circulated by the fan is configured to be substantially equally divided between the first airflow path and the second airflow path.

20. The cooking device of claim 19, wherein the first airflow path is configured to create a first toroidal airflow pattern in the internal cooking chamber and the second airflow is configured to create a second toroidal airflow pattern in the internal cooking chamber.
